(19) United States
(12) Patent Application Publication
(10) Pub. No.: US 2006/0216638 A1
(43) Pub. Date: Sep. 28, 2006

(54) Infrared-ray photosensitive planographic printing plate precursor

(75) Inventor: Noriaki Watanabe, Shizuoka-ken (JP)

Correspondence Address: SUGHRUE MION, PLLC, 2100 PENNSYLVANIA AVENUE, N.W., SUITE 800, WASHINGTON, DC, 20037, US

(73) Assignee: FUJI PHOTO FILM CO., LTD.

(21) Appl. No.: 11/366,401

(22) Filed: Mar. 3, 2006

(30) Foreign Application Priority Data
Mar. 22, 2005 (JP) 2005-082769

(51) Int. Cl. G03C 1/00

(52) U.S. Cl. 430/270.1

(57) ABSTRACT

The infrared-ray photosensitive planographic printing plate precursor of the present invention comprises a support, a recording layer provided on one side of the support, and a back coating layer provided on a side opposite to a side having the recording layer of the support, and the recording layer contains (a) a long chain alkyl group-containing polymer containing a vinyl monomer having a carboxyl group at a composition ratio within a range from 20 to 99 mol %, and (b) an infrared absorbing agent, and can form an image by infrared-ray irradiation. According to this planographic printing plate precursor, even when the precursor is packaged and transported without using a protective paper (interleaving paper) between plate materials, a recording layer is hardly scratched.

### CROSS-REFERENCE TO RELATED APPLICATION

This application claims priority under 35 USC 119 from Japanese Patent Application No. 2005-082769, the disclosure of which is incorporated by reference herein.

### BACKGROUND OF THE INVENTION

1. Field of the Invention

The present invention relates to an infrared-ray photosensitive planographic printing plate precursor, particularly, an infrared-ray photosensitive planographic printing plate precursor having excellent scratch resistance.

2. Description of the Related Art

Development of lasers in recent years has been remarkable, particularly in solid lasers and semiconductor lasers having a light-emitting region in the near-infrared to infrared regions, of which the high output and miniature-type have become easily available. Particularly, in the field of planographic printing, these lasers are extremely useful as an exposure light source when a plate is made directly from digital data of computers or the like.

Positive type planographic printing plate precursors for direct plate-making using such infrared-ray lasers contain an alkali-soluble resin and an infrared-ray absorbing agent which absorbs light and generates heat as essential components. In an unexposed portion (image portion), the infrared-ray absorbing agent works as a dissolution inhibitor, which substantially reduces solubility of the alkali-soluble resin by interacting with the alkali-soluble resin. On the other hand, in an exposed portion (non-image portion), interaction between the infrared-ray absorbing agent and the alkali-soluble resin is weakened due to generated heat, and the resin is dissolved in an alkali developer to form an image.

However, there is a problem that this positive type planographic printing plate precursor has insufficient mechanical strength of the recording layer and, when a plate surface comes into strong contact with various members during the manufacturing process, transportation, and handling of the printing plate, a defect is generated on the plate surface, and drop-out occurs in an image part after development.

As a means to solve the aforementioned problem, Japanese Patent Application Laid-Open (JP-A) No. 2004-258490 describes use of a polymer, which forms fine projections on a recording layer surface for the purpose of improving the mechanical strength of a recording layer. By such a technique, mechanical strength of the recording layer is improved. However, under the circumstance of a great load on a plate material, such as transportation over a distance in the state where materials are stacked and packaged without using a protective paper (interleaving paper) between plate materials for the purpose of resource saving and productivity improvement, drop-out in an image portion in contact with the back surface of a support for a recording layer is generated in some cases, and further improvement in scratch resistance is desired.

### SUMMARY OF THE INVENTION

The present invention was done in view of the aforementioned conventional problems, and an object of the invention is to provide an infrared-ray photosensitive planographic printing plate, which is provided with a recording layer having practically sufficient scratch resistance, and can be packaged without using protective papers (interleaving paper) between plate materials even when the planographic printing plate precursors are stacked.

The present inventors have, as a result of intensive studies, found that the aforementioned problems can be solved by containing a polymer having a long chain alkyl group and a carboxyl group in a recording layer of an infrared-ray photosensitive planographic printing plate precursor, and by further providing a back coating layer, which resulted in completion of the present invention.

That is, the infrared-ray photosensitive planographic printing plate precursor of the present invention comprises a support, a recording layer provided on one side of the support, and a back coating layer provided on a side opposite to a side having the recording layer of the support, and is characterized in that the recording layer contains (a) a long chain alkyl group-containing polymer constituted from a vinyl monomer having a carboxyl group at a composition ratio within the range from 20 to 99 mol %, and (b) an infrared-ray absorbing agent, and an image can be formed thereon by infrared-ray irradiation.

In the image recording material of the present invention, (a) a long chain alkyl group-containing polymer and another polymer compound, which are not mutually soluble, are used. Thereby, both cause phase separation, and (a) a long chain alkyl group-containing polymer is self-aggregated, fine projections consisting of (a) a long chain alkyl group-containing polymer are formed on a recording layer surface, thereby exhibiting the excellent effect of the present invention.

It is preferable that the back coating layer is a back coating layer containing a resin of at least one kind of resin selected from the group consisting of a polymerized saturated polyester resin, a phenoxy resin, a polyvinyl acetal resin, and a vinylidene chloride copolymer resin, or a back coating layer containing the following (i) to (iii):

(i) a metal oxide obtained by hydrolyzing and polycondensing an organic metal compound or an inorganic metal compound,

(ii) a colloidal silica sol, and

(iii) an organic polymer compound.

The present invention is based on the following investigations and findings by the present inventors.

A recording layer in the infrared-ray photosensitive planographic printing plate precursor of the present invention is provided by dissolving a long chain alkyl group-containing polymer and the other polymer compound, which is not compatible with the long chain alkyl group-containing polymer, in a coating solvent, and coating this solution on a support, followed by drying. It is thought that, accompanied with removal of a coating solvent in the drying step, phase separation due to inherent incompatibility occurs between the (a) long chain alkyl group-containing polymer and the other polymer, the long chain alkyl group-containing polymer is self-aggregated in the recording layer to form fine particles, and fine projections consisting of the fine particles are formed on a recording layer surface. In the present invention, it is thought that, since such the fine projections reduce frictional force of the recording layer surface, stress from scraping scratches, abrasion scratches or the like (scratch stress) is alleviated.

It is thought that these fine projections are the polymer containing a long chain alkyl group, and this is a relatively soft polymer. When the hardness of a member, which may come into contact with a recording layer and damage this layer, is low, the recording layer has sufficient scratch resistance since stress relief of the contacting member itself is added. However, when the hardness of the contacting member is high, even if the fine projection are deformed, stress relief due to the deformation quickly reaches its limit. That is, the limit of stress relief is reached under relatively weak stress.

Therefore, in the case when a recording layer surface and the back surface of a support back having a high hardness come into contact, if planographic printing plate precursors are stacked and packaged without using a protective paper (interleaving paper) between the plate materials (hereinafter, referred to as “interleaving paperless packaging” where appropriate), and transported a long distance, there is a possibility that scratches are formed on a recording layer surface.

The present inventors have, in view of the above instance, studied the provision of a back coating layer on a side opposite to a side having a recording layer such that the recording layer and the back surface of a support do not come into contact. As a result, it was found that scratch resistance in the interleaving paperless packaging form was dramatically improved by provision of a back coating layer.

Regarding such a back coating layer, it is required that its components are not dissolved out during development to adversely influence development stability, and there is no adverse influence on feedability when used in a light exposing device or a developing apparatus. The present inventors found that a back coating layer containing at least one kind of resin selected from the group consisting of a polymerized saturated polyester resin, a phenoxy resin, a polyvinyl acetal resin, and a vinylidene chloride copolymer resin, or a back coating layer containing the following (i) to (iii) is particularly excellent in those respects, which resulted in completion of the invention:

(i) a metal oxide obtained by hydrolyzing and polycondensing an organic metal compound or an inorganic metal compound,

(ii) a colloidal silica sol, and

(iii) an organic polymer compound.

In brief, according to the present invention, an infrared-ray photosensitive planographic printing plate, which is provided with a recording layer having practically sufficient scratch resistance and can also be packaged without using a protective paper (interleaving paper) between plate materials even when planographic plate precursors are stacked, is provided.

### DETAILED DESCRIPTION OF THE INVENTION

[Infrared-Ray Photosensitive Planographic Printing Plate Precursor]

The infrared-ray photosensitive planographic printing plate precursor of the present invention (hereinafter, simply referred to as “planographic printing plate precursor” in some cases) comprises a support, a recording layer provided on one side of the support, and a back coating layer provided on a side opposite to a side having the recording layer of the support, and is characterized in that the recording layer contains (a) a long chain alkyl group-containing polymer containing a vinyl monomer having a carboxyl group at a composition ratio within a range from 20 to 99 mol %, and (b) an infrared-absorbing agent, and an image can be formed by infrared-ray irradiation.

Essential features of the invention will be sequentially explained below.

[Recording Layer]

A recording layer in the invention is a recording layer which contains (a) a long chain alkyl group-containing polymer containing a vinyl monomer having a carboxyl group at a composition ratio within a range from 20 to 90 mol %, and (b) an infrared-ray absorbing agent, and can form an image by infrared-ray irradiation.

(a) A long chain alkyl-containing polymer is characterized in that it contains a vinyl monomer having a carboxyl group at a composition ratio within a range from 20 to 99 mol %.

In addition, a recording layer in the invention is characterized in that it contains (a) a long chain alkyl-containing polymer which causes phase separation from a polymer compound (e.g. phenol-based resin etc.) contained in a coating solution during coating formation, to form projections on the outermost surface.

(a) A long chain alkyl-containing polymer has property that it is dissolved in a coating solvent together with the other polymer compound in a coating solution, but in a drying step after coating, causes phase separation from other components accompanied with removal of a solvent, and is self-aggregated to form projections on the outermost surface. Therefore, fine projections consisting of this (a) long chain alkyl group-containing polymer are different in both process for production and physical property from the previous surface projections formed by adding a fine particle dispersion of inorganic particles, metal particles or organic particles to a coating solution, and particularly has an advantage that fine particles (fine projections) are excellent in adherability with a polymer compound constituting a matrix.

The fine projections present on a recording layer surface in the present invention can be easily confirmed by observing a recording layer surface with a microscope.

An average particle diameter of fine particles forming a surface projection is preferably 0.01 μm to 10 μm, more preferably 0.03 μm to 5 μm, more preferably 0.05 μm to 1 μm. When an average particle diameter is below 0.01 μm, formation of irregularities on a recording layer surface is insufficient, and there is a fear that the scratch resistance improving effect is not sufficiently obtained. In addition, when a projection exceeding 10 μm is present, there is a fear that resolution of a printed material and adherability with a lower layer are reduced, and particles present near a surface are more easily detached by an external stress, and there is a fear that uniformity deteriorates.

Examples of a method of measuring an average particle diameter of a surface projection generally include a method of measuring a diameter of particles present on a surface by observation with a optical microscope, an electron microscope or the like, and calculating its average. That is, an average particle diameter of fine particles referred herein is obtained by optically measuring a plurality of particle diameters of fine particles consisting of (a) a long chain alkyl group-containing polymer which is projected on a recording layer surface, and obtaining its average value.

A height of a fine projection present on a recording layer surface is preferably 5.0 nm to 2000 nm, more preferably 10 nm to 1000 nm, most preferably 20 nm to 800 nm.

Examples of a method of measuring a height of a surface projection include a method of measuring a height of a projection by observing a cross-section with an electron microscope, and a method of measuring a height using an atomic force microscope (AFM). A fine projection is preferably softer as compared with a smooth part, and this hardness can be measured using a hardness meter.

In the invention, examples of a factor of controlling a particle diameter and a height of a fine projection consisting of (a) a long chain alkyl group-containing polymer present on a recording layer surface include polarity of (a) a long chain alkyl group-containing polymer, polarity of a polymer compound to be used jointly, each addition amount, a kind of a coating solvent, other additives contained in a recording layer, and drying condition (temperature, time, humidity, pressure etc.).

For example, when a difference in polarity between (a) a long chain alkyl group-containing polymer and a polymer having no compatibility to be used together grows great, a particle diameter of a fine projection is increased and, by raising a drying temperature, and shortening a necessary time for drying, a particle diameter of a fine projection becomes small.

(Long Chain Alkyl Group-Containing Polymer Containing Vinyl Monomer Having a Carboxyl Group at a Composition Ratio Ranging from 20 to 99 mol %)

(a) A long chain alkyl group-containing polymer containing a vinyl monomer having a carboxyl group at a composition ratio ranging from 20 to 99 mol % (hereinafter, conveniently, referred to as “long chain alkyl group-containing polymer”) which is a characteristic component in a recording layer will be described.

(a) A long chain alkyl group-containing polymer is indispensable that it contains a vinyl monomer having a carboxyl group at a composition ratio ranging from 20 to 99 mol %. A long chain alkyl group in (a) a long chain alkyl group-containing polymer refers to a carbon number of 6 or more, preferably a carbon number of 12 or more. More specifically, it is preferable that (a) a long chain alkyl group-containing polymer is a copolymer of a monomer having a long chain alkyl group and a vinyl monomer having a carboxyl group, and is indispensable that it contains the vinyl monomer having a carboxyl group at a composition ratio ranging from 20 to 99 mol %.

In the invention, as (a) a long chain alkyl group-containing polymer, for example, it is preferable that the polymer consists of a copolymer represented by the following formula (I).

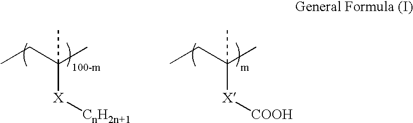

In the formula (I), X and X′ each represents, independently, a single bond or a divalent tethering group. And, m represents an integer of 20<m<99, preferably an integer of 30<m<90, further preferably an integer of 45<m<80. And, n represents an integer of 6 to 40, more preferably an integer of 12 to 30, further preferably an integer of 14 to 20. A bond represented by a dotted line means that there is a methyl group or hydrogen at a tip end thereof.

Examples of a divalent tethering group represented by X or X′ in the formula (I) include a straight, branched or cyclic alkylene group of a carbon number of 1 to 20, a straight, branched or cyclic alkylene group of a carbon number of 2 to 20, an alkynylene group of a carbon number of 2 to 20, an arylene group (monocycle, heterocycle) of a carbon number of 6 to 20, —OC(═O)—, —OC(═O)Ar—, —OC(═O)O—, —OC(═O)OAr—, —C(═O)NR—, —C(═O)NAr—, —SO₂NR—, —SO₂NAr—, —O-(alkyleneoxy, polyalkyleneoxy), —OAr-(aryleneoxy, polyaryleneoxy), —C(═O)O—, —C(═O)O—Ar—, —C(═O)Ar—, —C(═O)—, —SO₂O—, —SO₂OAr—, —OSO₂—, —OSO₂Ar—, —NRSO₂—, —NArSO₂—, —NRC(═O)—, —NArC(═O)—, —NRC(═O)O—, —NArC(═O)O—, —OC(═O)NR—, —OC(═O)NAr—, —NAr—, —NR—, —N⁺RR′—, —N⁺RAr—, —N⁺ArAr′—, —S—, —SAr—, —ArS—, a heterocyclic group (3 to 12-membered monocycle or fused ring containing, for example, at least one of nitrogen, oxygen and sulfur as a hetero atom), —OC(═S)—, —OC(═S)Ar—, —C(═S)O—, —C(═S)OAr—, —C(═S)OAr—, —C(═O)S—, —C(═O)SAr—, —ArC(═O)—, —ArC(═O)NR—, —ArC(═O)NAr—, —ArC(═O)O—, —ArC(═O)S—, —ArC(═S)O—, —ArO—, and —ArNR—. Herein, R and R′ each represents, independently, a hydrogen atom, or a straight or branched, chain-like or cyclic alkyl group, an alkenyl group or an alkynyl group. Ar and Ar′ each represents, independently, an aryl group.

The tethering group may be such that two or more kinds of tethering groups listed herein are combined to form a tether group.

Among such the tethering groups, an arylene group (monocycle, heterocycle) of a carbon number of 6 to 20, —C(═O)NR—, —C(═O)NAr—, —O-(alkyleneoxy, polyalkyleneoxy), —OAr-(aryleneoxy, polyaryleneoxy), —C(═O)O—, —C(═O)O—Ar—, —C(═O)—, —C(═O)Ar—, —S—, —SAr—, —ArS—, —ArC(═O)—, —ArC(═O)O—, —ArO—, and —ArNR— are preferable, and an arylene group (monocycle, heterocycle) of a carbon number of 6 to 20, —C(═O)NR—, —C(═O)NAr—, —O-(alkyleneoxy, polyalkyleneoxy), —OAr-(aryleneoxyl, polyaryleneoxy), —C(═O)O—, —C(═O)O—Ar—, —SAr—, —ArS—, —ArC(═O)—, —ArC(═O)O—, —ArO—, and —ArNR— are more preferable.

The tethering group may have a substituent, and examples of the substituent include a straight, branched or cyclic alkyl group of a carbon number of 1 to 20, a straight, branched or cyclic alkenyl group of a carbon number of 2 to 20, an alkylene group of a carbon number of 2 to 20, an aryl group of a carbon number of 6 to 20, an acyloxy group of a carbon number of 1 to 20, an alkoxycarbonyloxy group of a carbon number of 2 to 20, an aryloxycarbonyloxy group of a carbon number of 7 to 20, a carbamoyloxy group of a carbon number of 1 to 20, a carbonamido group of a carbon number of 1 to 20, a sulfonamido group of a carbon number of 1 to 20, a cabamoyl group of a carbon number of 1 to 20, a sulfamoyl group of a carbon number of 0 to 20, an alkoxy group of a carbon number of 1 to 20, an aryloxy group of a carbon number of 6 to 20, an aryloxycarbonyl group of a carbon number of 7 to 20, an alkoxycarbonyl group of a carbon number of 2 to 20, a N-acylsulfamoyl group of a carbon number of 1 to 20, a N-sulfamoylcarbamoyl group of a carbon number of 1 to 20, an alkylsulfonyl group of a carbon number of 1 to 20, an arylsulfonyl group of a carbon number of 6 to 20, an alkoxycarbonylamino group of a carbon number of 2 to 20, an aryloxycarbonylamino group of a carbon number of 7 to 20, an amino group of a carbon number of 0 to 20, an imino group of a carbon number of 1 to 20, an ammonio group of a carbon number of 3 to 20, a carboxyl group, a sulfo group, an oxy group, a mercapto group, an alkylsulfinyl group of a carbon number of 1 to 20, an arylsulfinyl group of a carbon number of 6 to 20, an alkylthio group of a carbon number of 1 to 20, an arylthio group of a carbon number of 6 to 20, an ureido group of a carbon number of 1 to 20, a heterocyclic group of a carbon number of 2 to 20, an acyl group of a carbon number of 1 to 20, a sulfamoylamino group of a carbon number of 0 to 20, a silyl group of a carbon number of 2 to 20, a hydroxyl group, a halogen atom (e.g. fluorine atom, chlorine atom, bromine atom etc.), a cyano group, and a nitro group.

As (a) a long chain alkyl group-containing polymer, for example, it is preferable that the polymer consists of an acryl-based copolymer represented by the following formula (II).

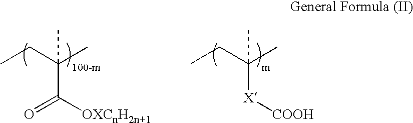

In the formula (II), X and X′ each represents, independently, a single bond or a divalent tethering group. Such the X and X′ represented in the formula (II) have the same meaning as that of X and X′ in the formula (I), and a preferable example is the same. And, m represents an integer of 20<m<99, preferably an integer of 30<m<90, further preferably an integer of 45<m<80. And, n represents an integer of 6 to 40, more preferably an integer of 12 to 30, further preferably an integer of 14 to 20. A bond represented by a dotted line means that there is a methyl group or hydrogen at its tip end.

As (a) a long chain alkyl group-containing polymer, for example, it is further preferable that the polymer consists of an acryl-based copolymer represented by the following formula (III).

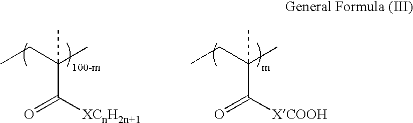

In the formula (III), X and X′ each represents, independently, a single bond or a divalent tethering group. Such the X and X′ represented in the formula (III) have the same meaning as that represented by X and X′ in the formula (I), and a preferable example is the same. And, m represents an integer of 20<m<99, preferably an integer of 30<m<90, further preferably an integer of 45<m<80. And, n represents an integer of 6 to 40, more preferably an integer of 12 to 30, further preferably an integer of 14 to 20. A bond represented by a dotted line means that there is a methyl group or hydrogen at its tip end.

As (a) a long chain alkyl group-containing polymer, for example, it is most preferable that the polymer consists of an acryl-based copolymer represented by the following formula (IV) or the formula (V).

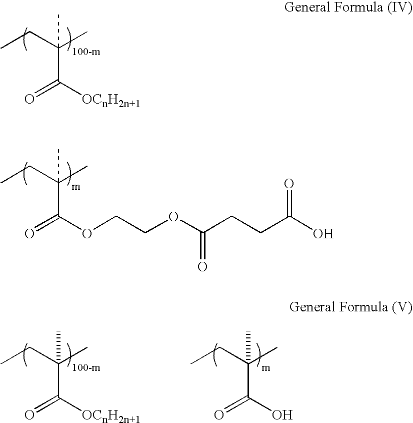

In the formula (IV) and the formula (V), m represents an integer of 20<m<99, preferably an integer of 30<m<90, further preferably an integer of 45<m<80. And, n represents an integer of 6 to 40, more preferably an integer of 12 to 30, further preferably an integer of 14 to 20. A bond represented by a dotted line means that there is a methyl group or hydrogen at its tip end.

Further, it is most preferable that (a) a long chain alkyl group-containing polymer is an acryl-based copolymer represented by the formula (V) from a viewpoint of balance between scratch resistance and alkali solubility.

(a) A long chain alkyl group-containing polymer may be a copolymer with one or more kinds selected from the following hydrophilic monomer and other monomers in addition to the monomer having a long chain alkyl group and the vinyl monomer having a carboxyl group. In this case, a mole composition ratio of other monomer in the copolymer is preferably 40 mol % or lower, more preferably 30 mole % or lower, further preferably 25 mole % or lower from a viewpoint of formation of a surface fine projection.

(Hydrophilic Monomer)

As a monomer to be copolymerized with the monomer having a long chain alkyl group and the vinyl monomer having a carboxyl group a hydrophilic monomer is preferable from a viewpoint of solubility in an alkali developer, and sensitivity.

As such the hydrophilic monomer, a monomer having an acidic group listed in the following (1) to (5) is preferable, from a viewpoint of solubility in an alkaline developer, and sensitivity.

(1) Phenol group (—Ar—OH),

(2) Sulponamido group (—SO₂NH—R),

(3) Active imido group (—SO₂NHCOR, —SO₂NHSO₂R, —CONHSO₂R),

(4) Sulfonic acid group (—SO₃H),

(5) Phosphoric acid (—OPO₃H₂)

In the (1) to (5), Ar represents a divalent aryl tethering group optionally having a substituent and, R represents a hydrocarbon group optionally having a substituent.

Examples of a monomer having the (1) phenol group include acrylamide, methacrylamide, acrylic acid ester, methacrylic acid ester, or hydroxystyrene, which have a phenol group.

Examples of a monomer having the (2) sulponamido group include a compound having each one or more of sulponamido groups of the above structure and polymerizable unsaturated groups in a molecule. Inter alia, a low-molecular compound having an acryloyl group, an aryl group or a vinyloxy group and a sulponamido group in a molecule is preferable. Examples include compounds represented by the following formulae (i) to (v).

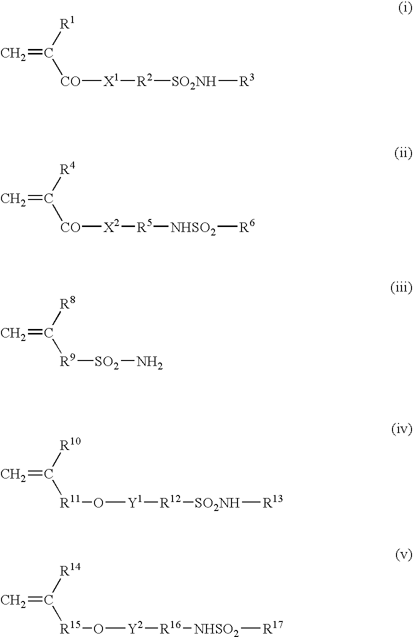

In the formulae (i) to (v), X¹ and X² each represents, independently, —O— or —NR⁷—. R¹ and R⁴ each represents, independently, a hydrogen atom or —CH₃. R², R⁵, R⁹, R¹² and R¹⁶ each represents, independently, an alkylene group of a carbon number of 1 to 12 optionally having a substituent, a cycloalkylene group, an arylene group or an aralkylene group. R³, R⁷ and R¹³ each represents, independently, a hydrogen atom, an alkyl group of a carbon number of 1 to 12 optionally having a substituent, a cycloalkyl group, an aryl group or an aralkyl group. R⁶ and R¹⁷ each represents, independently, an alkyl group of a carbon number of 1 to 12 optionally having a substituent, a cycloalkyl group, an aryl group, or an aralkyl group. R⁸, R¹⁰ and R¹⁴ each represents, independently, a hydrogen atom or —CH₃. R¹¹ and R¹⁵ each represents, independently, a single bond, or an alkylene group of a carbon number of 1 to 12 optionally having a substituent, a cycloalkylene group, an arylene group or an aralkylene group. Y¹ and Y² each represents, independently, a single bond or —CO—.

Among compounds represented by the formulae (i) to (v), in the planographic printing plate precursor of the invention, particularly, m-aminosulfonylphenyl methacrylate, N-(p-aminosulfonylphenyl)methacrylamide, and N-(p-aminosulfonylphenyl)acrylamide can be preferably used.

Examples of a monomer having the (3) active imido group include a compound having each one or more of active imido groups represented by the above structural formula and polymerizable unsaturated groups in a molecule. Inter alia, a compound having each one or more of unactive imido groups represented by the following structural formula and polymerizable unsaturated groups in a molecule is preferable.

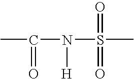

Specifically, N-(p-toluenesulfonyl)methacrylamide, and N-(p-toluenesulfonyl)acrylamide can be preferably used.

Examples of a monomer having the (4) sulfonic acid group include a compound having each one or more of sulfonic acid groups and polymerizable unsaturated groups in a molecule.

Examples of a monomer having the (5) phosphoric acid group include a compound having each one or more of phosphoric acid groups and polymerizable unsaturated groups.

Among the above hydrophilic monomers, a monomer having (1) a phenol group, (2) a sulponamido group, or (3) an active imido group is preferable and, particularly, a monomer having (1) a phenol group, or (2) a sulponamido group is most preferable from a viewpoint of sufficient maintenance of solubility in an alklyene developer, development latitude, and a film strength.

[Other Monomer]

Example of other monomer copolymerizable with the monomer having a long chain alkyl group and the vinyl monomer having a carboxyl group include compounds listed in the following (6) to (16).

(6) Acrylic acid esters, and methacrylic acid esters having an aliphatic hydroxy group such as 2-hydroxyethyl acrylate and 2-hydroxyethyl metacrylate.

(7) Acrylate such as methyl acrylate, ethyl acrylate, propyl acrylate, amyl acrylate, benzyl acrylate, 2-chloroethyl acrylate, glycidyl acrylate, N-dimethylaminoethyl acrylate, polyethylene glycol monoacrylate, and polypropylene glycol monoacrylate.

(8) Methacrylate such as methyl methacrylate, ethyl methacrylate, propyl methacrylate, amyl methacrylate, cyclohexyl methacrylate, benzyl methacrylate, 2-chloroethyl methacrylate, glycidyl methacrylate, N-dimethylaminoethyl methacrylate, polyethylene glycol monomethacrylate, and polypropylene glycol monomethacrylate.

(9) Acrylamide or methacrylamide such as acrylamide, methacrylamide, N-methylolacrylamide, N-ethylacrylamide, N-hexylmethacrylamide, N-cyclohexylacrylamide, N-hydroxlethylacrylamide, N-phenylacrylamide, N-nitrophenylacrylamide, and N-ethyl-N-phenylacrylamide.

(10) Vinyl ethers such as ethyl vinyl ether, 2-chloroethyl vinyl ether, hydroxyethylvinyl ether, propyl vinyl ether, butyl vinyl ether, and phenyl vinyl ether.

(11) Vinyl esters such as vinyl acetate, vinyl chloroacetate, vinyl butyrate, and vinyl benzoate.

(12) Styrenes such as styrene, α-methyl styrene, methylstyrene, and chloromethylstyrene.

(13) Vinyl ketones such as methyl vinyl ketone, ethyl vinyl ketone, propyl vinyl ketone, and phenyl vinyl ketone.

(14) Olefins such as ethylene, propylene, isobutylene, butadiene, and isoprene.

(15) N-vinylpyrrolidone, N-vinylcarbazole, 4-vinylpyridine, acrylonitrile, and methacrylonitrile.

(16) Unsaturated imide such as malemide, N-acryloylacrylamide, N-acetylmethacrylamide, N-propionylmethacrylamide, and N-(p-chlorobenzoyl)methacrylamide.

As a method of copolymerizing the above listed monomer having a long chain alkyl group, vinyl monomer having a carboxyl group, hydrophilic monomer and other monomer, the conventionally known graft copolymerization method, a block copolymerization method and a random copolymerization method can be used. In addition, in this copolymerization, two or more kinds of each monomer can be used by mixing them. When two or more kinds of a monomer having a carboxyl group are used by mixing them, if a sum of mole composition ratios of those used monomers is with at a composition ratio ranging from 20 to 99 mole %, they can be (a) a long chain alkyl group-containing polymer in the present application.

Examples of (a) a long chain alkyl group-containing polymer in the invention are not limited to, but include the following polymers.

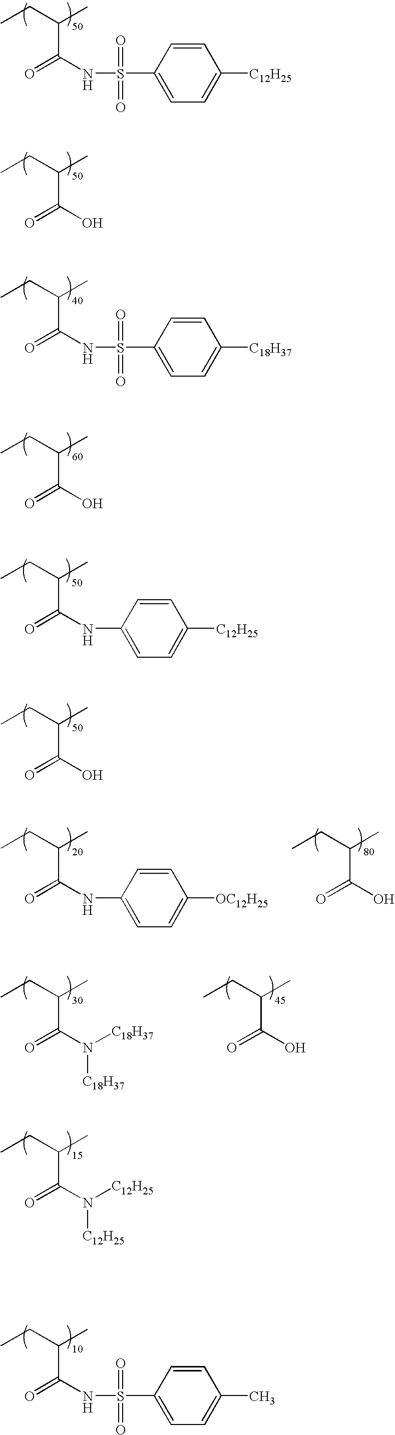

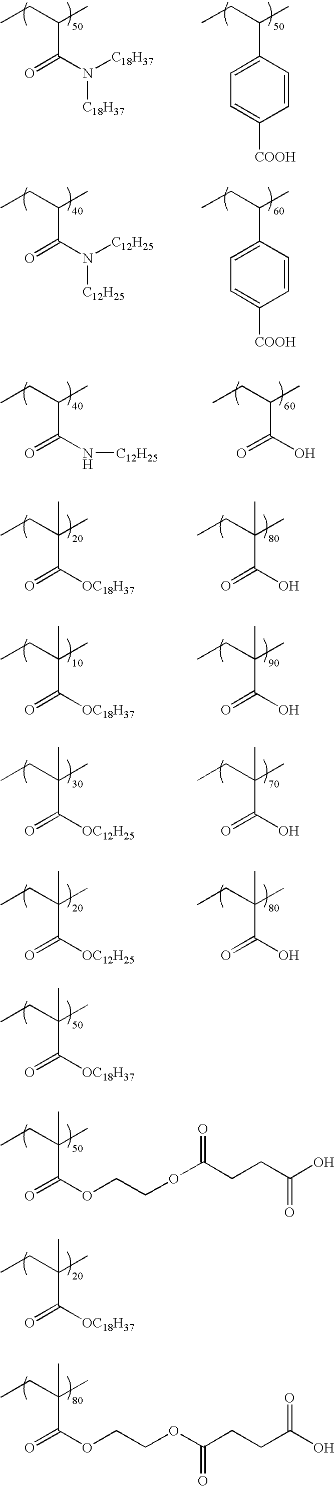

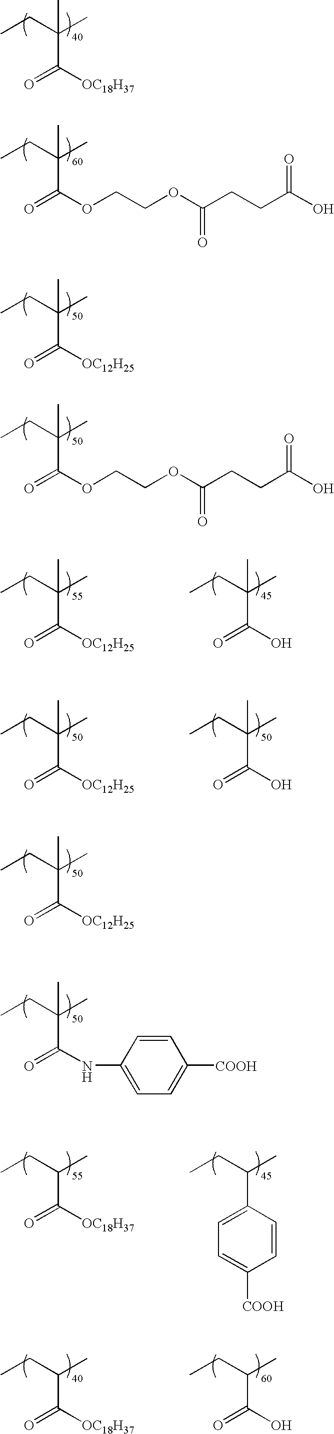

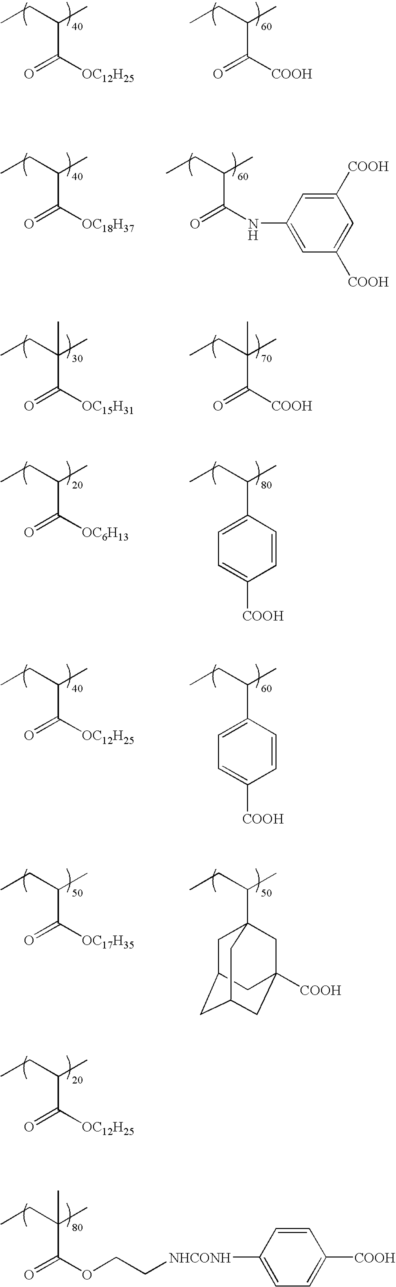

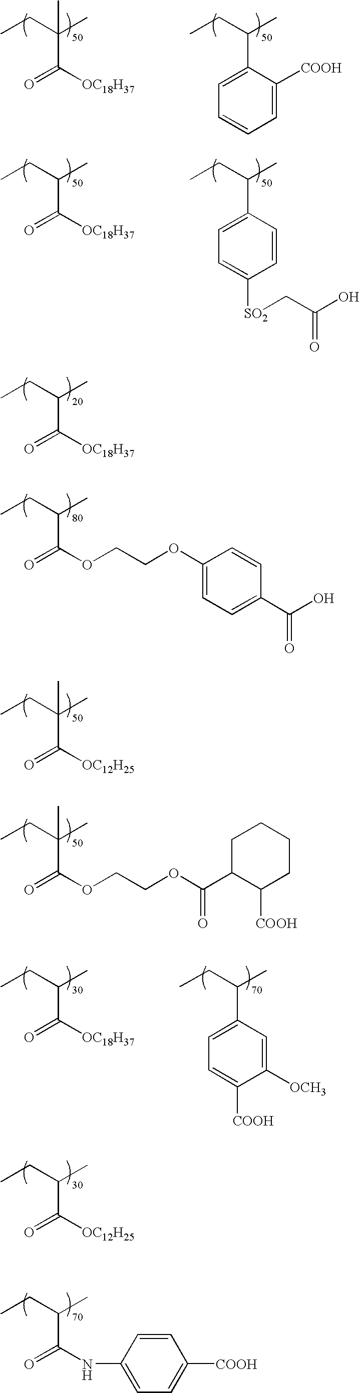

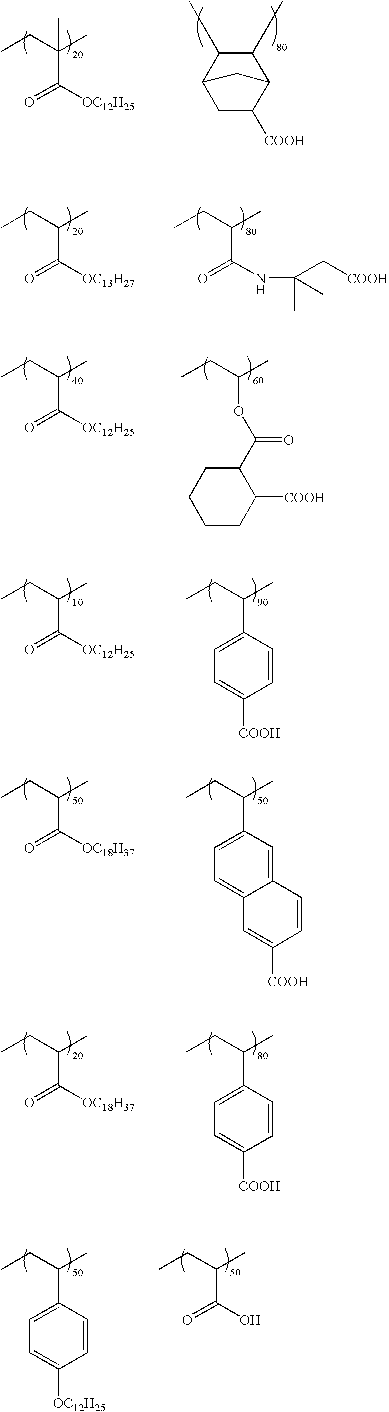

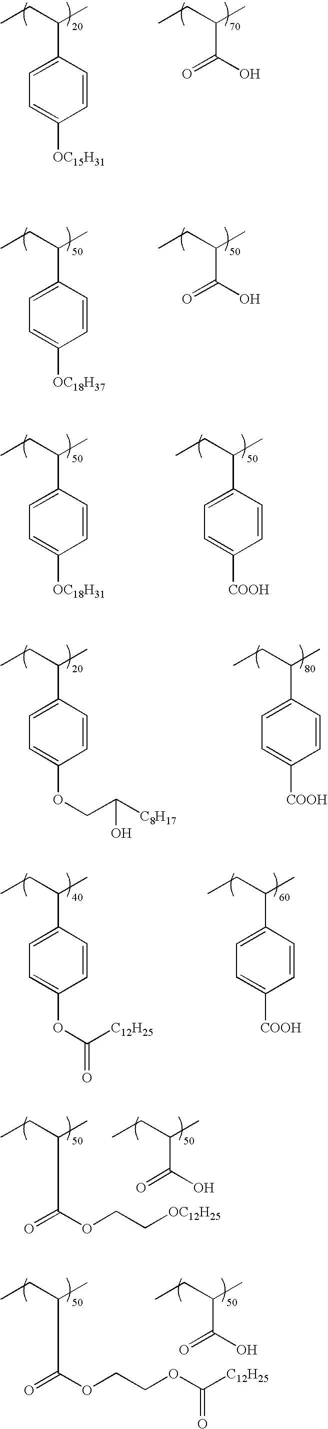

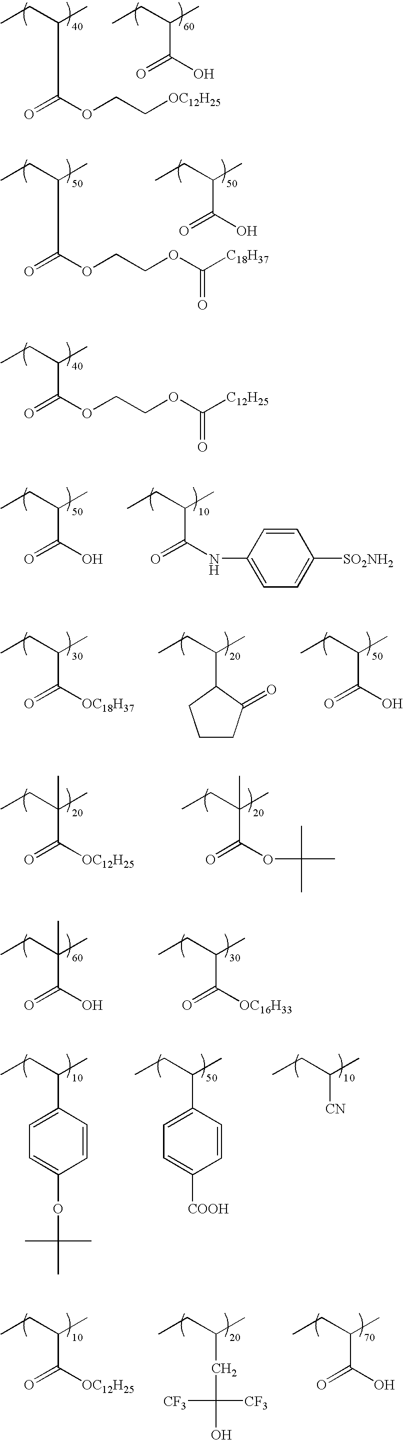

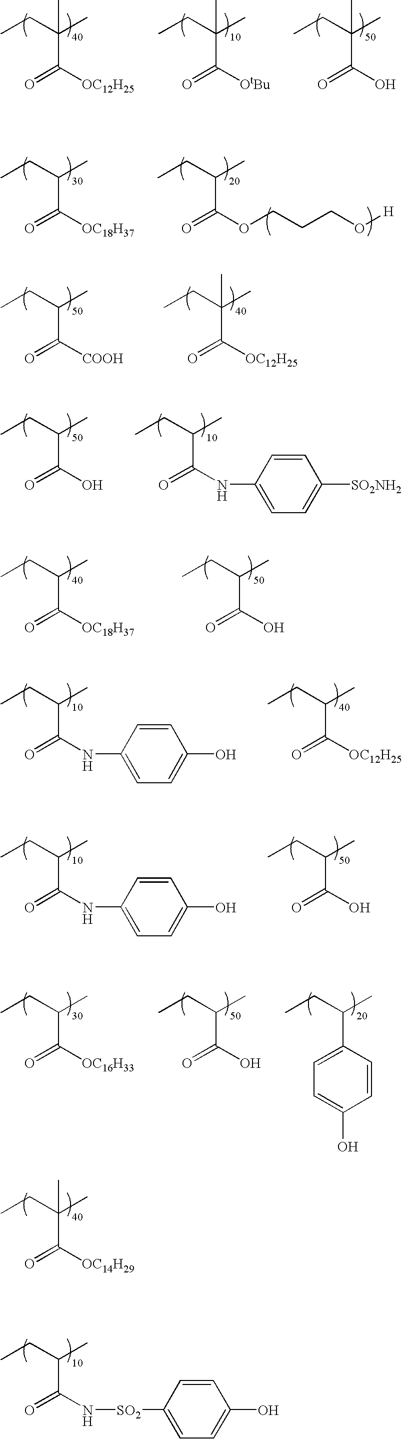

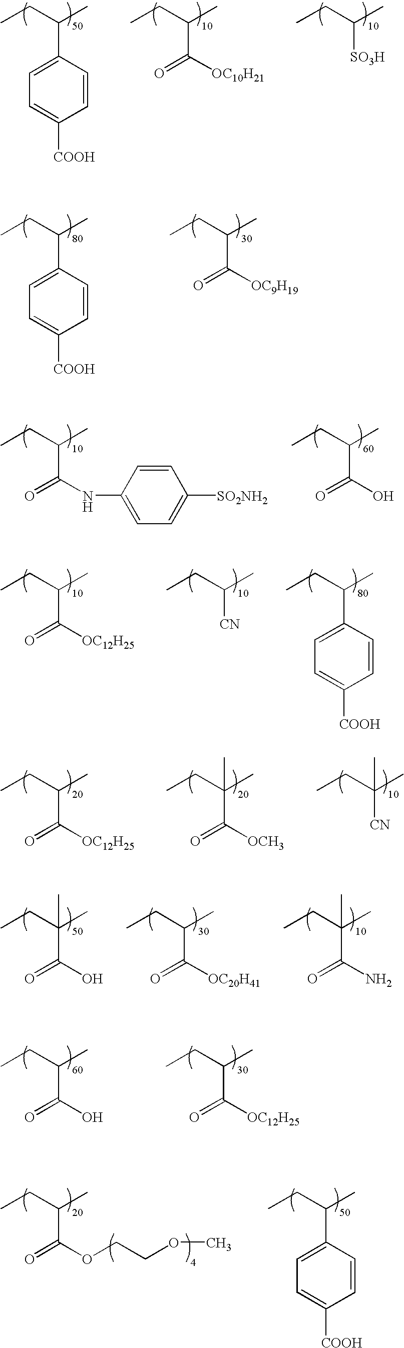

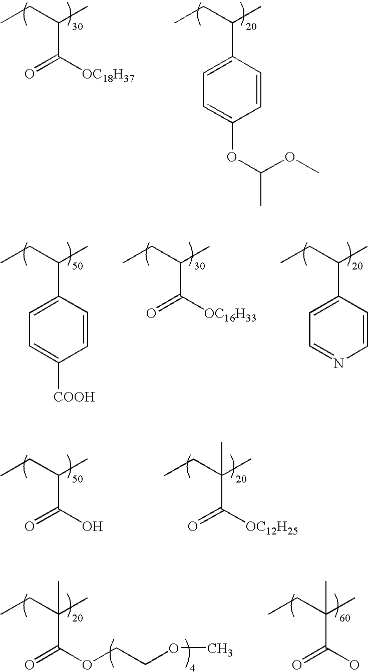

As (a) a long chain alkyl group-containing polymer used in the invention, a polymer having a mass average molecular weight of 5,000 or more, and a number average molecular weight of 1,000 or more is preferably used. Further preferably, a mass average molecular weight in terms of polystyrene is 10,000 to 5,000,000 particularly preferably 10,000 to 2,000,000, further preferably 20,000 to 1,000,000. Such the polymers may be used alone, or two or more kinds may be used in a combination thereof

An amount of a monomer remaining in (a) a long chain alkyl group-containing polymer is preferably 10% by mass or less, more preferably 5% by mass or less, from a problem of transference onto a protective paper (interleaving paper) or a substrate back, upon lamination of planographic printing plate precursors of the invention and transference onto a roller at manufacturing of a planographic printing plate precursor.

For forming a recording layer, the (a) long chain alkyl group-containing polymer, and respective components used in a recording layer described later are mixed, and a recording layer coating solution is coated on a support. Thereby, the (a) long chain alkyl group-containing polymer, and a polymer compound contained in recording layer components, for example, an alkali-soluble resin described later cause phase separation, the (a) long chain alkyl group-containing polymer is self-aggregated, and a fine projection is formed on a surface.

Herein, an addition amount of such the (a) long chain alkyl group-containing polymer contained in a recording layer total solid matter is preferably around 0.1 to 20% by mass, further preferably 0.5 to 10% by mass. When a content is less than 0.1% by mass, formation of irregularities is insufficient, and the scratch resistance improving effect is not sufficiently obtained and, when the content exceeds 20% by mass, there is a tendency that a strength of an upper recording layer is reduced, and printing resistance is deteriorated.

Besides, examples of preferable property of an image recording material for sufficiently exerting the effect of the invention include a contact angle of a water droplet in the air on a surface of the recording layer after formation of a recording layer containing the (a) long chain alkyl group-containing polymer, in a range of 60 degree to 140 degree, and a dynamic friction coefficient on a surface of a recording layer at manufacturing of a film of the recording layer containing the (a) long chain alkyl group-containing polymer, in a range of 0.38 to 0.70, and a kind and an addition amount of the (a) long chain alkyl group-containing polymer may be determined in view of them. A dynamic friction coefficient mentioned herein refers to a value measured according to standard ASTM D1894 by arrangement so as to contact the recording layer surface and a stainless steel.

((b) Infrared Absorbing Agent)

A recording layer in the invention is required to contain (b) an infrared absorbing agent. As the infrared absorbing agent, a substance which absorbs a light energy irradiated beam, and produces heat can be used without any limitation in an absorption wavelength region, however from a viewpoint of suitability with an easily available high output laser, preferable examples include an infrared absorbing dye or pigment having absorption maximum in a wavelength of 760 nm to 1200 nm.

As the infrared absorbing dye, commercially available dyes, for example, known dyes described in documents such as “DYE HANDBOOK” (edited by Organic Synthetic Chemical Society, published in 1970) may be utilized. Specific examples of the dye include azo dyes, metal complex salt azo dyes, pyrazolone azo dyes, naphthoquinone dyes, anthraquinone dyes, phthalocycnine dyes, carbonium dyes, quinoneimine dyes, methine dyes, cyanine dyes, squalillium dyes, pyrylium salts, metal thiolate complexes, oxonol dyes, diimmonium dyes, aminium dyes and croconium dyes.

Preferable examples of the dye may include cyanine dyes described in, for example, JP-A Nos. 58-125246, 59-84356, 59-202829 and 60-78787, methine dyes described in, for example, JP-A Nos. 58-173696, 58-181690 and 58-194595, naphthoquinone dyes described in, for example, JP-A Nos. 58-112793, 58-224793, 59-48187, 59-73996, 60-52940 and 60-63744, squalillium dyes described in, for example, JP-ANo. 58-112792 and cyanine dyes described in U.K. Patent No. 434,875.

A near-infrared absorbing sensitizer described in U.S. Pat. No. 5,156,938 is also preferably used. Substituted arylbenzo(thio)pyrylium salts described in U.S. Pat. No. 3,881,924, trimethinethiapyrylium salts described in JP-A No. 57-142645 (U.S. Pat. No. 4,327,169), pyrylium type compounds described in JP-A Nos. 58-181051, 58-220143, 59-41363, 59-84248, 59-84249, 59-146063 and 59-14606, cyanine dyes described in JP-A No. 59-216146, pentamethinethiopyrylium salts described in U.S. Pat. No. 4,283,475 and pyrylium compounds disclosed in Japanese Patent Application Publication (JP-B) Nos. 05-13514 and 05-19702 are also preferably used.

Also, other preferable examples of the dye may include near-infrared absorbing dyes described as the formulae (I) and (II) in U.S. Pat. No. 4,756,993.

Particularly preferable examples among these dyes include cyanine dyes, phthalocyanine dyes, oxonol dyes, squarylium dyes, pyrylium salts, thiopyrylium dyes and nickel thiolate complexes. Furthermore, dyes represented by the following formulae (a) to (e) have high light-to-heat conversion efficiency and are therefore preferable. Particularly cyanine dyes represented by the following formula (a) give a high interaction with an alkali-soluble resin, are also superior in stability and economical when used as the resin composition of the invention and are therefore most preferable.

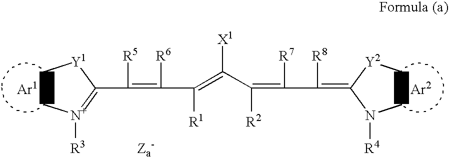

In the formula (a), X¹ represents a hydrogen atom, a halogen atom, —NPh₂, X²-L¹ or a group shown below. Here, X² represents an oxygen atom or a sulfur atom and L¹ represents a hydrocarbon group having 1 to 12 carbon atoms, an aromatic ring having a hetero group, a hydrocarbon group including a heteroatom and having 1 to 12 carbon atoms. Here, the heteroatom indicates N, S, O, a halogen atom or Se.

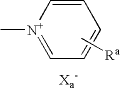

In the above formula, Xₐ⁻ is defined in the same manner as in the case of Zₐ⁻ and R^{a} represents a substituent selected from a hydrogen atom, an alkyl group, an aryl group, a substituted or unsubstituted amino group and a halogen atom.

In the formula (a), R¹ and R² respectively represent a hydrocarbon group having 1 to 12 carbon atoms. R¹ and R² respectively preferably a hydrocarbon group having 2 or more carbon atoms and are particularly preferably combined with each other to form a five-membered or six-membered ring.

Ar¹ and Ar², which may be the same or different, respectively represent an aromatic hydrocarbon group which may have a substituent. Preferable examples of the aromatic hydrocarbon group include a benzene ring and a naphthalene ring. Also, preferable examples of the substituent include a hydrocarbon group having 12 or less carbon atoms, a halogen atom or an alkoxy group having 12 or less carbon atoms.

Y¹ and Y², which may the same or different, respectively represent a sulfur atom or a dialkylmethylene group having 12 or less carbon atoms.

R³ and R⁴, which may be the same or different, represents a hydrocarbon group which has 20 or less carbon atoms and may have a substituent. Preferable examples of the substituent include an alkoxy group having 12 or less carbon atoms, carboxyl group and sulfo group.

R⁵, R⁶, R⁷ and R⁸, which may be the same or different, respectively represent a hydrogen atom or a hydrocarbon group having 12 or less carbon atoms, and are respectively preferably a hydrogen atom in view of availability of raw materials.

In addition, Za⁻ donates a counteranion. When a cyanine pigment represented by the formula (a) has an anionic substituent in its structure, and neutralization of a charge is not necessary, Za⁻ is not necessary. From a viewpoint of storage stability of a recording layer coating solution, preferable Za⁻ includes a halogen ion, a perchlorate ion, a tetrafluoroborate ion, a hexafluorophosphate ion, a carboxylic acid ion, and a sulfonic acid ion. From a viewpoint of compatibility with an alkali-soluble resin, and solubility in a coating solution, a halogen ion, and an organic acid ion such as a carboxylic acid ion and a sulfonic acid ion are preferable, a sulfonic acid ion is more preferable and, inter alia, an arylsulfonic acid ion is particularly preferable.

Specific examples of the cyanine dye which is represented by the formula (a) and is preferably used in the invention may include those given below and those described in JP-A No. 2001-133969, paragraphs Nos. [0017] to [0019], JP-A No. 2002-40638, paragraphs No. [0012] to [0038] and JP-A No. 2002-23360, paragraphs No. [0012] to [0023].

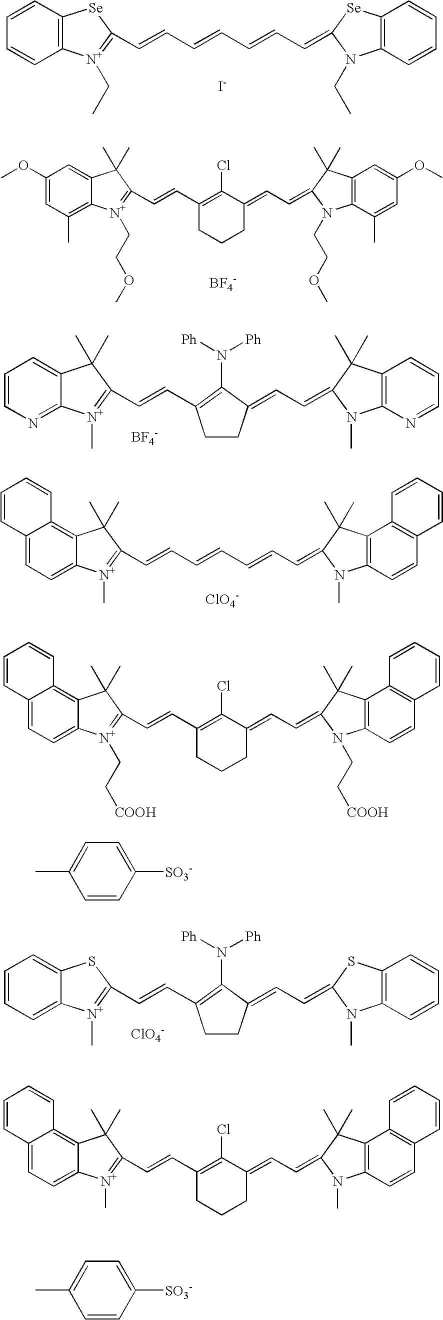

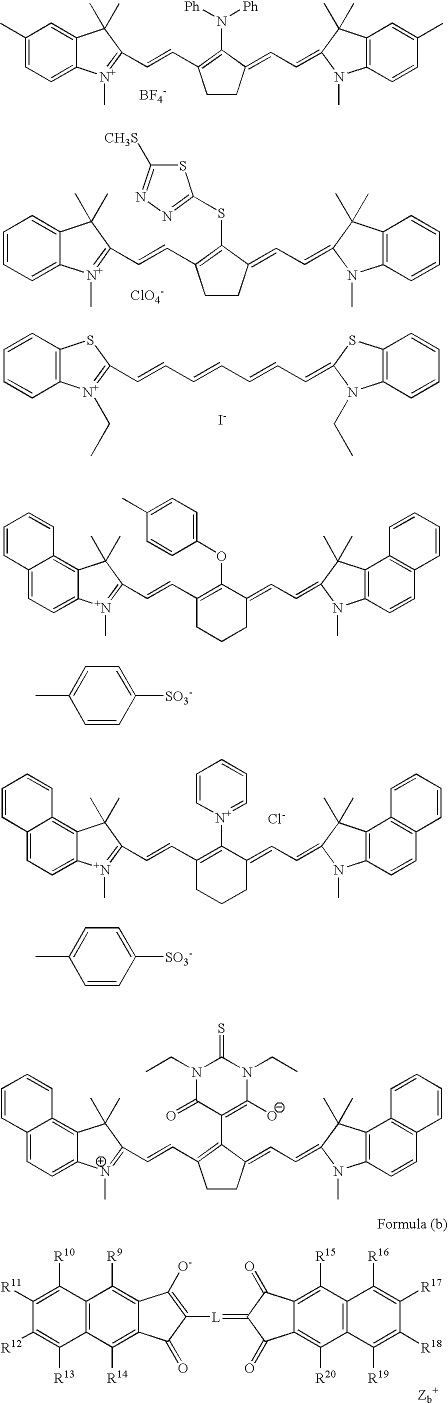

In the formula (b), L represents a methine chain having 7 or more conjugate carbon atoms, wherein the methine chain may have substituents, which may be combined with each other to form a cyclic structure. Z_{b}⁺ represents a counter cation. Preferable examples of the counter cation include ammonium, iodonium, sulfonium, phosphonium, pyridinium and alkali metal cations (Ni⁺, K⁺ and Li⁺).

R⁹ to R¹⁴ and R¹⁵ to R²⁰ respectively represent a hydrogen atom or a substituent selected from a halogen atom, a cyano group, an alkyl group, an aryl group, an alkenyl group, an alkinyl group, a carbonyl group, a thio group, a sulfonyl group, a sulfinyl group and an oxy group and an amino group or a substituent which is a combination of two or three of these groups and may be combined with each other to form a cyclic structure.

Among the compounds represented by the formula (b), those represented by the formula (b) in which L represents a methine chain having 7 conjugate carbon atoms and those represented by the formula (b) in which all of R⁹ to R¹⁴ and R¹⁵ to R²⁰ respectively represent hydrogen atom are preferable from the viewpoint of availability and effect.

Specific examples of the dye represented by the formula (b) which can be preferably used in the invention may include those exemplified below.

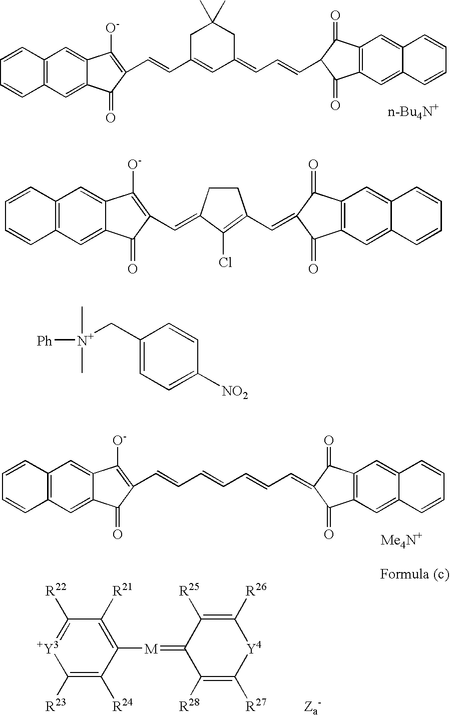

In the formula (c), Y³ and Y⁴ respectively represent an oxygen atom, a sulfur atom, a selenium atom or a tellurium atom. M represents a methine chain having 5 or more conjugate carbon atoms. R²¹ to R²⁴ and R²⁵ to R²⁸, which may be the same or different, respectively represent a hydrogen atom, a halogen atom, a cyano group, an alkyl group, an aryl group, an alkenyl group, an alkinyl group, a carbonyl group, a thio group, a sulfonyl group, a sulfinyl group, an oxy group or an amino group. Also, Zₐ⁻ in the formula represents an anion and has the same meaning as Zₐ⁻ in the formula (a).

Specific examples of the dye represented by the formula (c) which can be preferably used in the invention may include those exemplified below.

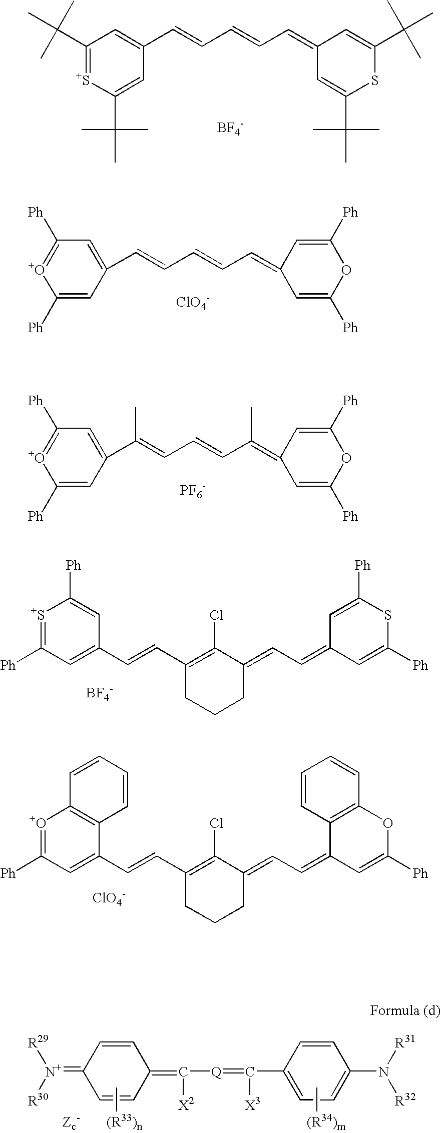

In the formula (d), R²⁹ to R³¹ respectively represent a hydrogen atom, an alkyl group or an aryl group. R³³ and R³⁴ respectively represent an alkyl group, a substituted oxy group or a halogen atom. n and m respectively denote an integer from 0 to 4. R²⁹ and R³⁰ or R³¹ and R³² may be combined with each other to form a ring. Also, R²⁹ and/or R³⁰ and R³³ or R³¹ and/or R³² and R³⁴ may be combined with each other to form a ring. Moreover, when R³³ or R³⁴ is present in the plural, R³³s or R³⁴s may be combined among them to form a ring.

X² and X³ respectively represent a hydrogen atom, an alkyl group or an aryl group provided that at least one of X² and X³ represents a hydrogen atom or an alkyl group.

Q represents a trimethine group or a pentamethine group which may have a xubstituent and may form a cyclic structure in combination with a divalent organic group. Z_{c}⁻ represents a counter anion and has the same meaning as Zₐ⁻ in the above formula (a).

Specific examples of the dye represented by the formula (d) which can be preferably used in the invention may include those exemplified below.

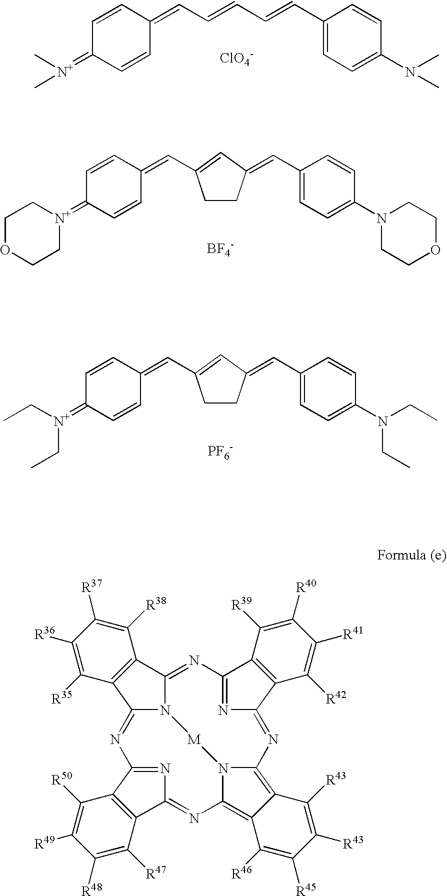

In the formula (e), R³⁵ to R⁵⁰ respectively represent a hydrogen atom, a halogen atom, a cyano group, an alkyl group, an aryl group, an alkenyl group, an alkinyl group, a hydroxyl group, a carbonyl group, a thio group, a sulfonyl group, a sulfinyl group, an oxy group, an amino group or an onium salt structure which may have a substituent. M represents two hydrogen atoms or a metal atom, a halo-metal group or an oxy metal group. Examples of the metal atoms contained therein include the IA, IIA, IIIB or IVB group atoms in the periodic chart, transition metals of the first, second and third periods and lanthanoids. Among these materials, copper, magnesium, iron, zinc, cobalt, aluminum, titanium and vanadium are preferable.

Specific examples of the dye represented by the formula (e) which can be preferably used in the invention may include those exemplified below.

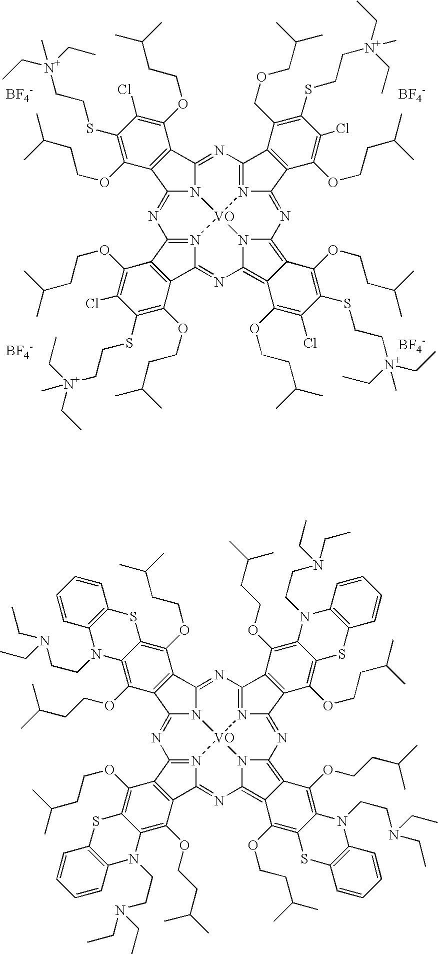

Examples of the pigment to be used as the infrared absorber in the invention include commercially available pigments and pigments described in Color Index (C.I.) Handbook, “Latest Pigment Handbook” (edited by Japanese Pigment Technological Society, published in 1977), “Latest Pigment Applied Technology” (CMC Publishing Co., Ltd., published in 1986) and “Printing Ink Technology” CMC Publishing Co., Ltd., published in 1984).

Examples of these pigments include black pigments, yellow pigments, orange pigments, brown pigments, red pigments, violet pigments, blue pigments, green pigments, fluorescent pigments, metal powder pigments and polymer binder dyes. Specifically, insoluble azo pigments, azo lake pigments, condensed azo pigments, chelate azo pigments, phthalocyanine type pigments, anthraquinone type pigments, perylene and perinone type pigments, thioindigo type pigments, quinacridone type pigments, dioxazine type pigments, isoindolinone type pigments, quinophthalone type pigments, dyeing lake pigments, azine pigments, nitroso pigments, nitro pigments, natural pigments, fluorescent pigments, inorganic pigments, carbon black and the like may be used. Among these pigments, carbon black is preferable.

These pigments may be used either without any surface treatment or with some surface treatment. As the surface treating method, it is considered to use, for example, a method in which the surface is coated with a resin or wax, a method in which a surfactant is stuck to the surface of a pigment or a method in which a reactive material (e.g., a silane coupling agent, epoxy compound and polyisocyanate) is bound with the surface of a pigment. The above surface treating methods are described in “Nature and Application of Metal Soaps” (Saiwai Shobo), “Printing Ink Technology” CMC Publishing Co., Ltd., published in 1984) and “Latest Pigment Applied Technology” (CMC Publishing Co., Ltd., published in 1986).

The particle diameter of the pigment is preferably in a range of 0.01 μm to 10 μm, more preferably in a range of 0.05 μm to 1 μm and particularly preferably in a range of 0.1 μm to 1 μm, in terms of the stability of the particles in the coating solution for the recording layer and the uniformity of the resulting recording layer.

As a method of dispersing the pigment, known dispersing technologies used for the production of ink and toners may be used. Examples of a dispersing machine include a ultrasonic dispersing machine, sand mill, attritor, pearl mill, super mill, ball mill, impeller, disperser, KD mill, colloid mill, dynatron, three-roll mill and pressure kneader. The details of these machines are described in “Latest Pigment Apply Technology” (CMC Publishing Co., Ltd., published in 1986).

These pigments or dyes are 0.01 to 50% by mass, preferably 0.1 to 10% by mass relative to a total solid matter constituting a recording layer. A dye can be added particularly preferably at a ratio of 0.5 to 10% by mass, and a pigment can be added at a ratio of particularly preferably 0.1 to 10% by mass. When an addition amount of a pigment or a dye is less than 0.01% by mass, there is a tendency that sensitivity is reduced and, when a pigment or dye is blended at an amount exceeding 50% by mass, there is a fear that as a blending amount is increased, uniformity of a recording layer, and durability of a recording layer are not preferably influenced.

((a) Polymer Compound which is not Compatible with Long Chain Alkyl Group-Containing Polymer)

As described above, in the image recording material of the invention, by using a polymer compound which is not compatible with (a) a long chain alkyl group-containing polymer, both cause phase separation, and (a) a long chain alkyl group-containing polymer is self-aggregated, thereby, a fine projection consisting of (a) a long chain alkyl group-containing polymer is formed on a recording layer surface. In the invention, as such the polymer compound, an alkali-soluble resin is preferably used.

<Alkali-Soluble Resin>

The aforementioned alkali-soluble resin is a water-insoluble and alkali-soluble resin, and includes homopolymers containing an acyclic group on a main chain and/or a side chain in a polymer, a copolymer of them and a mixture of them. Inter alia, entities having an acyclic group listed in the following (1) to (6) on a main chain and/or a side chain of a polymer are preferable from the points of solubility in an alkaline developer, and manifestation of dissolution suppressing ability.

(1) phenol (—Ar—OH),

(2) sulfone amide (—SO₂NH—R),

(3) substituted sulfoneamido based acid group (hereinafter, referred to as active imido group) [—SO₂NHCOR, —SO₂NHSO₂R, —CONHSO₂R]

(4) carboxylic acid group (—CO₂H),

(5) sulfonic acid group (—SO₃H), and

(6) phosphoric acid group (—OPO₃H₂)

Ar in the above-mentioned groups (1) to (6) represents a divalent aryl bonding group optionally comprising a substituent group and R represents a hydrocarbon group optionally comprising a substituent group.

Among the alkali-soluble resin comprising the acidic group selected from the above-mentioned (1) to (6), an alkali-soluble resin comprising (1) phenol, (2) sulfone amide, or (3) active imido group is preferable and an alkali-soluble resin comprising (1) phenol or (2) sulfone amide is more preferable in terms of assurance of the sufficient solubility in an alkaline developer, development latitude, and film strength.

As the alkali-soluble resin comprising the acidic group selected from the above-mentioned (1) to (6), the following can be exemplified.

(1) Examples of the alkali-soluble resin comprising phenol group may include novolak resin such as condensation polymers of phenol and formaldehyde; condensation polymers of m-cresol and formaldehyde, condensation polymers of p-cresol and formaldehyde, condensation polymers of m-/p-mixed cresol and formaldehyde, and condensation polymers of phenol, cresol (m-, p-, or m-/p-mixture) and formaldehyde; and condensation copolymers of pyrogallol and acetone. Further, copolymers obtained by copolymerizing compound comprising phenyl groups in the side chains can be exemplified. Or, copolymers obtained by copolymerizing compounds comprising phenyl groups in the side chains can also be used.

As the compounds comprising phenol group, acrylamide, methacrylamide, acrylic acid ester, methacrylic acid ester, or hydroxystyrene can be exemplified.

(2) Examples of the alkali-soluble resin comprising sulfoneamido group may include a polymer obtained by using the minimum component units derived from compounds comprising sulfoneamido group as main constituent components. Examples of such compounds include those having at least one sulfoneamido group comprising at least one hydrogen atom bonded to the nitrogen atom and at least one polymerizable unsaturated group, in the molecules. Among them, low molecular weight compounds comprising acryloyl, allyl, or vinyloxy group as well as substituted or mono-substituted aminosulfonyl group or a substituted sulfonylimino group in molecules are preferable and the aforementioned compounds defined by the following (i) to (v) can be exemplified.

Of the compounds represented by the represented by the general formulae (i) to (v), in particular, the following can preferably be used in the invention: m-aminosulfonylphenyl methacrylate, N-(p-aminosulfonylphenyl)methacrylamide and N-(p-aminosulfonylphenyl)acrylamide.

Examples of the alkali-soluble resin having an active imide group in the item (3) include a polymer mainly constituted of a minimum structural unit derived from a compound having an active imide group. Specific examples of such a compound include a compound having in the molecule thereof one or more active imide group and one or more unsaturated groups which can be polymerized with the active imide group(s).

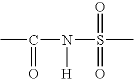

Specifically, N-(p-toluenesulfonyl)methacrylamide, N-(p-toluenesulfonyl)acrylamide and others can be preferably used.

Examples of the alkali-soluble resin having a carboxylic acid group in the item (4) include a polymer mainly constituted of a minimum structural unit derived from a compound having in the molecule thereof one or more carboxylic acid group and one or more unsaturated groups which can be polymerized with the carboxylic acid group(s).

Examples of the alkali-soluble resin having a sulfonic acid group in the item (5) include a polymer mainly constituted of a minimum structural unit derived from a compound having in the molecule thereof one or more sulfonic acid group and one or more unsaturated groups which can be polymerized with the sulfonic acid group(s).

Examples of the alkali-soluble resin having a phosphoric acid group in the item (6) include a polymer mainly constituted of a minimum structural unit derived from a compound having in the molecule thereof one or more phosphoric acid group and one or more unsaturated groups which can be polymerized with the phophoric acid group(s).

The minimum constituent unit having acidic group selected from (1) to (6), which comprises the alkali-soluble resin for the recording layer, is not necessarily limited to one particular unit, but those obtained by copolymerizing two or more minimum constituent units comprising the same acidic group or two or more minimum constituent units comprising different acidic groups can also be used.

The above-mentioned copolymer contains the compound having the acidic group selected from (1) to (6) to be copolymerized in an amount preferably 10% by mole or more, more preferably 20% by mole or more. If it is less than 10% by mole, the development latitude tends to be improved insufficiently.

In the invention, when compounds are copolymerized, and an alkali-soluble resin is used as a copolymer, as a compound to be copolymerized, other compound not containing the (1) to (6) acyclic group may be used. Examples of other compound not containing the (1) to (6) include compounds listed in the following (m1) to (m12), but not limited to this.

(m1) Acrylic acid esters and methacrylic acid esters having aliphatic hydroxyl groups such as 2-hydroxyethyl acrylate or 2-hydroxyethyl methacrylate.

(m2) Alkyl acrylate such as methyl acrylate, ethyl acrylate, propyl acrylate, butyl acrylate, amyl acrylate, hexyl acrylate, octyl acrylate, benzyl acrylate, 2-chloroethyl acrylate, and glycidyl acrylate.

(m3) Alkyl methacrylate such as methyl methacrylate, ethyl methacrylate, propyl methacrylate, butyl methacrylate, amyl methacrylate, hexyl methacrylate, cyclohexyl methacrylate, benzyl methacrylate, 2-chloroethyl methacrylate, and glycidyl methacrylate.

(m4) Acrylamide or methacrylamide such as acrylamide, methacrylamide, N-methylol acrylamide, N-ethylacrylamide, N-hexylmethacrylamide, N-cyclohexylacrylamide, N-hydroxyethylacrylamide, N-phenylacrylamide, N-nitrophenylacrylamide, and N-ethyl-N-phenylacxrylamide.

(m5) Vinyl ethers such as ethyl vinyl ether, 2-chloroethyl vinyl ether, hydroxyethyl vinyl ether, propyl vinyl ether, butyl vinyl ether, octyl vinyl ether, and phenyl vinyl ether.

(m6) Vinyl esters such as vinyl acetate, vinyl chloroacetate, vinyl butylate, and vinyl benzoate.

(m7) Styrenes such as styrene, α-methylstyrene, methylstyrene, and chloromethylstyrene.

(m8) Vinyl ketones such as methyl vinyl ketone, ethyl vinyl ketone, propyl vinyl ketone, and phenyl vinyl ketone.

(m9) Olefins such as ethylene, propylene, isobutylene, butadiene, and isoprene.

(m10) N-vinylpyrrolidone, acrylonitrile, and methacrylonitrile.

(m11) Unsaturated imides such as maleimide, N-acryloylacrylamide, N-acetylmethacrylamide, N-propionylmethacrylamide, and N-(p-chlorobenzoyl)methacrylamide.

(m12) Unsaturated carboxylic acid such as acrylic acid, methacrylic acid, maleic anhydride, and itaconic acid.

As the alkali-soluble resin, in terms of the excellent image formability by exposure by infrared laser, it is preferable to comprise phenolic hydroxyl groups and preferable examples of the resin to be usable are novolak resins and pyrogallol acetone resins such as phenol formaldehyde resin, m-cresol formaldehyde resin, p-cresol formaldehyde resin, m-/p-mixed cresol formaldehyde resin, and phenol/cresol (either m-, p- or m-/p-mixed) mixed formaldehyde resin.

Also, as the alkali-soluble resin having phenolic hydroxyl groups, condensed copolymers of phenol and formaldehyde comprising alkyl having 3 to 8 carbon atoms such as tert-butylphenol formaldehyde resin and octylphenol formaldehyde resin as a substituent group can be exemplified as described in U.S. Pat. No. 4,123,279.

The alkali-soluble resin has a weight average molecular weight preferably 500 or higher and more preferably 1,000 to 700,000 in terms of the image formability and has a number average molecular weight preferably 500 or higher and more preferably 700 to 650,000. The dispersion (the weight average molecular weight/the number average molecular weight) is preferably 1.1 to 10.

These alkali-soluble resins are used alone and two or more of them may be used in combination. In the case of combination, as described in U.S. Pat. No. 4,123,279, condensed polymers of phenol comprising alkyl having 3 to 8 carbon atoms as a substituent group and formaldehyde such as condensed polymer of tert-butylphenol and formaldehyde, condensed polymer of octyl phenol and formaldehyde, and as described in Japanese Patent Application Laid-Open No. 2000-241972 previously applied by inventors, alkali-soluble resins having phenol structure having electron attractive group in an aromatic ring may be used in combination.

As alkali-soluble resin, a polymer compound having a phenolic hydroxy group is desirable since the image forming property is improved from that, at an unexposed part, the strong hydrogen bonding property is caused, and at an exposed part, a part of hydrogen bonds is easily eliminated, and that a difference in developability at an unexposed part and an exposed part is great for a non-silicate developer. Further preferable is a novolak resin.

An alkali-soluble resin contained in a recording layer is such that a total content is preferably 30 to 98% by mass, more preferably 40 to 95% by mass in a recording layer total solid matter, from a viewpoint of durability, sensitivity and image forming property.

(Other Components of the Recording Layer)

Various types of additives may be added to the recording layer of the invention described above, according to necessity.

For example, it is preferable to add a so-called dissolution inhibitor that enhances the effect of inhibiting dissolution of the alkaline solution-soluble polymer (alkaline soluble resin) in the developer when added, such as other onium salts, aromatic sulfone compounds, aromatic sulfonate ester compounds, polyfunctional amine compounds, or the like. Among these, the combined use of a substance that is heat-decomposing and substantially lowers the solubility of the alkaline soluble resin in an un-decomposed state, such as onium salts, o-quinonediazide compounds, alkyl sulfonate ester, and the like is preferable for the aim of improving the solubility inhibiting property of the image area with regard to the developer. As the decomposable and dissolution suppressing agent, preferable examples thereof include onium salts such as diazonium salts, iodonium salts, sulfonium salts, and ammonium salts and o-quinonediazido compounds. Among these examples, onium salts such as diazonium salts, iodonium salts and sulfonium salts are more preferable.

Preferable examples of the onium salt used in the invention include diazonium salts described in S. I. Schlesinger, Photogr. Sci. Eng., 18, 387 (1974), T. S. Bal et al., Polymer, 21, 423 (1980), and JP-A No. 5-158230; ammonium salts described in U.S. Pat. Nos. 4,069,055 and 4,069,056, and JP-A No. 3-140140; phosphonium salts described in D. C. Necker et al., Macromolecules, 17, 2468 (1984), C. S. Wen et al., Teh, Proc. Conf Rad. Curing ASIA, p478 Tokyo, Oct (1988), and U.S. Pat. Nos. 4,069,055 and 4,069,056; iodonium salts described in J. V Crivello et al., Macromolecules, 10 (6), 1307 (1977), Chem. & Eng. News, Nov. 28, p31 (1988), EP No. 104,143, U.S. Pat. Nos. 5,041,358 and 4,491,628, and JP-A Nos. 2-150848 and 2-296514; sulfonium salts described in J. V. Crivello et al., Polymer J. 17, 73 (1985), J. V. Crivello et al., J. Org. Chem., 43, 3055 (1978), W. R. Watt et al., J. Polymer Sci., Polymer Chem. Ed., 22, 1789 (1984), J. V Crivello et al., Polymer Bull., 14, 279 (1985), J. V Crivello et al., Macromolecules, 14 (5), 1141 (1981), J. V Crivello et al., J. Polymer Sci., Polymer Chem. Ed., 17, 2877 (1979), EP Nos. 370,693, 233,567, 297,443 and 297,442, U.S. Pat. Nos. 4,933,377, 3,902,114, 5,041,358, 4,491,628, 4,760,013, 4,734,444 and 2,833,827, and DE Patent Nos. 2,904,626, 3,604,580 and 3,604,581; selenonium salts described in J. V. Crivello et al., Macromolecules, 10 (6), 1307 (1977), J. V Crivello et al., J. Polymer Sci., Polymer Chem. Ed., 17, 1047 (1979); arsonium salts described in C. S. Wen et al., and The Proc. Conf Rad. Curing ASIA, p478, Tokyo, Oct (1988).

Among such onium salts, diazonium salts are particularly preferable from the viewpoints of both their capacity of hindering dissolution, and their thermal decomposability. The diazonium salts represented by general formula (I) in the JP-A No. 5-158230 and the diazonium salts represented by general formula (1) in JP-A No. 11-143064 are more preferable, and diazonium salts represented by general formula (1) in the JP-A No. 11-143064, which have low absorption wavelength peaks within the visible ray range, are most preferable.

Examples of the counter ion of the onium salt include tetrafluoroboric acid, hexafluorophosphoric acid, triisopropylnaphthalenesulfonic acid, 5-nitro-o-toluenesulfonic acid, 5-sulfosalicylic acid, 2,5-dimethylbenzenesulfonic acid, 2,4,6-trimethylbenzenesulfonic acid, 2-nitrobenzenesulfonic acid, 3-chlorobenzenesulfonic acid, 3-bromobenzenesulfonic acid, 2-fluorocaprylnaphthalenesulfonic acid, dodecylbenzenesulfonic acid, 1-naphthol-5-sulfonic acid, 2-methoxy-4-hydroxy-5-benzoyl-benzenesulfonic acid, and p-toluenesulfonic acid. Among these examples, hexafluorophosphoric acid, and alkylaromatic sulfonic acids such as triisopropylnaphthalenesulfonic acid and 2,5-dimethylbezenesulfonic acid are particularly preferable.

The quinonediazide is preferably an o-quinonediazide compound. The o-quinonediazide compound used in the invention is a compound having at least one o-quinonediazide group and having an alkali-solubility increased by being thermally decomposed. The compound may be any one of compounds having various structures.

In other words, the o-quinonediazide compound assists the solubility of the photosensitive material both from the viewpoint of the effects of being thermally decomposed, and thereby losing the function of suppressing the dissolution of the binder, and the effect that the o-quinonediazide itself is changed into an alkali-soluble material.

Preferable examples of the o-quinonediazide compound used in the invention include compounds described in J. Coser, “Light-Sensitive Systems” (John Wiley & Sons. Inc.), pp. 339-352. Particularly preferable are sulfonic acid esters or sulfonamides of o-quinonediazide made to react with various aromatic polyhydroxy compounds or with aromatic amino compounds.

Further preferable examples include an ester made from benzoquinone-(1,2)-diazidesulfonic acid chloride or naphthoquinone-(1,2)-diazide-5-sulfonic acid chloride and pyrogallol-acetone resin, as described in JP-B No. 43-28403; and an ester made from benzoquinone-(1,2)-diazidesulfonic acid chloride or naphthoquinone-(1,2)-diazide-5-sulfonic acid chloride and phenol-formaldehyde resin.

Additional preferable examples include an ester made from naphthoquinone-(1,2)-diazide-4-sulfonic acid chloride and phenol-formaldehyde resin or cresol-formaldehyde resin; and an ester made from naphthoquinone-(1,2)-diazide-4-sulfonic acid chloride and pyrogallol-acetone resin.

Other useful o-quinonediazide compounds are reported in unexamined or examined patent documents, examples of which include JP-A Nos. 47-5303, 48-63802, 48-63803, 48-96575, 49-38701 and 48-13354, JP-B No. 41-11222, 45-9610 and 49-17481, U.S. Pat. Nos. 2,797,213, 3,454,400, 3,544,323, 3,573,917, 3,674,495 and 3,785,825, GB Patent Nos. 1,227,602, 1,251,345, 1,267,005, 1,329,888 and 1,330,932, and DE Patent No. 854,890.

The amount of onium salt and/or o-quinonediazide compound to be added as the decomposable dissolution suppresser(s) is preferably from 1 to 10%, more preferably from 1 to 5%, and even more preferably from 1 to 2% by relative to the total solid contents of the recording layer. The onium salts and the o-quinonediazide compounds may be used either independently or in the form of mixtures of two or more thereof.

The amount of additives other than the o-quinonediazide compound added is preferably from 0.1 to 5%, more preferably from 0.1 to 2%, and even more preferably from 0.1 to 1.5% by mass. The additives and the binder used in the invention are preferably incorporated into the same layer.

Further, dissolution suppresser having no decomposability may be used in combination. Preferable examples thereof include sulfonic acid esters, phosphoric acid esters, aromatic carboxylic acid esters, aromatic disulfones, carboxylic acid anhydrides, aromatic ketones, aromatic aldehydes, aromatic amines, and aromatic ethers, details of which are described in JP-A No. 10-268512; acidic color-developable dyes which have a lactone skeleton, an N,N-diarylamide skeleton or a diarylmethylimino skeleton and also function as a coloring agent, details of which are described in JP-A No. 11-190903; and nonionic surfactants described, details of which are described in JP-A No. 2000-105454.

In addition, as other additive, cyclic anhydrides, phenols, and organic acids may be used together in order to improve sensitivity. In addition, surfactants, image coloring agents, and plasticizers described later are also a usable additive.

Examples of cyclic acid anhydride include phthalic anhydride, tetrahydrophthalic anhydride, hexahydrophthalic anhydride, 3,6-endooxy-Δ4-tetrahydrophthalic anhydride, tetrachlorophthalic anhydride, maleic anhydride, chloromaleic anhydride, α-phenylmaleic anhydride, succinic anhydride, and pyromellitic anhydride which are described in U.S. Pat. No. 4,115,128.

Examples of phenolic compound include bisphenol A, p-nitrophenol, p-ethoxyphenol, 2,4,4′-trihydroxybenzophenone, 2,3,4-trihydroxybenzophenone, 4-hydroxybenzophenone, 4,4′,4″-trihydroxytriphenylmethane, 4,4′,3″,4″-tetrahydroxy-3,5,3′,5′-tetramethyltriphenylmethane.

Examples of the organic acid include sulfonic acids, sulfonic acids, alkylsulfuric acids, phosphonic acids, phosphates, and carboxylic acids, which are described in JP-A No. 60-88942 or 2-96755.

When the cyclic acid anhydride, the phenol or the organic acid is added to a recording layer of a planographic printing plate precursor, the ratio thereof in the recording layer is preferably from 0.05 to 20%, more preferably from 0.1 to 15%, and even more preferably from 0.1 to 10% by mass.

Besides, crosslinking compounds having the alkali dissolution suppressing activity described in JP-A No. 11-160860 conventionally proposed by the present inventors can be appropriately added depending on the purpose.

In order to enhance stability in processes which affect conditions of developing, the following can be added to the coating solution for the recording layer of the invention: nonionic surfactants as described in JP-A Nos. 62-251740 and 3-208514; amphoteric surfactants as described in JP-A Nos. 59-121044 and 4-13149; siloxane compounds as described in EP No. 950517; and copolymers made from a fluorine-containing monomer as described in JP-A No. 11-288093.

Specific examples of nonionic surfactants include sorbitan tristearate, sorbitan monopalmitate, sorbitan trioleate, monoglyceride stearate, and polyoxyethylene nonyl phenyl ether. Specific examples of amphoteric surfactants include alkyldi(aminoethyl)glycine, alkylpolyaminoethylglycine hydrochloride, 2-alkyl-N-carboxyethyl-N-hydroxyethylimidazolinium betaine and N-tetradecyl-N,N′-betaine type surfactants (trade name: “Amolgen K”, manufactured by Dai-ichi Kogyo Seiyaku Co., Ltd.).

The siloxane compounds are preferably block copolymers made from dimethylsiloxane and polyalkylene oxide. Specific examples thereof include polyalkylene oxide modified silicones (trade names: DBE-224, DBE-621, DBE-712, DBE-732, and DBE-534, manufactured by Chisso Corporation; trade name: Tego Glide 100, manufactured by Tego Co., Ltd.).

The content of the nonionic surfactant and/or the amphoteric surfactant in the photosensitive composition is preferably from 0.05 to 15% by mass, and more preferably from 0.1 to 5% by mass.

To the photosensitive composition of the invention may be added a printing-out agent for obtaining a visible image immediately after the photosensitive composition of the invention has been heated by exposure to light, or a dye or pigment as an image coloring agent.

A typical example of a printing-out agent is a combination of a compound which is heated by exposure to light, thereby emitting an acid (an optically acid-generating agent), and an organic dye which can form salts (salt formable organic dye).

Specific examples thereof include combinations of an o-naphthoquinonediazide-4-sulfonic acid halogenide with a salt-formable organic dye, described in JP-A Nos. 50-36209 and 53-8128; and combinations of a trihalomethyl compound with a salt-formable organic dye, described in each of JP-A Nos. 53-36223, 54-74728, 60-3626, 61-143748, 61-151644 and 63-58440.

The trihalomethyl compound is classified into an oxazol compound or a triazine compound. Both of the compounds provide excellent in stability over the passage of time and produce a vivid printed-out image.

As the image coloring agent, a dye different from the above-mentioned salt-formable organic dye may be used. Preferable examples of such a dye, and of the salt-formable organic dye, include oil-soluble dyes and basic dyes.

Specific examples thereof include Oil yellow #101, Oil Yellow #103, Oil Pink #312, Oil Green BG, Oil Blue BOS, Oil Blue #603, Oil Black BY, Oil Black BS, and Oil Black T-505 (each of which is manufactured by Orient Chemical Industries Ltd.); Victoria Pure Blue, Crystal Violet (CI42555), Methyl Violet (CI42535), Ethyl Violet, Rhodamine B (CI145170B), Malachite Green (CI42000), and Methylene Blue (CI52015).

Dyes described in JP-A No. 62-293247 are particularly preferable. These dyes may be added to the photosensitive composition at a ratio of 0.01 to 10% by mass, and preferably 0.1 to 3% by mass, relative to the total solid contents therein.

Whenever necessary, a plasticizer may be added to the photosensitive composition of the invention to give flexibility to a coating film made from the composition. Examples of the plasticizer include oligomers and polymers of butyl phthalyl, polyethylene glycol, tributyl citrate, diethyl phthalate, dibutyl phthalate, dihexyl phthalate, dioctyl phthalate, tricresyl phosphate, tributyl phosphate, trioctyl phosphate, tetrahydrofurfuryl olete, and acrylic acid and methacrylic acid.

(Manufacturing of Planographic Printing Plate)

The planographic printing plate of the invention is formed by providing the aforementioned recording layer on one side of a support, and providing a protective layer described later on a side opposite to a recording layer. If desired, other layer such as an undercoating layer may be provided.

A recording layer may be a monolayer, or of a laminated structure. As an outermost superficial layer of a monolayer and a laminated structure, the aforementioned recording layer containing the (a) long chain alkyl group-containing polymer and the (b) infrared absorbing agent is applied.

When a recording layer is of a laminated structure, it is preferable that a lower layer of a recording layer contains an alkali-soluble resin as a main component, and does not contain a long chain alkyl group-containing polymer. It is preferable that an alkali-soluble resin contained in a lower layer is a resin selected from the aforementioned alkali-soluble resin having a phenol group, and a copolymer containing, as a copolymerization component, a compound which is at least one acyclic group selected from a sulfonamido group, an active imido group, a carboxylic acid group, a sulfonic acid group, and a phosphoric acid group.

It is preferable that a more preferable alkali-soluble resin contained in a lower layer is the aforementioned alkali-soluble resin having a phenol group, and a copolymer containing, as a copolymerization component, a compound having at least one acyclic group selected from a sulfonamide group, an active imido group, and a carboxylic acid group, and at least one of the (m1) to (m12) compound.

A lower layer of a laminated structure may appropriately contain the aforementioned infrared absorbing agent and other recording layer components.

The planographic printing plate of the invention is usually formed by dissolving the recording layer components in a solvent, and coating this on a suitable support.

Examples of the solvent that may be used herein include ethylene dichloride, cyclohexanone, methyl ethyl ketone, methanol, ethanol, propanol, ethylene glycol monomethyl ether, 1-methoxy-2-propanol, 2-methoxyethyl acetate, 1-methoxy-2-propyl acetate, dimethoxyethane, methyl lactate, ethyl lactate, N,N-dimethylacetamide, N,N-dimethylformamide, tetramethylurea, N-methylpyrrolidone, dimethylsulfoxide, sulfolane, γ-butyrolactone and toluene, but the invention is not limited to these. These solvents may be used independently or in combination of two or more thereof.

In addition, it is preferable that, as a solvent used in coating, in principle, a solvent having different solubilities for an alkali-soluble resin used in a recoding layer upper layer and an alkali-soluble resin used in a lower layer is selected, however in order to impart new function, positive partial compatibility is also possible.

Examples of a method of forming separately two layers include a method of utilizing a difference in solubility in a solvent between a copolymer contained in a lower layer and an alkali-soluble resin contained in an upper layer, and a method of coating a recording layer upper layer, and rapidly drying to remove a solvent. These methods will be described in detail below, however a method of coating separately two layers is not limited to them.

The method of utilizing a difference in solubility in a solvent between a copolymer contained in a lower layer and an alkali-soluble resin contained in an upper layer is such that, upon coating of an alkali-soluble resin, a solvent system in which neither an alkali-soluble resin contained in a lower layer nor a copolymer to be used together is insoluble. Thereby, when two layers coating is performed, it becomes possible to obtain a coated film by clearly separating respective layers. For example, a copolymer containing, as a copolymerization component, a specified monomer constituting a lower layer component insoluble in a solvent which dissolves an alkali-soluble resin such as methyl ethyl ketone and 1-methoxy-2-propanol is selected, a lower layer may be contained the copolymer is coated using a solvent system which dissolves the copolymer constituting a lower layer component, this is dried and, thereafter, an upper layer mainly containing an alkali-soluble resin is coated using a solvent which does not dissolve a lower layer component such as methyl ethyl ketone and 1-methoxy-2-propanol, thereby, it becomes possible to obtain two layers.

On the other hand, a method of drying a solvent extremely rapidly after coating of a second layer can be attained by blowing the high pressure air through a slit nozzle which is disposed approximately orthogonal with a running direction of a belt-like support, or imparting a heat energy as conducting heat from an underside of a belt-like support from a roll (heat roll) in which a heat medium such as a steam has been supplied into the interior thereof, or combining them.

A method of partial compatibility of two layers becomes possible by adjusting a relevant extent in any of the aforementioned method of utilizing a difference in solubility in a solvent and method of drying a solvent extremely rapidly after coating of a second layer.

A concentration of the aforementioned component (total solid matter including additive) in a coating solution is preferably 1 to 50% by mass. As a coating method, various methods can be used, and examples include bar coater coating, rotation coating, spraying coating, curtain coating, dipping coating, air knife coating, blade coating, and roll coating.

In order to prevent damage on a lower layer at coating of a recording layer of an upper layer, it is desirable that a method of coating an upper layer of a recording layer is non-contact format. As a method, which is generally used in solvent system coating although, contact-type, bar coater coating may also be used, and in order to prevent damage on a lower layer, it is desirable to perform coating by forward rotation driving.

A surfactant for improving coating property, for example, a fluorine surfactant described in JP-A No. 62-170950 can be added to a recording layer coating solution. A preferable addition amount is 0.01 to 1% by mass, further preferably 0.05 to 0.5% by mass in a recording layer total solid matter.

A coating amount after drying of a lower layer of a recording layer is preferably in a range of 0.5 to 4.0 g/m², further preferably in a range of 0.6 to 2.5 g/m². In this range, better printing resistance, image reproductivity and sensitivity are obtained.

In addition, a coating amount after drying of an upper layer of a recording layer is preferably in a range of 0.05 g/m² to 1.0 g/m², further preferably in a range of 0.08 to 0.7 g/m². In this range, better development latitude, scratch resistance and sensitivity are obtained.

A coating amount as a sum of upper and lower layers, and a coating layer in a monolayer system is preferably in a range of 0.6 g/m² to 4.0 g/m², further preferably in a range of 0.7 to 2.5 g/m². In this range, better printing resistance, image reproductivity and sensitivity are obtained.

(Back Coating Layer)

The planographic printing plate of the invention is characterized in that it has a back coating layer on a side opposite to a side having the aforementioned recording layer.

It is preferable that the back coating layer is a back coating layer containing at least one kind resin selected from the group consisting of a saturated polymerized polyester resin, a phenoxy resin, a polyvinyl acetal resin, and a vinylidene chloride copolymer resin, or a back coating layer containing the following (i) to (iii):

(i) A metal oxide obtained by hydrolyzing and polycondensing an organic metal compound or an inorganic metal compound

(ii) Colloidal silica sol

(iii) Organic polymer compound.

In the invention, surface roughness (Ra) after provision of a back coating layer is preferably 0.25 or lower, more preferably 0.20 or lower.

Hereinafter, explanation will be performed by designating a back coating layer of the former (i.e. using a resin) as “back coating layer (A)” and a back coating layer of the latter (i.e. using a metal oxide) as “back coating layer (B)”.

<Back Coating Layer (A)>

A back coating layer (A) is a layer containing at least one kind resin selected from the group consisting of a saturated polymerized polyester resin, a phenoxy resin, a polyvinyl acetal resin, and a vinylidene chloride copolymer resin.

The saturated copolymerized polyester resin consists of a dicarboxylic acid unit and a diol unit. Examples of a dicarboxylic acid unit of polyester used in the invention include aromatic dicarboxylic acids such as phthalic acid, terephthalic acid, isophthalic acid, tetrabromophthalic acid, and tetrachlorophthalic acid; saturated aliphatic dicarboxylic acids such as adipic acid, azelaic acid, succinic acid, oxalic acid, suberic acid, sebacic acid, malonic acid, and 1,4-cyclohexanedicarboxylic acid.

Examples of a diol unit include aliphatic chain diols such as ethylene glycol, diethylene glycol, triethylene glycol, polyethylene glycol, propylene glycol, dipropylene glycol, polypropylene glycol, 1,3-butylene glycol, 2,3-butylene glycol, 1,4-butylene glycol, neopentyl glycol, hexanediol, and 2,2,4-trimethyl-1,3-pentanediol; cyclic diols such as 1,4-bis-β-hydroxyethoxycyclohexane, cyclohexanedimethanol, tricyclodecanedimethanol, bisphenoldioxyethyl ether, and bisphenoldioxypropyl ether. These dicarboxylic acids and diol units are used such that at least one kind of each of them is used, and one of them is used as a copolymer unit of two or more kinds, and nature of a copolymer is determined by a copolymer composition and a molecular weight.

A back coating layer (A) can be provided by a film thermal adhesion or melting lamination method, and coating from a solution is more preferable for effectively providing a thin layer. Therefore, as a copolymerized polyester resin used in the invention, a resin which is non-crystalline and is easily dissolved in industrial various organic solvents is preferable.

A molecular weight of a copolymerized polyester resin is preferably 10,000 or more from a viewpoint of film strength of a back coating layer (A).

A phenoxy resin is prepared from bisphenol A and epichlorohydrin like an epoxy resin, and is excellent in chemical resistance and adherability without assisting action of a curing agent or a catalyst as compared with an epoxy resin, and is suitable as a main component for back coating.

A polyvinyl acetal resin is a resin in which polyvinyl alcohol is acetalated with aldehyde such as butylaldehyde and formaldehyde, and a polyvinyl butyral resin and a polyvinyl formal resin are preferably used.

In addition, as a vinylidene chloride copolymer resin, copolymer resins of a vinylidene chloride monomer, a vinyl monomer such as vinyl chloride, vinyl acetate, ethylene and vinyl methyl ether, and an acryl monomer such as (meth)acrylic acid ester, and (meth)acrylonitrile are used. Inter alia, a vinylidene chloride copolymer containing acrylonitrile in a range of 20 mole % or less is rich in solubility in a general organic solvent, being preferable.

A glass transition temperature of a resin used in a back coating layer (A) is preferably 60° C. or higher, more preferably 65° C. or higher.

Other hydrophobic polymer compound is added to a back coating layer (A), occasionally. As such the hydrophobic polymer compound, for example, polybutene, polybutadiene, polyamide, an unsaturated copolymerized polyester resin, polyurethane, polyurea, polyimide, polysiloxane, polycarbonate, an epoxy resin, chlorinated polyethylene, an aldehyde-condensed resin of alkyl phenol, polyvinyl chloride, polyvinylidene chloride, polystyrene, an acryl-based resin and a copolymer resin thereof, hydroxycellulose, polyvinyl alcohol, cellulose acetate, and carboxymethylcellulose are suitable.

Examples of other preferable hydrophobic polymer compound include copolymers usually having a molecular weight of 10 thousands to 200 thousands containing a monomer represented by the following (1) to (12) as its constitutional unit.

(1) Acrylamides, methacrylamides, acrylic acid esters, methacrylic acid esters and hydroxystyrenes having an aromatic hydroxy group, for example, N-(4-hydroxyphenyl)acrylamide or N-(4-hydroxyphenyl)methacrylamide, o-, m- and p-hydroxystyrene, o-, m- and p-hydroxyphenyl acrylate or methacrylate,

(2) Acrylic acid esters and methacrylic acid esters having an aliphatic hydroxy group, for example, 2-hydroxyethyl acrylate or 2-hydroxyethyl methacrylate,

(3) (Substituted) acrylic acid esters such as methyl acrylate, ethyl acrylate, propyl acrylate, butyl acrylate, amyl acrylate, hexyl acrylate, cyclohexyl acrylate, octyl acrylate, phenyl acrylate, benzyl acrylate, 2-chloroethyl acrylate, 4-hydroxybutyl acrylate, glycidyl acrylate, and N-dimethylaminoethyl acrylate,

(4) (Substituted) methacrylic acid esters such as methyl methacrylate, ethyl methacrylate, propyl methacrylate, butyl methacrylate, amyl methacrylate, hexyl methacrylate, cyclohexyl methacrylate, octyl methacrylate, phenyl methacrylate, benzyl methacrylate, 2-chloroethyl methacrylate, 4-hydroxybutyl methacrylate, glycidyl methacrylate, and N-dimethylaminoethyl methacrylate,

(5) Acrylamides or methacrylamides such as acrylamide, methacrylamide, N-methylolacrylamide, N-methylolmethacrylamide, N-ethylacrylamide, N-ethylmethacrylamide, N-hexylacrylamide, N-hexylmethacrylamide, N-cyclohexylacrylamide, N-cyclohexylmethacrylamide, N-hydroxyethylacrylamide, N-hydroxyethylacrylamide, N-phenylacrylamide, N-phenylmethacrylamide, N-benzylacrylamide, N-benzylmethacrylamide, N-nitrophenylacrylamide, N-nitrophenylmethacrylamide, N-ethyl-N-phenylacrylamide and N-ethyl-N-phenylmethacrylamide,

(6) Vinyl ethers such as ethyl vinyl ether, 2-chloroethyl vinyl ether, hydroxylethyl vinyl ether, propyl vinyl ether, butyl vinyl ether, octyl vinyl ether, and phenyl vinyl ether,

(7) Vinyl esters such as vinyl acetate, vinyl chloroacetate, vinyl butyrate, and vinyl benzoate,

(8) Styrenes such as styrene, methylstyrene, and chloromethylstyrene,

(9) Vinyl ketones such as methyl vinyl ketone, ethyl vinyl ketone, propyl vinyl ketone, and phenyl vinyl ketone,

(10) Olefins such as ethylene, propylene, isobutylene, butadiene, and isoprene,

(11) N-vinylpyrrolidone, N-vincarbazole, 4-vinylpyridine, acrylonitrile, and methacrylonitrile,

(12) Acrylamides such as N-(o-aminosulfonylphenyl)acrylamide, N-(m-aminosulfonylphenyl)acrylamide, N-(p-aminosulfonylphenyl)acrylamide, N-[1-(3-aminosulfonyl)naphthyl]acrylamide, and N-(2-aminosulfonylethyl)acrylamide, methacrylamides such as N-(o-aminosulfonylphenyl)methacrylamide, N-(m-aminosulfonylphenyl)methacrylamide, N-(p-aminosulfonylphenyl)methacrylamide, N-[1-(3-aminosulfonyl)naphthyl]methacrylamide, and N-(2-aminosulfonylethyl)methacrylamide, as well as unsaturated sulfonamides of acrylic acid esters such as o-aminosulfonylphenyl acrylate, m-aminosulfonylphenyl acrylate, p-aminosulfonylphenyl acrylate, and 1-(3-aminosulfonylphenylnaphthyl)acrylate, and unsaturated sulfonamides of methacrylic acid esters such as o-aminosulfonylphenyl methacrylate, m-aminosulfonylphenyl methacrylate, p-aminosulfonylphenyl methacrylate, and 1-(3-aminosulfonylphenylnaphthyl) methacrylate.

Further, a monomer copolymerizable with the aforementioned monomer may be copolymerized. In addition, entities obtained by modifying a copolymer obtained by copolymerization of the aforementioned monomer with, for example, glycidyl acrylate or glycidyl methacrylate is also included, being not limiting. These hydrophobic polymer compounds can be added to a back coating in a range of 50% by mass or less, and in order to utilize properties of a saturated copolymerized polyester resin, a phenoxy resin, a polyvinyl acetal resin and a vinylidene chloride copolymer resin, 30% by mass or less is preferable.

If necessary, in addition to these hydrophobic polymer compounds, plasticizers, surfactants, and other additives can be added to a back coating layer (A) for the purpose of imparting flexibility, adjusting sliding property, and improving coating planar state.

As a plasticizer, for example, phthalic acid esters such as dimethyl phthalate, diethyl phthalate, dibutyl phthalate, diisobutyl phthalate, dioctyl phthalate, octylcapryl phthalate, dicyclohexyl phthalate, ditridecyl phthalate, butylbenzyl phthalate, diisodecyl phthalate, and diallyl phthalate, glycol esters such as dimethylglycol phthalate, ethylphthalylethyl glycolate, methylphthalylethyl glycolate, butylphthalylbutyl glycolate, and triethylene glycol dicaprylic acid ester, phosphoric acid esters such as tricresyl phosphate, and triphenyl phosphate, aliphatic dibasic acid esters such as diisobutyl adipate, dioctyl adipate, dimethyl sebacate, dibutyl sebacate, dioctyl azelate, and dibutyl maleate, polyglycidyl methacrylate, triethyl citrate, glycerin triacetyl ester, and butyl laurate are effective.

An amount to of a plasticizer to be added to a back coating layer (A) is different depending on a kind of an organic polymer used in back coating, and a plasticizer is preferably added in such a range that a glass transition temperature is not 60° C. or lower.

Examples of a surfactant include anionic, cationic, nonionic and amphoteric surfactants. Examples include nonionic surfactants such as polyoxyethylene alkyl ethers, polyoxyethylene alkyl phenyl ethers, polyoxyethylene polystyryl phenyl ethers, polyoxyethylene polyoxypropylene alkyl ethers, glycerin fatty acid partial esters, sorbitan fatty acid partial esters, pentaerythritol fatty acid partial esters, propylene glycol monofatty acid esters, sucrose fatty acid partial esters, polyoxyethylene sorbitan fatty acid partial esters, polyoxyethylene sorbitol fatty acid partial esters, polyethylene glycol fatty acid esters, polyglycerin fatty acid partial esters, polyoxyethylenated castor oils, polyoxyethylene glycerin fatty acid partial esters, fatty acid diethanolamides, N,N-bis-2-hydroxyalkylamines, polyoxyethylene alkylamine, triethanolamine fatty acid ester, and trialkylamine oxide, anionic surfactants such as fatty acid salts, abietic acid salts, hydroxyalkanesulfonic acid salts, alkanesulfonic acid salts, dialkylsulfosuccinic acid ester salts, straight alkylbenzenesulfonic acid salts, branched alkylbenzenesulfonic acid salts, alkylnaphthalenesulfonic acid salts, alkylphenoxypolyoxyethylene propylsulfonic acid salts,

Polyoxyethylene alkylsulfophenyl ether salts, N-methyl-N-oleyltaurin sodium salt, N-alkylsulfosuccinic acid monoamide disodium salt, petroleum sulfonic acid salts, sulfated beef tallow oil, fatty acid alkyl ester sulfate ester salts, alkyl sulfate ester salts, polyoxyethylene alkyl ether sulfate ester salts, sulfuric acid ester salts, aliphatic acid monoeglyceride sulfate ester salts, polyoxyethylene alkyl phenyl ether sulfate ester salts, polyoxyethylene styryl phenyl ether sulfate ester salts, alkyl phosphate ester salts, polyoxyethylene alkyl ether phosphate ester salts, polyoxyethylene alkyl phenyl ether phosphate ester salts, styrene/maleic anhydride copolymer partial saponified entities, olefin/maleic anhydride copolymer partial saponified entities, and naphthalenesulfonate formalin condensates, cationic surfactants such as alkylamine salts, quaternary ammonium salts, polyoxyethylene alkylamine salts, and polyethylene polyamine derivative, and amphoteric surfactants such as carboxybetaines, aminocarboxylic acids, sulfobetaines, aminosulfate esters, and imidazolines. In the aforementioned surfactants, polyoxyethylene can be replaced with polyoxyalkylene such as polyoxymethylene, polyoxypropylene, and polyoxybutylene, and those surfactants are also included.

A further preferable surfactant is a fluorine-based surfactant containing a perfluoroalkyl group in a molecule. Examples of such the fluorine-based surfactant include anionic type such as perfluoroalkylcarboxylic acid salt, perfluoroalkylsulfonic acid salt, and perfluoroalkylphosphoric acid ester, amphoteric type such as perfluoroalkylbetaine, cationic type such as perfluoroalkyltrimethylammonium salt, and nonionic type such as perfluoroalkylamine oxide, perfluoroalkylethylene oxide adduct, perfluoroalkyl group and hydrophilic group-containing oligomer, perfluoroalkyl group and lipophilic group-containing oligomer, perfluoroalkyl group, hydrophilic group and lipophilic group-containing oligomer, and perfluoroalkyl group and lipophilic group-containing urethane.

The surfactants can be used alone, or in a combination of two or more kinds, and are added to a back coating in a range of preferably 0.001 to 10% by mass, more preferably 0.01 to 5% by mass.

Further, a dye for coloring, a silane coupling agent for improving adherability with an aluminum support, a diazo resin comprising a diazonium salt, organic phosphonic acid, organic phosphoric acid and cationic polymer and, further, wax, higher fatty acid, higher fatty acid amide, a silicone compound comprising dimethylsiloxane, modified dimethylsiloxane, and a polyethylene powder which are usually used as a lubricant are appropriately added to a back coating layer (A).

A thickness of a back coating layer (A) is basically such a thickness that a recording layer is hardly damaged without an interleaving paper, and a range of 0.01 to 8 μm is preferable, and a range of 0.05 to 2 μm is more preferable. When a thickness is in the above range, this is sufficient for preventing a rubbing flaw of a recording layer when planographic printing plate precursors are handled by piling up them, and there is no fear that a back coating layer (A) is dissolved in a chemical used around printing during printing, or the layer is swollen to change a thickness and change a printing pressure, deteriorating printing property.

As a solvent used when a back coating layer (A) is coated on a back surface of a support as a solution of an organic polymer and necessary components, organic solvents described in JP-A No. 62-251739 are used alone or by mixing them. Examples of a solvent include ethylene dichloride, cyclohexanone, methyl ethyl ketone, methanol, ethanol, propanol, ethylene glycol monomethyl ether, 1-methoxy-2-propanol, 2-methoxyethyl acetate, 1-methoxy-2-propyl acetate, dimethoxyethane, methyl lactate, ethyl lactate, N,N-dimethylacetamide, N,N-dimethylformamide, tetramethylurea, N-methylpyrrolidone, dimethyl sulfoxide, sulfolane, γ-butyrolactone, and toluene, being not limiting. These solvents are used alone, or by mixing them.

<Back Coating Layer (B)>

A back coating layer (B) is a layer containing (i) a metal oxide obtained by hydrolyzing and polycondensing an organic metal compound or an inorganic metal compound, (ii) a colloidal silica sol, and (iii) an organic polymer compound. In addition, a back coating layer may further contain a plasticizer.

Examples of a metal oxide used in a back coating layer (B) include silica (silicon oxide), titanium oxide, boron oxide, aluminum oxide and zirconium oxide, and a composite of them. A metal oxide in a back coating layer used in the invention is obtained by causing hydrolysis and a polycondensation reaction of an organic metal compound or an inorganic metal compound with a catalyst such as an acid or an alkali in water or an organic solvent to obtain a sol-gel reaction solution, and coating the solution on a back surface of a support, and drying this. Examples of an organic metal compound or an inorganic metal compound used herein include metal alkoxide, metal acetylacetonate, metal acetate salt, metal oxalate salt, metal nitrate salt, metal sulfate salt, metal carbonate salt, metal oxychloride, metal chloride and a condensate obtained by partially hydrolyzing them to obtain an oligomer.

Metal alkoxide is represented by the formula of M(OR)ₙ (M represents a metal element, R represents an alkyl group, and n represents an oxidation number of a metal element). As an example, Si(OCH₃)₄, Si(OC₂H₅)₄, Si(OC₃H₇)₄, Si(OC₄H₉)₄, Al(OCH₃)₃, Al(OC₂H₅)₃, Al(OC₃H₇)₃, Al(OC₄H₉)₃, B(OCH₃)₃, B(OC₂H₅)₃, B(OC₃H₇)₃, B(OC₄H₉)₃, Ti(OCH₃)₄, Ti(OC₂H₅)₄, Ti(OC₃H₇)₄, Ti(OC₄H₉)₄, Zr(OCH₃)₄, Zr(OC₂H₅)₄, Zr(OC₃H₇)₄, and Zr(OC₄H₉)₄ are used. Other examples include alkoxides of Ge, Li, Na, Fe, Ga, Mg, P, Sb, Sn, Ta and V Further, monosubstituted silicon alkoxides such as CH₃Si(OCH₃)₃, C₂H₅Si(OCH₃)₃, CH₃Si(OC₂H₅)₃, and C₂H₅Si(OC₂H₅)₃ are also used. Examples of metal acetylacetonate include Al(COCH₂COCH₃)₃, and Ti(COCH₂COCH₃)₄. Examples of metal oxalate salt include K₂TiO(C₂O₄)₂, and examples of a metal nitrate salt include Al(NO₃)₃, and ZrO(NO₃)₂.2H₂O. Examples of a metal sulfate salt include Al₂(SO₄)₃, (NH₄)Al(SO₄)₂, KAl(SO₄)₂, and NaAl(SO₄)₂, examples of metal oxychloride include Si₂OCl₆, and ZrOCl₂, and examples of chloride include AlCl₃, SiCl₄, ZrCl₂, and TiCl₄.

These organic metal compounds or inorganic metal compounds can be used alone, or two or more can be used by combining them. Among these organic metal compounds or inorganic metal compounds, metal alkoxide is rich in reactivity, and easily produces a polymer composed of a bond of metal-oxygen, being preferable. Among them, a silicon alkoxy compound such as Si(OCH₃)₄, Si(OC₂H₅)₄, Si(OC₃H₇)₄, and Si(OC4H₉)₄ is inexpensive, and easily available, and a covering layer of a metal oxide obtained from them is excellent in developer resistance, being particularly preferable. In addition, an oligomer obtained by condensation by partially hydrolyzing these silicon alkoxy compounds is also preferable. Examples of them include an ethyl silicate oligomer of average pentamer containing about 40% by mass of SiO₂ and, further, preferable examples include joint use of a so-called silane coupling agent in which one or two alkoxy groups of the aforementioned silicon tetraalkoxy compound is substituted with an alkyl group or a group having reactivity. As a silane coupling agent used thereupon, there are vinyltrimethoxysilane, vinyltriethoxysilane, γ(methacryloxypropyl)trimethoxysilane, β-(3,4epoxycyclohexyl)ethyltrimethoxysilane, γ-glycidoxypropyltrimethoxysilane, γ-glycidoxypropylmethyldiethoxysilane, N-β(aminoethyl)γ-aminopropyltrimethoxysilane, N-β(aminoethyl)γ-aminopropylmethyldimethoxysilane, γ-aminopropyltriethoxysilane, N-phenyl-γ-aminopropyltrimethoxysilane, γ-mercaptopropyltrimethoxysilane, γ-chloropropyltrimethoxysilane, methyltrimethoxysilane and methyltriethoxysilane.

On the other hand, as a catalyst, organic or inorganic acids and alkalis are used. Examples include inorganic acids such as hydrochloric acid, sulfuric acid, sulfurous acid, nitric acid, nitrous acid, hydrofluoric acid, phosphoric acid, and phosphorus acid, organic acids such as formic acid, acetic acid, propionic acid, butyric acid, glycolic acid, chloroacetic acid, dichloroacetic acid, trichloroacetic acid, fluoroacetic acid, bromoacetic acid, methoxyacetic acid, oxaloacetic acid, citric acid, oxalic acid, succinic acid, malic acid, tartaric acid, fumaric acid, maleic acid, malonic acid, ascorbic acid, benzoic acid, substituted benzoic acid such as 3,4-dimethoxybenzoic acid, phenoxyacetic acid, phthalic acid, picric acid, nicotinic acid, picolinic acid, pyrazine, pyrazole, dipicolinic acid, adipic acid, p-toluic acid, terephthalic acid, 1,4-cyclohexene-2,2-dicarboxylic acid, erucic acid, lauric acid, n-undecanoic acid, and ascorbic acid, and alkali's such as hydroxide of an alkali metal and an alkaline earth metal, ammonia, ethanolamine, diethanolamine, and triethanolamine. Besides, organic acids such as sulfonic acids, sulfinic acids, alkylsulfuric acids, phosphonic acids, and phosphoric acid esters, specifically, p-toluenesulfonic acid, dodecylbenzenesulfonic acid, p-toluenesulfinic acid, ethylic acid, phenylphosphonic acid, phenylphosphinic acid, phenyl phosphate, and diphenyl phosphate can be used. These catalysts may be used alone or in a combination of two or more kinds. An amount of a catalyst is preferably in a range of 0.001 to 10% by mass, more preferably in a range of 0.05 to 5% by mass relative to a metal compound as a raw material. When a catalyst amount is less than this range, initiation of a sol-gel reaction is delayed and, when the amount is above this range, a reaction rapidly progresses, and the resulting covering layer is inferior in developer resistance, probably because ununiform sol-gel particles are produced.

In order to initiate a sol-gel reaction, further, an appropriate amount of water is necessary, and a preferable addition amount is preferably 0.05 to 50-fold mole, more preferably 0.5 to 30-fold mole an amount of necessary water for completely hydrolyzing a metal compound as a raw material. When an amount of water is less than this range, hydrolysis progresses slow and, when the amount is more than this range, a reaction progresses also slow probably because a raw material is diluted. Further, a solvent is added to a sol-gel reaction solution. As a solvent, any solvent may be used as far as it dissolves a metal compound as a raw material, and dissolves or disperses sol-gel particles produced in a reaction, and lower alcohols such as methanol, ethanol, propanol and butanol, and ketones such as acetone, methyl ethyl ketone, and diethyl ketone are used. In addition, for the purpose of improving coating surface quality of a back coating layer, mono or dialkyl ether and acetic acid ester of glycols such as ethylene glycol, diethylene glycol, triethylene glycol, propylene glycol and dipropylene glycol can be used. Among these solvents, lower alcohols, which are miscible with water, are preferable. A sol-gel reaction solution is adjusted with a solvent to a suitable concentration for coating and, when a total amount of a solvent is added to a reaction solution from beginning, a hydrolyzing reaction hardly progresses probably due to dilution of a raw material.

Then, a method of adding a part of a solvent is added to a sol-gel reaction solution, and adding a remaining solvent at a timepoint at which a reaction progresses is preferable.

The (ii) and (iii) components may be added to a sol-gel reaction solution for preparing a metal oxide, which is (i) a component, in advance, or may be added during a sol-gel reaction. Preferably, (ii) and (iii) components dissolved or suspended in a part of the solvent are added at a timepoint at which a sol-gel reaction has partially progressed because adherability with an aluminum support is improved.

A sol-gel reaction progresses by mixing a metal oxide raw material, water, a solvent and a catalyst. Progression of a reaction depends on a kind and a composition ratio thereof, and a reaction temperature and time, this influences on film quality after formation of a film. Particularly, since a reaction temperature has great influence, it is preferable to control a temperature during the reaction. In addition to the aforementioned essential components, a compound containing a hydroxyl group, an amino group or active hydrogen may be added to a sol-gel reaction solution for appropriately adjusting a sol-gel reaction. Examples of the compound include polyethylene glycol, polypropylene glycol, block copolymer thereof, and monoalkyl ether or monoalkyl aryl ether thereof, various phenols such as phenol and cresol, a copolymer of polyvinyl alcohol and azovinly monomer, an acid having a hydroxyl group such as malic acid and tartaric acid, aliphatic and aromatic amine, formaldehyde and dimethylformaldehyde. Further, in order to improve affinity of a dried coating solution for an organic solvent to solubilize it, (iii) an organic polymer compound is added.

Examples of (iii) an organic polymer compound in a back coating layer (B) include polyvinyl chloride, polyvinyl alcohol, polyvinyl acetate, polyvinyl phenol, polyvinyl halogenated phenol, polyvinyl formal, polyvinyl acetal, polyvinyl butyral, polyamide, polyurethane, polyurea, polyimide, polycarbonate, epoxy resin, condensed resin of phenol novolak, or resol phenols and aldehyde or ketone, polyvinylidene chloride, polystyrene, silicone resin, acryl-based copolymer having an alkali-soluble group such as an active methylene, a phenolic hydroxyl group, a sulfoneamido group, and a carboxy group, and a binary, or ternary or more copolymer resin thereof. A particularly preferable compound is specifically a phenol novolak resin or a resol resin, and examples include phenol, cresol (m-cresol, p-cresol, m/p mixed cresol), phenol/cresol (m-cresol, p-cresol, m/p mixed cresol), phenol-modified xylene, tert-butyl phenol, octyl phenol, resorcinol, pyrogallol, catechol, chlorophenol (m-Cl, p-Cl), bromophenol (m-Br, p-Br), salicylic acid, a novolak resin and a resol resin condensed with formaldehyde such as fluoroglucinol, and a condensed resin of the aforementioned phenol compounds, and acetone.

Examples of a suitable polymer compound include copolymers having a molecular weight of usually 10 thousands to 200 thousands, which contains a monomer represented by the following (1) to (12) as a constitutional unit.

(1) Acrylamides, methacrylamides, acrylic acid esters, methacrylic acid esters and hydroxystyrenes, which have an aromatic hydroxyl group, for examples, N-(4-hydroxyphenyl)acrylamide or N-(4-hydroxyphenyl)methacrylamide, o-, m- and p-hydroxystyrene, o-, m- and p-hydroxyphenyl acrylate or methacrylate, (2) acrylic acid esters and methacrylic acid esters, which have an aliphatic hydroxyl group, for example, 2-hydroxyethyl acrylate or 2-hydroxyethyl methacrylate, (3) (substituted) acrylic acid esters such as methyl acrylate, ethyl acrylate, propyl acrylate, butyl acrylate, amyl acrylate, hexyl acrylate, cyclohexyl acrylate, octyl acrylate, phenyl acrylate, benzyl acrylate, 2-chloroethyl acrylate, 4-hydroxybutyl acrylate, glycidyl acrylate, and N-dimethylaminoethyl acrylate, (4) (substituted) methacrylic acid esters such as methyl methacrylate, ethyl methacrylate, propyl methacrylate, butyl methacrylate, amyl methacrylate, hexyl methacrylate, cyclohexyl methacrylate, octyl methacrylate, phenyl methacrylate, benzyl methacrylate, 2-chloroethyl methacrylate, 4-hydroxybutyl methacrylate, glycidyl methacrylate, and N-dimethylaminoethyl methacrylate,

(5) Acrylamides or methacrylamides such as acrylamide, methacrylamide, N-methylolacrylamide, N-methylolmethacrylamide, N-ethylacrylamide, N-ethylmethacrylamide, N-hexylacrylamide, N-hexylmethacrylamide, N-cyclohexylacrylamide, N-cyclohexylmethacrylamide, N-hydroxyethylacrylamide, N-hydroxyethylacrylamide, N-phenylacrylamide, N-phenylmethacrylamide, N-benzylacrylamide, N-benzylmethacrylamide, N-nitrophenylacrylamide, N-nitrophenylmethacrylamide, N-ethyl-N-phenylacrylamide and N-ethyl-N-phenylmethacrylamide, (6) vinyl ethers such as ethyl vinyl ether, 2-chloroethyl vinyl ether, hydroxyethyl vinyl ether, propyl vinyl ether, butyl vinyl ether, octyl vinyl ether, and phenyl vinyl ether, (7) vinyl esters such as vinyl acetate, vinyl chloroacetate, vinyl butyrate, and vinyl benzoate, (8) styrenes such as styrene, methylstyrene, and chloromethylstyrene, (9) vinyl ketones such as methyl vinyl ketone, ethyl vinyl ketone, propyl vinyl ketone, and phenyl vinyl ketone, (10) olefins such as ethylene, propylene, isobutylene, butadiene, and isoprene,

(11) N-vinylpyrrolidone, N-vinylcarbazole, 4-vinylpyrydine, acrylonitrile, and mathacrylonitrile, (12) acrylamides such as N-(o-aminosulfonylphenyl)acrylamide, N-(m-aminosulfonylphenyl)acrylamide, N-(p-aminosulfonylphenyl)acrylamide, N-[1-(3-aminosulfonyl)naphthyl]acrylamide, and N-(2-aminosulfonylethy)acrylamide, methacrylamides such as N-(o-aminosulfonylphenyl)methacrylamide, N-(m-aminosulfonylphenyl)methacrylamide, N-(p-aminosulfonylphenyl)methacrylamide, N-[1-(3-aminosulfonyl)naphthyl]methacrylamide, and N-(2-aminosulfonylethyl)methacrylamide, and, unsaturated sulfonamides of acrylic acid esters such as o-aminosulfonylphenyl acrylate, m-aminosulfonylphenyl acrylate, p-aminosulfonylphenyl acrylate, and 1-(3-aminosulfonylphenylnaphthyl) acrylate, and unsaturated sulfonamides of methacrylic acid esters such as o-aminosulfonylphenyl methacrylate, m-aminosulfonylphenyl methacrylate, p-aminosulfonylphenyl methacrylate, and 1-(3-aminosulfonylphenylnaphthyl)metahcrylate.

It is preferable that these have a weight average molecular weight of 500 to 20000, and a number average molecular weight of 200 to 60000, and an addition amount is specifically suitably 1 200% by mass, preferably 2 to 100% by mass, particularly, most preferably 5 to 50% by mass relative to a metal compound as a raw material. When an addition amount is more than this, a back coating layer is peeled with a chemical used in printing, and the original function is damaged. In addition, when a lipophilic substance such as an ink is attached to a back surface, hydrophilicity originally possessed by sol-gel is deteriorated, and it becomes very difficult to remove an ink.

Further, in order to prevent disorder of dust attachment during manufacturing coating accompanied with scaly peeling of a dried coating solution, and obtain stable coating surface quality, it is preferable to add a plasticizer together with the aforementioned organic polymer compound. As a plasticizer in a back coating layer used in the invention, for example, dimethyl phthalate, diethyl phthalate, dibutyl phthalate, diheptyl phthalate, dioctyl phthalate, butylbenzyl phthalate, diisodecyl phthalate, ethylphthalylethyl glycolate, methylphthalylethyl glycolate, butylphthalylbutyl glycolate, diisobutyl phthalate, octylcapryl phthalate, dicyclohexyl phthalate, ditridecyl phthalate, diallyl phthalate, dimethyl glycol phthalate, ethylphthalylethyl glycolate, methylphthalylethyl glycolate, butylphthalylbutyl glycolate, triethylene glycol dicaprylic acid ester, trioctyltrimellitate, dioctyl adipate, dioctyl azelate, dibutyl sebacate, dioctyl sebacate, methylacetyl ricinolate, dimethyl maleate, diethyl maleate, dibutyl maleate, dioctyl maleate, dibutyl fumarate, dioctyl fumarate, adipic acid-propylene glycol ester, adipic acid-1,3butylene glycol ester, glycerol triacetate, glycerol tributyrate, cellulose acetate phthalate, trimethyl phosphate, triethyl phosphate, tributyl phosphate, trioctyl phosphate, tributoxyethyl phosphate, trischloroethyl phosphate, trisdichloropropyl phosphate, mono-2,3-dichloropropyl-bis-2,3-dibromopropyl phosphate, triphenyl phosphate, tricresyl phosphate, trixylenyl phosphate, cresyldiphenyl phosphate, diphenylmonoorthoxenyl phosphate, octyldiphenyl phosphate, triphenyl phosphite, trilauryl trithiophosphite, trischloroethyl phosphite, trilauryl phosphite, trisnonylphenyl phosphite, trisdinonylphenyl phosphite, dibutylhydrogen phosphite, isopropylacid phosphate, butylacid phosphate, dibutyl phosphate, octylacid phosphate, dioctyl phosphate, isodecylacid phosphate, monoisodecyl phosphate, and tridecanolacid phosphate are effective. Among them, plasticizers having a boiling point at 760 mmHg of 250° C. or higher are particularly effective. In addition, in order that staining property due to adhesion of a lipophilic substance at plate-making is not deteriorated, plasticizers having as high as possible hydrophilicity are preferable. A plasticizer is added in such a range that a back coating layer is not sticky, and at suitably 1 to 100% by mass, particularly preferably 5 to 30% by mass, relative to a metal compound as a raw material. When an addition amount is more than 100% by mass, a lipophilic substance such as an ink is adhered to a back surface, and the back is easily polluted.

Examples of (ii) a colloidal silica sol in a back coating layer (B) include a colloid solution of superfine particles of silicic acid using, as a dispersing medium, water, methanol, ethanol, isopropyl alcohol, butanol, xylene, or dimethylformamide. A methanol dispersing medium is particularly preferable. A size of particles of a dispersion solute is preferably 1 to 100 μm, particularly preferably 10 to 50 μm. When a size is more than 100 μm, uniformity of a coated film is deteriorated due to irregularities of a surface.

A content of silicic acid is preferably 5 to 80% by mass and, particularly, a hydrogen ion concentration outside a neutral region (pH 6-8) is preferable from a viewpoint of safety. Particularly, an acidic region is preferable.

In addition, a silica sol may be used together with fine particles of alumina sol or lithium silicate. Due to them, property of film hardness of a sol-gel coated film is further improved. An addition amount is specifically not less than 30% by mass and not more than 300% by mass, further preferably 30% by mass to 200% by mass, most preferably 50 to 100% by mass. When an addition amount is more than this, film property is deteriorated, and uniform coating becomes difficult. On the other hand, when an addition amount is less than this, adhesion of a lipophilic substance easily occurs and, particularly, when printing plates after PI rubbing up are piled, there arises a problem that an ink is adhered to a surface.

Further, it is preferable that other surfactant is used in a back coating layer (B) for adjusting sliding property. Preferable examples of such the surfactant include nonionic surfactants such as polyoxyethylene alkyl ethers, polyoxyethylene alkyl phenyl ethers, polyoxyethylene polystyryl phenyl ethers, polyoxyethylene polyoxypropylene alkyl ethers, glycerin fatty acid partial esters, sorbitan fatty acid partial esters, pentaerythritol fatty acid partial esters, propylene glycol monofatty acid esters, sucrose fatty acid partial esters, poyloxyethylene sorbitan fatty acid esters, polyoxyethylene sorbitol fatty acid partial esters, polyethylene glycol fatty acid esters, polyglycerin fatty acid partial esters, polyoxyethylenated castor oil, polyoxyethlene glycerin fatty acid partial esters, fatty acid diethanolamides, N,N-bis-2-hydroxyalkylamines, polyoxyethylene alkylamine, triethanolamine fatty acid ester, and trialkylamine oxide, anionic surfactants such as fatty acid salts, abietic acid salts, hydroxyalkanesulfonic acid salts, alkanesulfonic acid salts, dialkylsulfosuccinic acid ester salts, straight alkylbenzenesulfonic acid salts, branched alkylbenzenesulfonic acid salts, alkylnaphthalenesulfonic acid salts, alkylphenoxy polyoxyethylene propylsulfonic acid salts,

Polyoxyethylene alkylsulfophenyl ether salts, N-methyl-N-oleyltaurin sodium salt, N-alkylsulfosuccinic acid monoamide disodium salt, petroleum sulfonic acid salts, sulfated beef tallow oil, fatty acid alkyl ester sulfate ester salts, alkyl sulfate ester salts, polyoxyethylene alkyl ether sulfate esters, fatty acid monoglyceride sulfate ester salts, polyoxyethylene alkyl phenyl ether sulfate ester salts, polyoxyethylene styryl phenyl ether sulfate ester salts, alkyl phosphate ester salts, polyoxyethylene alkyl ether phosphate ester salts, polyoxyethylene alkyl phenyl ether phosphate ester salts, styrene/maleic anhydride copolymer partial saponified entities, olefin/maleic anhydride copolymer partial saponified entities, and naphthalenesulfonic acid salt formalin condensates, cationic surfactants such as alkylamines, quaternary ammonium salts, polyoxyethylene alkylamine salts, and polyethylene polyamine derivative, and amphoteric surfactants such as carboxybetaines, aminocarboxylic acids, sulfobetaines, aminosulfate esters, and imidazolines.

Further, a dye or a pigment for coloring to determine a kind of a plate may be added to a back coating layer (B). Examples of a preferable dye include rhodamine 6G chloride, rhodamine B chloride, Crystal Violet, Malachite Green oxalate, oxazine 4 perchlorate, quinizarin, 2-α-naphthyl)-5-phenyloxazole, and coumarin-4. Examples of other dye include specifically triphenylmethane series, diphenylmethane series, oxazine series, xanthene series, iminonaphthoquinone series, azomethine series and anthraquinone series dyes, representative which are Oil Yellw #101, Oil Yellow #103, Oil Pink #312, Oil Green BG, Oil Blue BOS, Oil Blue #603, Oil Black BY, Oil Black BS, Oil Black T-505 (all manufactured by Orient Chemical Industries Ltd.), Victoria Pure Blue, Crystal Violet (CI42555), Methyl Violet (CI42535), Ethyl Violet, Methylene Blue (CI52015), Patent Pure Blue (manufactured by Sumitomo Mikuni Kagaku), Brilliant Blue, Methyl Green, Erythricin B, Basic Fuchsin, m-Cresol Purple, Auramine, 4-p-diethylaminophenyliminaphthoquinone, and cyano-p-diethylaminophenylacetoanilide. The pigment is contained in a back coating layer at usually about 0.05 to 10% by mass, more preferably about 0.5 to 5% by mass.

Further, in order to improve chemical resistance, o-naphthoquinone diazide compound, photosensitive azide compound, photopolymerizable composition containing an unsaturated double bond-containing monomer as a main component, and a diazo resin obtained by condensing cinnamic acid or dimethylmaleimide group, a photocrosslinking composition and a diazonium salt monomer, or an aromatic diazonium salt, and a reactive carbonyl group-containing organic condensing agent, particularly, aldehydes such as formaldehyde and acetaldehyde, or acetals in an acidic medium can be added to a back coating layer (B). Among them, as an o-naphthoquinone diazide compound, which is known as a positive photosensitive compound, an o-naphthoquinone diazide compound described in the aforementioned recording layer, is suitably used. As an aromatic diazonium salt, representative is a condensate of p-diazodiphenylamine and formaldehyde. A method of synthesizing these diazo resins is described, for example, in U.S. Pat. No. 2,679,498, U.S. Pat. No. 3,050,502, U.S. Pat. No. 3,311,605 and U.S. Pat. No. 3,277,074. Further, as a diazonium salt, a diazonium compound obtained by cocondensing an aromatic diazonium salt and a substituted aromatic compound containing no diazonium group described in JP-B No. 49-48,001 is suitably used and, inter alia, a diazonium compound obtained by cocondensing with an aromatic compound substitute with an alkali-soluble group such as a carboxyl group and a hydroxyl group is preferable. Further, a diazonium salt compound obtained by condensing an aromatic diazonium salt with a reactive carbonium compound having an alkali-soluble group described in JP-A No. 4-18559, No. 4-190361, and No. 4-172353 is also used.

There is a diazonium compound using an inorganic anion such as a mineral acid such as hydrochloric acid, hydrobromic acid, sulfuric acid and phosphoric acid, or a double salt with zinc chloride as a counteranion for these diazonium salts, however a diazonium compound which is substantially water-insoluble and organic solvent-soluble is particularly preferable. Such the preferable diazonium compound is described in detail in JP-B No. 47-1167, and U.S. Pat. No. 3,300,309. Further, a diazonium compound using, as a counteranion, halogenated Lewis acid such as tetrafluoroboric acid and hexafluorophosphoric acid, or perhalogen acid such as perchloric acid and periodic acid described in JP-A No. 54-98613, No. 56-121031 is preferably used. In addition, a diazonium compound using, as a counteranion, sulfonic acid having a long chain alkyl group described in JP-A No. 58-209733, No. 62-175731, and No. 63-262643 is also preferably used. A diazonium compound is contained in a photosensitive layer in a range of 0.5 to 60% by mass, preferably 5 to 50% by mass.

Further, as a sliding agent, higher fatty acid or higher fatty acid amide such as behenic acid, hebenic acid amide, stearic acid, stearic acid amide, and alkenylsuccinic acid anhydride, wax, dimethylsiloxane, or a polyethylene powder is added to a back coating layer (B).

A thickness of a back coating layer (B) is basically enough to be a thickness that can suppress dissolution out of an anode oxidized film of aluminum at developing, and is preferably in a range of 0.001 to 10 g/m², more preferably 0.01 to 1 g/m², most preferably 0.02 to 0.1 g/m². As a method of covering a back surface of an aluminum support with a back coating layer, various methods can be applied, and most preferable for maintaining the aforementioned coating amount is a method of coating a solution, followed by drying.

[Support]

The support used in the present invention is a plate having necessary strength and durability, as well as dimensional stability. A plate satisfying required physical properties such as strength and flexibility can be used without any restriction. Examples thereof include paper, plastic (such as polyethylene, polypropylene or polystyrene)-laminated papers, metal plates (such as aluminum, zinc and copper plates), plastic films (such as cellulose biacetate, cellulose triacetate, cellulose propionate, cellulose lactate, cellulose acetate lactate, cellulose nitrate, polyethylene terephthalate, polyethylene, polystyrene, polypropylene, polycarbonate, and polyvinyl acetate films), and papers or plastic films on which, as described above, a metal is laminated or vapor-deposited.

The support is preferably a polyester film or an aluminum plate, and more preferably an aluminum plate, since an aluminum plate is superior in terms of dimensional stability and is also relatively inexpensive.

Preferable examples of the aluminum plate include a pure aluminum plate and alloy plates made of aluminum as a main component with a very small amount of other elements. A plastic film on which aluminum is laminated or vapor-deposited may also be used.

Examples of other elements contained in the aluminum alloys include silicon, iron, manganese, copper, magnesium, chromium, zinc, bismuth, nickel, and titanium. The content by percentage of different elements in the alloy is at most 10% by mass. A particularly preferable aluminum plate in the invention is a pure aluminum plate; however, since from the viewpoint of refining a completely pure aluminum cannot be easily produced, a very small amount of other elements may also be contained in the plate.

The aluminum plate used as the support is not specified in terms of the composition thereof. Thus, aluminum plates which are conventionally known can be appropriately used. The thickness of the aluminum plate used in the invention is from about 0.1 to 0.6 mm, preferably from 0.15 to 0.4 mm, and more preferably from 0.2 to 0.3 mm.

If necessary, prior to the surface-roughening treatment, the aluminum plate may optionally be subjected to degreasing treatment, in order to remove rolling oil or the like on the surface, with a surfactant, an organic solvent, an aqueous alkaline solution or the like.

The surface-roughening treatment of the aluminum surface can be performed by various methods such as a mechanical surface-roughening method, a method of dissolving and roughening the surface electrochemically, and a method of dissolving the surface selectively in a chemical manner.

Mechanical surface-roughening methods which can be used may be known methods, such as a ball polishing method, a brush polishing method, a blast polishing method or a buff polishing method. An electrochemical surface-roughening method may be a method of performing surface-roughening in an electrolyte of hydrochloric acid or nitric acid, by use of an alternating current or a direct current. As disclosed in JP-A No. 54-63902, a combination of the two kinds of methods may be used.

An aluminum plate whose surface is roughened as described above is if necessary subjected to alkali-etching treatment and neutralizing treatment. Thereafter, an anodizing treatment is optionally applied in order to improve the water holding capacity and wear resistance of the surface.

The electrolyte used in the anodizing treatment of the aluminum plate is any one selected from various electrolytes which can form a porous oxide film. Among which in general use are electrolytes of sulfuric acid, phosphoric acid, oxalic acid, chromic acid, or a mixed acid thereof. The concentration of the electrolyte may be appropriately decided depending on the kind of electrolyte selected.

Treatment conditions for anodization cannot be specified as a general rule since conditions vary depending on the electrolyte used; however, the following range of conditions are generally suitable: an electrolyte concentration of 1 to 80% by mass, a solution temperature of 5 to 70° C., a current density of 5 to 60 A/dm², a voltage of 1 to 100 V, and an electrolyzing time of 10 seconds to 5 minutes. If the amount of anodic oxide film is less than 1.0 g/m², printing resistance is inadequate or non-image portions of the planographic printing plate tend to become easily damaged and the so-called “blemish stains”, resulting from ink adhering to damaged portions at the time of printing, are easily generated.

After the anodizing treatment, the surface of the aluminum is if necessary subjected to treatment for obtaining hydrophilicity. This securance of hydrophilicity treatment may be an alkali metal silicate (for example, an aqueous sodium silicate solution) method, as disclosed in U.S. Pat. Nos. 2,714,066,3,181,461, 3,280,734, and 3,902,734. In this method, the support is subjected to an immersing treatment or an electrolyzing treatment with an aqueous sodium silicate solution.

In addition, the following methods may also be used: a method of treating the support with potassium fluorozirconate, as disclosed in JP-B No. 36-22063, or with polyvinyl phosphonic acid, as disclosed in U.S. Pat. Nos. 3,276,868, 4,153,461, and 4,689,272.

(Undercoat Layer)

In the planographic printing plate precursor of the present invention, an undercoat layer can be disposed, when required, between the support and the recording layer.

As components of the undercoat layer, various organic compounds can be used. Examples thereof include carboxymethylcellulose, dextrin, gum arabic, phosphonic acids having an amino group, such as 2-aminoethylphosphonic acid, organic phosphonic acids which may have a substituent, such as phenyl phosphonic acid, naphthylphosphonic acid, alkylphosphonic acid, glycerophosphonic acid, methylenediphosphonic acid and ethylenediphosphonic acid, organic phosphoric acids which may have a substituent, such as phenylphosphoric acid, naphthylphosphoric acid, alkylphosphoric acid and glycerophosphoric acid, organic phosphinic acids which may have a substituent, such as phenylphosphinic acid, naphthylphosphinic acid, alkylphosphinic acid and glycerophosphinic acid, amino acids such as glycine and β-alanine, and hydrochlorides of amines having a hydroxyl group, such as a hydrochloride of triethanolamine. These organic compounds may be used alone or in the form of a mixture made up of two or more thereof.

It is also preferable that an undercoating layer contains a compound having an onium group. A compound having an onium group is described in detail in JP-A No. 2000-10292 and 2000-108538. Besides, a compound selected from a group of polymer compounds having a structural unit, a representative of which is poly(p-vinyl benzoate), in a molecule may be used. More specifically, examples of the polymer compound include a copolymer of p-vinyl benzoate and a vinylbenzyltriethylammonium salt, and a copolymer of p-vinyl benzoate and vinylbenzyltrimethylammonium chloride.

Examples of a suitable undercoating layer in the invention include a layer containing a polymer (hereinafter, conveniently referred to as “polymer (i)”) having a structure represented by the followed formula (i) on a side chain.

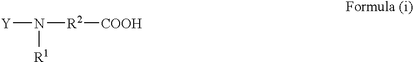

In the formula (i), Y represents a tethering group with a polymer main chain skeleton. R¹ represents a hydrogen atom or a hydrocarbon group. R² represents a divalent hydrocarbon group.

In the formula (i), Y represents a tethering group with a polymer main chain skeleton, and examples of a tethering group represented by Y include a substituted or unsubstituted divalent hydrocarbon group. The hydrocarbon group may have one or more partial structures containing one or more hetero atoms selected from the group consisting of an oxygen atom, a nitrogen atom and a sulfur atom.

In the formula (i), R¹ represents a hydrogen atom or a hydrocarbon group.

As a hydrocarbon group represented by R¹, a hydrocarbon group of a carbon atom number of 1 to 30 is preferable. Among these hydrocarbon groups, an alkyl group or an aryl group is more preferable.

A hydrocarbon group represented by R¹ may further have a substituent described later, and it is particularly preferably that the substituent is a group consisting of a carboxyl group or a salt thereof.

As a hydrocarbon group represented by R¹, a most preferable aspect is an alkyl group and an aryl group having a group consisting of a carboxyl group or the salt thereof

A hydrocarbon group in R¹, and a substituent which can be introduced into the hydrocarbon group will be explained in detail.

Examples of an alkyl group represented by R¹ include a straight, branched or cyclic alkyl group of a carbon atom number of 1 to 30, such as a methyl group, an ethyl group, a propyl group, a butyl group, a pentyl group, a hexyl group, a heptyl group, an octyl group, a nonyl group, a decyl group, an undecyl group, a dodecyl group, a tridecyl group, a hexadecyl group, an octadecyl group, an eicosyl group, an isopropyl group, an isobutyl group, a sec-butyl group, a tert-butyl group, an isopentyl group, a neopentyl group, a 1-methylbutyl group, an isohexyl group, a 2-ethylhexyl group, a 2-methylhexyl group, a cyclopentyl group, a cyclohexyl group, a 1-adamantyl group, and a 2-norbornyl group.

An aryl group represented by R² includes an aryl group in which 2 to 4 benzene rings form a fused ring, and an aryl group in which a benzene ring and an unsaturated 5-membered ring form a fused ring.

Examples of an aryl group represented by R¹ include an aryl group of a carbon atom number of 6 to 30, such as a phenyl group, a naphthyl group, an anthryl group, a phenanthryl group, an indenyl group, an acenabutenyl group, a fluorenyl group, and a pyrenyl group.

A hydrocarbon group represented by R¹ may be substituted with an arbitrary substituent at one or more places. Examples of a substituent which can be introduced into R¹ include a monovalent non-metallic atomic entity except for a hydrogen atom. Examples include a halogen atom (—F, —Br, —Cl, —I), a hydroxyl group, an alkoxy group, an aryloxy group, a mercapto group, an alkylthio group, an arylthio group, an alkyldithio group, an aryldithio group, an amino group, a N-alkylamino group, a N,N-dialkylamino group, a N-arylamino group, a N,N-diarylamino group, a N-alkyl-N-arylamino group, an acyloxy group, a carbamoyloxy group, a N-alkylcarbamoyloxy group, a N-arylcarbamoyloxy group, a N,N-dialkylcarbamoyloxy group, a N,N-diarylcarbamoyloxy group, a N-alkyl-N-arylcarbamoyloxy group, an alkylsulfoxy group, an arylsulfoxy group, an acrylthio group, an acrylamino group, an alkylacylamino group, a N-arylacylamino group, an ureido group, a N′-alkylureido group, a N′,N′-dialkylureido group, a N′-arylureido group, a N′,N′-diarylureido group, a N′-alkyl-N′-arylureido group, a N-alkylureido group, a N-arylureido group, a N′-alkyl-N-alkylureido group, a N′-alkyl-N-arylureido group, a N′,N′-dialkyl-N-alkylureido group, a N′,N′-dialkyl-N-arylureido group, a N′-aryl-N-alkylureido group, a N′-aryl-N-arylureido group, a N′,N′-diaryl-N-alkylureido group, a N′,N′-diaryl-N-arylureido group,

a N′-alkyl-N′-aryl-N-alkylureido group, a N′-alkyl-N′-aryl-N-arylureido group, an alkoxycarbonylamido group, an aryloxycarbonylamino group, a N-alkyl-N-alkoxycarbonylamino group, a N-alkyl-N-aryloxycarbonylamino group, a N-aryl-N-alkoxycarbonylamino group, a N-aryl-N-aryloxycarbonylamino group, a formyl group, an acyl group, a group consisting of a carboxyl group and a salt thereof, an alkoxycarbonyl group, an aryloxycarbonyl group, a carbamoyl group, a N-alkylcarbamoyl group, a N,N-dialkylcarbamoyl group, a N-arylcarbamoyl group, a N,N-diarylcarbamoyl group, a N-alkyl-N-arylcarbamoyl group, an alkylsulfinyl group, an arylsulfinyl group, an alkylsulfonyl group, an arylsulfonyl group, a group consisting of a sulfo group (—SO₃H) and a salt thereof, an alkoxysulfonyl group, an aryloxysulfonyl group, a sulfinamoyl group, a N-alkylsulfinamoyl group, a N,N-dialkylsulfinamoyl group, a N-arylsulfinamoyl group, a N,N-diarylsulfinamoyl group, a N-alkyl-N-arylsulfinamoyl group, a sulfamoyl group, a N-alkylsulfamoyl group, a N,N-dialkylsulfamoyl group, a N-arylsulfamoyl group, a N,N-diarylsulfamoyl group, a N-alkyl-N-arylsulfamoyl group, a group consisting of a N-acylsulfamoyl group and a salt thereof, a group consisting of a N-alkylsulfonylsulfamoyl group (—SO₂NHSO₂(alkyl)) and a salt thereof, a group consisting of a N-arylsulfonylsulfamoyl group (—SO₂NHSO₂(aryl)) and a salt thereof, a group consisting of a N-alkylsulfonylcarbamoyl group (—CONHSO₂(alkyl)) and a salt thereof,

a group consisting of a N-arylsulfonylcarbamoyl group (—CONHSO₂(aryl)) and a salt thereof, an alkoxysilyl group (—Si(Oalkyl)₃), an aryloxysilyl group (—Si(Oaryl)₃), a group consisting of a hydroxysilyl group (—Si(OH)₃) and a salt thereof, a group consisting of a phosphono group (—PO₃H₂) and a salt thereof, a dialkylphosphono group (—PO₃(alkyl)₂), a diarylphosphono group (—PO₃(aryl)₂), an alkylarylphosphono group (—PO₃(alkyl)(aryl)), a group consisting of a monoalkylphosphono group (—PO₃H(alkyl)) and a salt thereof, a group consisting of a monarylphosphono group (—PO₃H(aryl)) and a salt thereof, a group consisting of a phosphonooxy group (—OPO₃H₂) and a salt thereof, a dialkylphosphonooxy group (—OPO₃(alkyl)₂), a diarylphosphonooxy group (—OPO₃(aryl)₂), an alkylarylphosphonooxy group (—OPO₃(alkyl)(aryl)), a group consisting of a monoalkylphosphonooxy group (—OPO₂H(alkyl)) and a salt thereof, a group consisting of a monoarylphosphonooxy group (—OPO₃H(aryl)) and a salt thereof, a cyano group, a nitro group, an aryl group, an alkyl group, an alkenyl group, and an alkynyl group.

Among the above groups, as a substituent, which can be introduced into aforementioned R¹, a group consisting of a carboxy group and a salt thereof, an alkoxycarbonyl group, and an aryloxycarbonyl group are more preferable, and a group consisting of a carboxyl group and a salt thereof is particularly preferable.

In the formula (i), R² represents a divalent hydrocarbon group, and may further have a substituent. In addition, the hydrocarbon group may contain one or more hetero atoms selected from the group consisting of an oxygen atom, a nitrogen atom and a sulfur atom.

Examples of a substituent, which can be introduced into R2, include the same substituents as those indicated as a substituent which can be introduced into R¹, and a preferable substituent is the same.

A divalent hydrocarbon group represented by R² is more preferably an alkylene group or a phenyl group, which may have a substituent. Examples include a straight or branched alkylene group and phenylene group such as a methylene group, an ethylene group, a propylene group, a butylene group, an isopropylene group and an isopropylene group. Examples of a more preferable aspect include the aforementioned alkylene group substituted with a carboxylic acid group.

A carboxylic acid group possessed by the formula (i) may form an alkali metal salt or an ammonium salt.

A more preferable structure of the formula (i) is a case where R¹ is a hydrocarbon group substituted with a carboxylic acid group, and R² is a straight hydrocarbon group or a hydrocarbon group substituted with a carboxylic acid group. Further, a most preferable structure of the formula (i) is a case where R¹ is an alkyl group substituted with a carboxylic acid group, and R² is a straight alkylene group.

As a method of introducing a structure represented by the formula (i) into a polymer as a side chain, for example, a monomer having a structure represented by the formula (i) may be polymerized or copolymerized by the known method. Examples of other method include a method of reacting poly-p-aminostyrene and chloroacetic acid, and a method of reacting polychloromethylstyrene and iminodiacetonitrile, and hydrolyzing this. From a viewpoint of easier control of a rate of introduction of a structure represented by the formula (I), a method of polymerizing or copolymerizing a monomer having a structure represented by the formula (I) by the known method is preferable.

When a polymer (i) is a copolymer, it may be any of a random copolymer, a block copolymer, and a graft copolymer.

Synthesis of a specified polymer can be performed by radical polymerization using a polymerization initiator such as peroxides such as di-t-butyl peroxide, and benzoyl peroxide, persulfates such as ammonium persulfate, and an azo compound such as azobisisobutyronitrile. A polymerization initiator is appropriately selected depending on a polymerization format applied. As the polymerization format, solution polymerization, emulsion polymerization or suspension polymerization is applied.

Examples of a polymerization solvent to be used upon synthesis are not limited to, but include acetone, methyl ethyl ketone, methanol, ethanol, propanol, ethylene glycol monomethyl ether, ethylene glycol monoethyl ether, diethylene glycol dimethyl ether, 1-methoxy-2-propanol, 2-methoxyethyl acetate, 1-methoxy-2-propyl acetate, dimethoxyethane, methyl lactate, ethyl lactate, ethyl acetate, N,N-dimethylacetamide, N,N-dimethylformamide, dimethyl sulfoxide, tetrahydrofuran, toluene, and water.

Examples of a monomer having a structure represented by the formula (I) include the following compounds, however the invention is not limited to them.

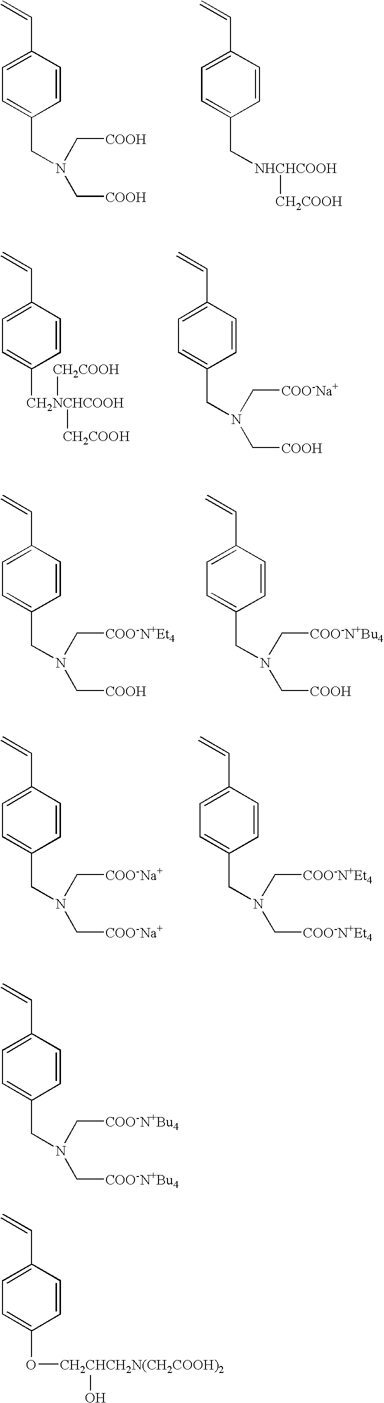

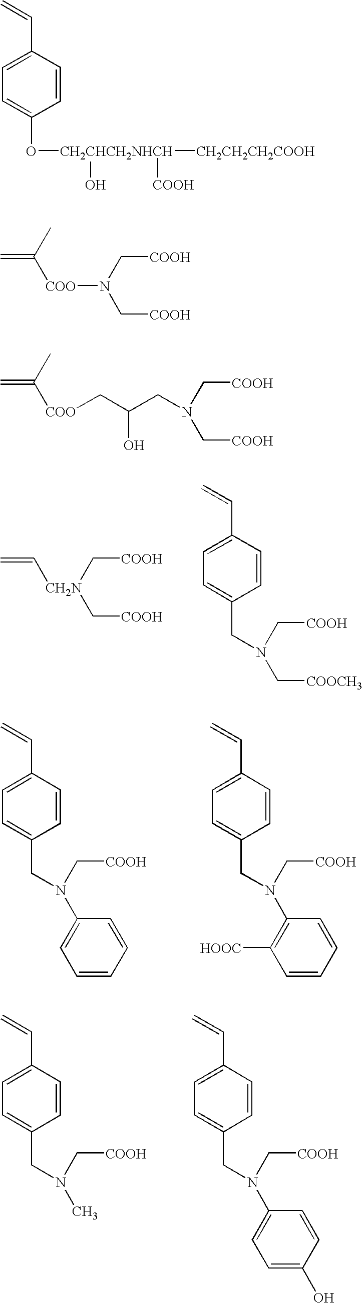

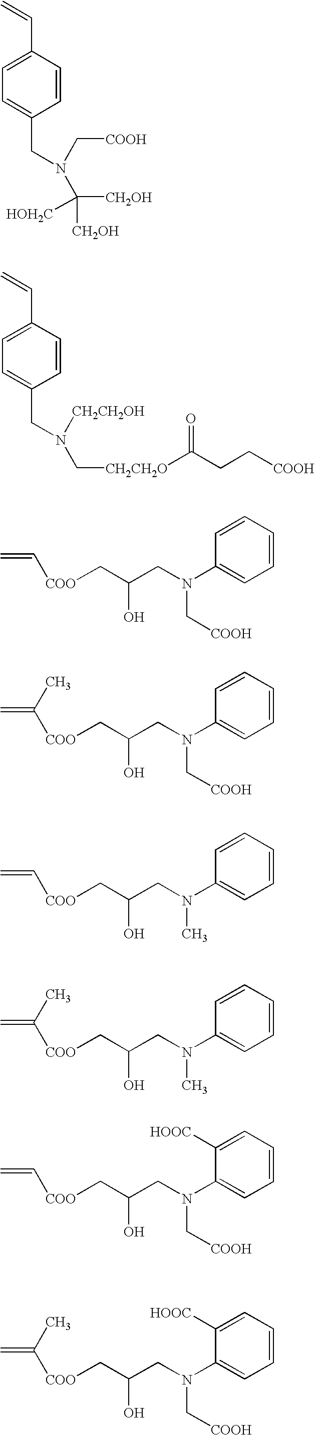

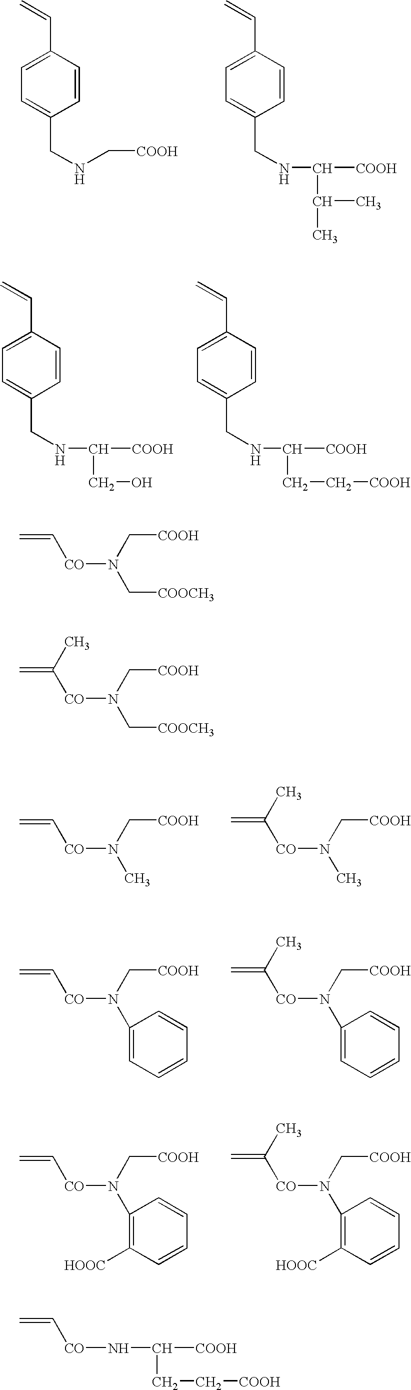

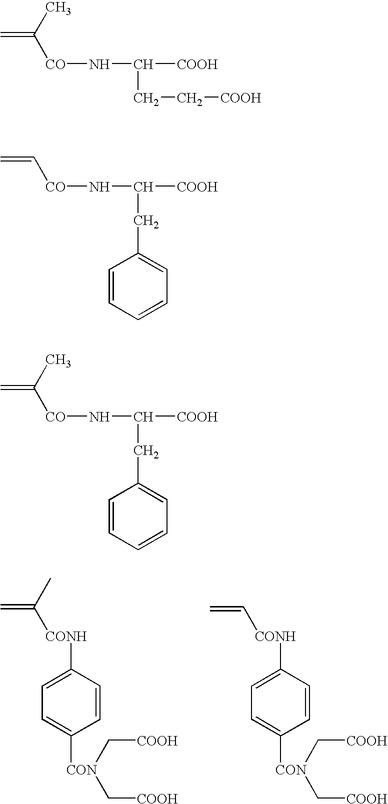

As a monomer having a structure represented by the formula (I), monomers containing the following structure are more preferable.

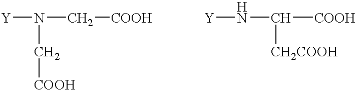

In addition, examples of a preferable structure of a tethering group with a polymer main chain skeleton represented by Y include the following structures.

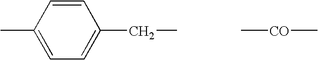

A content of a structure represented by the formula (I) in a polymer (I) is preferably 5 mol % or more, further preferably 20 mol % or more from a viewpoint that the printing resistance improving effect due to interaction with an aluminum support is sufficiently exerted.

A weight average molecular weight of the polymer (I) is preferably 500 to 1000000, more preferably 1000 to 500000.

For the purpose of enhancing further interaction with a support, or enhancing interaction with a recording layer, a polymer (i) may be copolymerized with other monomer component. Examples of the other monomer component include a “monomer having an onium group” from a viewpoint of improvement in adherability with a hydrophilization-treated substrate, a “monomer having an acid group” from a viewpoint of improvement in adherability with a hydrophilization-treated substrate and improvement in solubility in a developer, and a “monomer having a functional group which can interact with a recording layer” from a viewpoint of improvement in adherability with a recording layer.

<Monomer Having an Onium Group>

As the monomers each containing an onium group, monomers defined by the following general formulas (A) to (C) can be exemplified, but they are not limited to these examples.

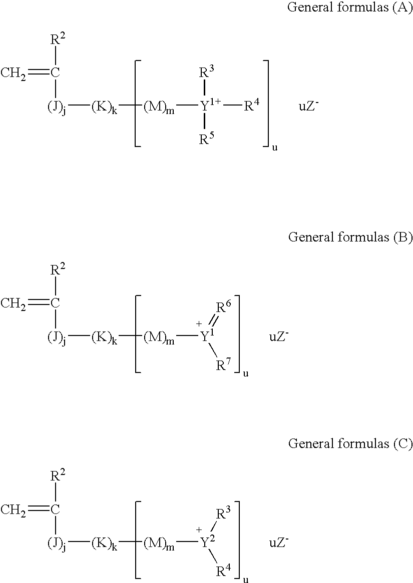

In the general formulas (A) to (C), J represents a divalent linking group; K represents an aromatic group or a substituted aromatic group; M represents a divalent linking group; Y¹ represents an atom belonging to V group in a periodic table; Y² represents an atom belonging to VI group in a periodic table; Z represents a coupled anion; R² represents a hydrogen atom, an alkyl group, or a halogen atom; R³, R⁴, R⁵, and R⁷ independently represent a hydrogen atom, or an alkyl group, an aromatic group, or an aralkyl group which may have substituent groups; R⁶ represents an alkyllysine group or a substituted alkyllysine group; R³ with R⁴ and R⁶ with R⁷ may be bonded to form rings; j, k, and m independently represent 0 or 1; and u represents an integer of 1 to 3.

Among the monomers having the onium groups defined by general formulas (A) to (C), following examples are especially preferable.

J represents —COO— or —CONH— and K represents a phenylene group or a substituted phenylene group. In the case where K represents a substituted phenylene group, the substituent group is preferably a hydroxyl group, a halogen atom, or an alkyl group.

M represents an alkylene group or a divalent linking group defined by a molecular formula CₙH₂ₙO, CₙH₂ₙS, or CnH₂ₙ₊₁N, wherein n represents an integer of 1 to 12.

Y¹ represents a nitrogen atom or a phosphorus atom and Y² represents a sulfur atom.

Z⁻ represents a halogen ion, PF₆⁻, BF₄⁻, or R⁸SO₃⁻.

R² represents a hydrogen atom or an alkyl group.

R³, R⁴, R⁵, and R⁷ independently represent a hydrogen atom, or an alkyl group having 1 to 10 carbon atoms, an aromatic group having 6 to 10 carbon atoms, or an aralkyl group having 7 to 10 carbon atoms which may have substituent groups.

R⁶ represents an alkyllysine group or a substituted alkyllysine group having 1 to 10 carbon atoms.

R³ with R⁴ and R⁶ with R⁷ may be bonded to form rings.

The reference characters j, k, and m independently represent 0 or 1; and j and k are preferably not to be zero simultaneously.

R⁸ represents an alkyl group having 1 to 10 carbon atoms, an aromatic group having 6 to 10 atoms, or an aralkyl group having 7 to 10 atoms which may be bonded with a substituent group.

Further more preferable examples of the monomer having the onium group defined by the general formulas (A) to (C) include are follows.

K represents a phenylene group or a substituted phenylene group. In the case where K represents a substituted phenylene group, the substituent group is a hydrogen atom or an alkyl group having 1 to 3 carbon atoms.

M represents an alkylene group having 1 or 2 carbon atoms or an alkylene group having 1 or 2 carbon atoms bonded by an oxygen atom.

Z⁻ represents chlorine ion or R⁸SO₃⁻. R² represents a hydrogen atom or a methyl group. “j” is 0 and k is 1. R³ represents an alkyl group having 1 to 3 carbon atoms.

Hereinafter, specific examples of the monomer having onium group used for the specific polymer (i) of the present invention will be exemplified, but the monomer of the invention is not limited to these examples.

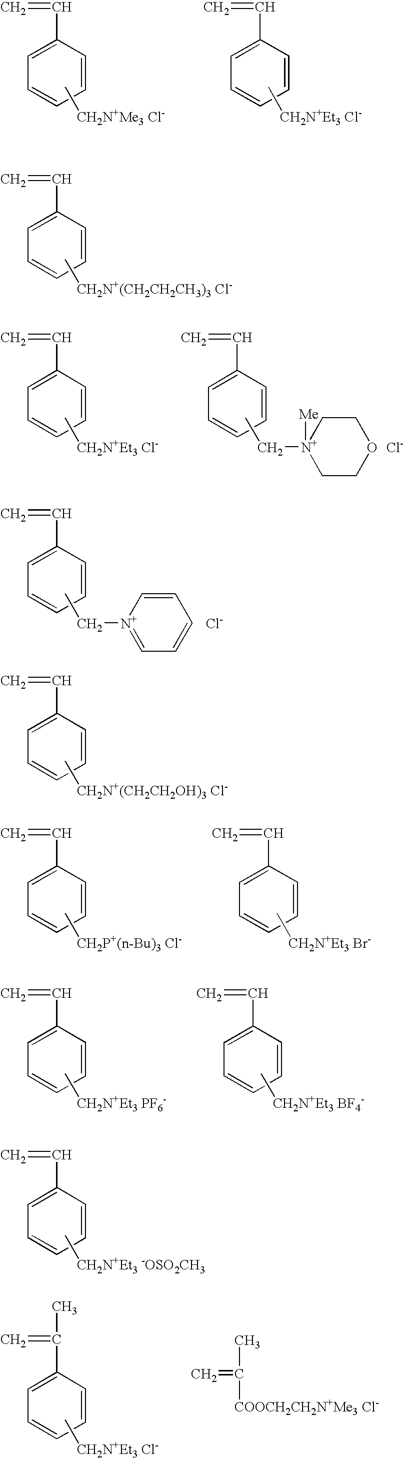

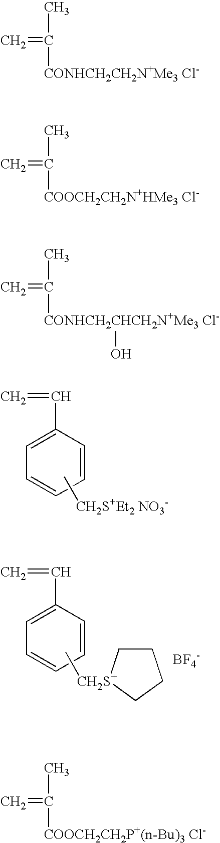

<Monomer Having Acid Group>

A monomer having an acid group, which is suitably used in a specified polymer, will be explained.

As an acid group contained in a monomer having an acid group, a carboxylic acid group, a sulfonic acid group, or a phosphonic acid group is particularly preferable, being not limiting.

-Monomer Having Carboxylic Acid Group-

A monomer having a carboxylic acid group is not particularly limited as far as it is a polymerizable compound having a carboxylic acid group and a polymerizable double bond in its structure.

Preferable examples of the monomer having a carboxylic acid group include a compound represented by the following formula (1).

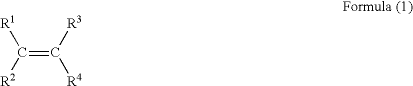

In the formula (1), R¹ to R⁴ each represents, independently, a hydrogen atom, an alkyl group, or an organic group represented by the following formula (2), and at least one of R¹ to R⁴ is an organic group represented by the following formula (2).

Herein, from a viewpoint of copolymerizability and raw material availability upon preparation of a specified polymer, R¹ to R⁴ have preferably 1 to 2, particularly preferably one organic groups represented by the following formula (2). From a viewpoint of flexibility of a specified polymer obtained as a result of polymerization, among R¹ to R⁴, groups other than an organic group represented by the following formula (2) are preferably an alkyl group or a hydrogen atom, particularly preferably a hydrogen atom.

From the same reason, when R¹ to R⁴ are an alkyl group, it is preferably an alkyl group of a carbon number of 1 to 4, particularly preferably a methyl group.
—X—COOH Formula (2)

In the formula (2), X represents a single bond, an alkylene group, an arylene group optionally having a substituent, or any of groups represented by the following structural formulae (i) to (iii). From a viewpoint of polymerizability and availability, a single bond, an arylene group, a representative of which is a phenylene group, or a group represented by the following structural formula (i) are preferable, an arylene group or a group represented by the following structural formula (i) is more preferable, and a group represented by the following structural formula (i) is particularly preferable.

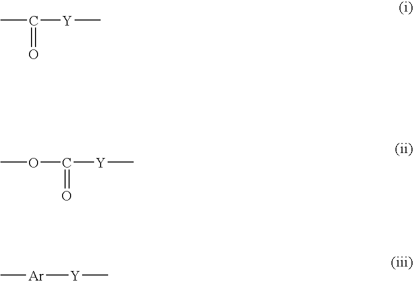

In the structural formulae (i) to (iii), Y represents a divalent tethering group, and Ar represents an arylene group optionally having a substituent. As Y, an alkylene group of a carbon atom number of 1 to 16, or a single bond is preferable. Methylene (—CH₂—) in an alkylene group may be substituted with an ether bond (—O—), a thioether bond (—S—), an ester bond (—COO—), or an amide bond (—CONR—; R represents a hydrogen atom or an alkyl group) and, as a bond for substitution of a methylene group, an ether bond or an ester bond is particularly preferable.

Among such the divalent tethering group, particularly preferable examples are as follows:

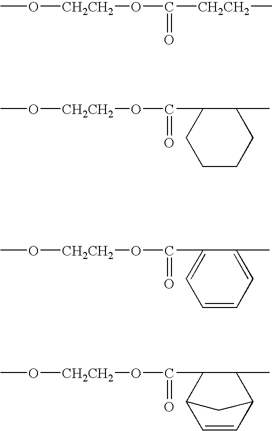

Particularly preferable examples of a monomer having a carboxylic acid group represented by the formula (1) are shown below, however the invention is not limited to them.

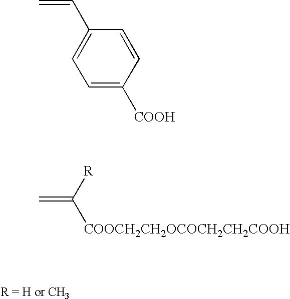

-Monomer Having Sulfonic Acid Group-

A monomer having a sulfonic acid group is not particularly limited as far as it is a polymerizable compound having a sulfonic acid group and a polymerizable double bond in its structure.

Preferable examples of the monomer having a sulfonic acid group include 3-sulfopropyl acrylate, 3-sulfopropyl methacrylate, and 4-styrenesulfonic acid.

-Monomer Having Phosphonic Acid Group-

A monomer having a phosphonic acid group is not particularly limited as far as it is a polymerizable compound having a phosphonic acid group and a polymerizable double bond in its structure.

Preferable examples of a monomer having a phosphonic acid group include acidphosphoxyethyl methacryalte, 3-chloro-2-acidphosphoxypropyl methacryalte, and acidphosphoxypolyoxyethylene glycol monomethacrylate.

<Other Monomer>

Examples of other monomer will be shown below, however the invention is not limited to them.

(1) Acrylamides, methacrylamides, acrylic acid esters, methacrylic acid esters and hydroxystyrenes having an aromatic hydroxy group, such as N-(4-hydroxyphenyl)acrylamide or N-(4-hydroxyphenyl)methacrylamide, o-, m- or p-hydroxystyrene, o- or m-bromo-p-hydroxystyrene, o- or m-chloro-p-hydroxystyrene, and o-, m- or p-hydroxyphenyl acrylate or methacrylate;

(2) Acrylamides such as N-(o-aminosulfonylphenyl)acrylamide, N-(m-aminosulfonylphenyl)acrylamide, N-(p-aminosulfonylphenyl)acrylamide, N-[1-(3-aminosulfonyl)naphthyl]acrylamide, and N-(2-aminosulfonylethyl)acrylamide, methacrylamides such as N-(o-aminosulfonylphenyl)methacrylamide, N-(m-aminosulfonylphenyl)methacrylamide, N-(p-aminosulfonylphenyl)methacrylamide, N-[1-(3-aminosulfonyl)naphthyl]methacrylamide, and N-(2-aminosulfonylethyl)methacrylamide, as well as unsaturated sulfonamides of acrylic acid esters such as o-aminosulfonylphenyl acrylate, m-aminosulfonylphenyl acrylate, p-aminosulfonylphenyl acrylate, and 1-(3-aminosulfonylphenylnaphthyl) acrylate, unsaturated sulfonamides of methacrylic acid esters such as o-aminosulfonylphenyl methacrylate, m-aminosulfonylphenyl methacrylate, p-aminosulfonylphenyl methacrylate, and 1-(3-aminosulfonylphenylnaphthyl) methacrylate;

(3) Phenylsulfonylacrylamide optionally having a substituent such as tosylacrylamide, and phenylsulfonylmethacrylamide optionally having a substituent such as tosylmethacrylamide;

(4) Acrylic acid esters and methacrylic acid esters having an aliphatic hydroxy group, for example, 2-hydroxyethyl acrylate or 2-hydroxyethyl methacrylate;

(5) (Substituted) acrylic acid ester such as methyl acrylate, ethyl acrylate, propyl acrylate, butyl acrylate, amyl acrylate, hexyl acrylate, cyclohexyl acrylate, octyl acrylate, phenyl acrylate, benzyl acrylate, 2-chloroethyl acrylate, 4-hydroxybutyl acrylate, glycidyl acrylate, and N-dimethylaminoethyl acrylate;

(6) (Substituted) methacrylic acid ester such as methyl methacrylate, ethyl methacrylate, propyl methacrylate, butyl methacrylate, butyl methacrylate, amyl methacrylate, hexyl methacrylate, cyclohexyl methacrylate, octyl methacrylate, phenyl methacrylate, benzyl methacrylate, 2-chloroethyl methacrylate, 4-hydroxybutyl methacrylate, glycidyl methacrylate, and N-dimethylaminoethyl methacrylate;

(7) Acrylamide or methacrylamide such as acrylamide, methacrylamide, N-methylolacrylamide, N-methylolmethacrylamide, N-ethylacrylamide, N-ethylmethacrylamide, N-hexylacrylamide, N-hexylmethacrylamide, N-cyclohexylacrylamide, N-cyclohexylmethacrylamide, N-hydroxyethylacrylamide, N-hydroxyethylacrylamide, N-phenylacrylamide, N-phenylmethacrylamide, N-benzylacrylamide, N-benzylmethacrylamide, N-nitrophenylacrylamide, N-nitrophenylmethacrylamide, N-ethyl-N-phenylacrylamide and N-ethyl-N-phenylmethacrylamide;

(8) Vinyl ethers such as ethyl vinyl ether, 2-chloroethyl vinyl ether, hydroxyethyl vinyl ether, propyl vinyl ether, butyl vinyl ether, octyl vinyl ether, and phenyl vinyl ether;

(9) Vinyl esters such as vinyl acetate, vinyl chloroacetate, vinyl butyrate, and vinyl benzoate:

(10) Styrenes such as styrene, α-methylstyrene, methylstyrene, and chloromethylstyrene;

(11) Vinyl ketones such as methyl vinyl ketone, ethyl vinyl ketone, propyl vinyl ketone, and phenyl vinyl ketone;

(12) Olefins such as ethylene, propylene, isobutylene, butadiene, and isoprene;

(13) N-vinylpyrrolidone, N-vinylcarbazole, 4-vinylpyridine, acrylonitrile, and methacrylonitrile;

(14) Lactone group-containing monomer such as pantoyllactone (meth)acrylate, α-(meth)acryloyl-γ-butyrolactone, and β-(meth)acryloyl-γ-butyrolactone;

(15) Ethylene oxide group-containing monomer such as polyethylene glycol mono(meth)acrylate, propylene glycol mono(meth)acrylate, and methoxypolyethylene glycol mono(meth)acrylate.

In the polymer (i), a content of the aforementioned other monomer is preferably 95 mol % or lower, more preferably 80 mol % or lower.

Among other monomer, it is preferable to copolymerize (4) acrylic acid esters and methacrylic acid esters having an aliphatic hydroxy group, (5) acrylic acid esters, (6) metharylic acid esters.

Examples (P-1 to P-21) of a polymer (i) will be shown below, however the invention is not limited to them.

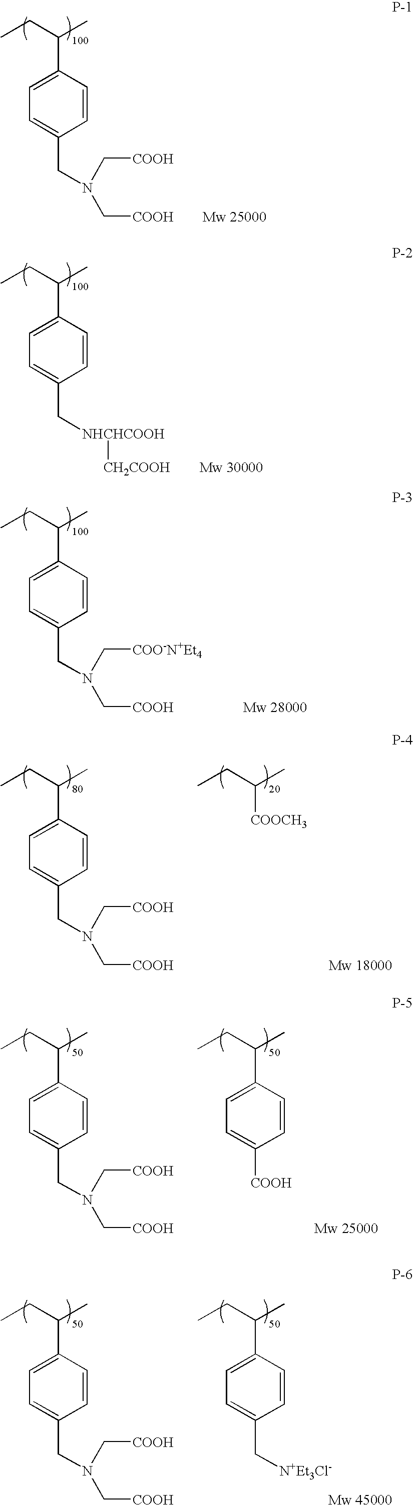

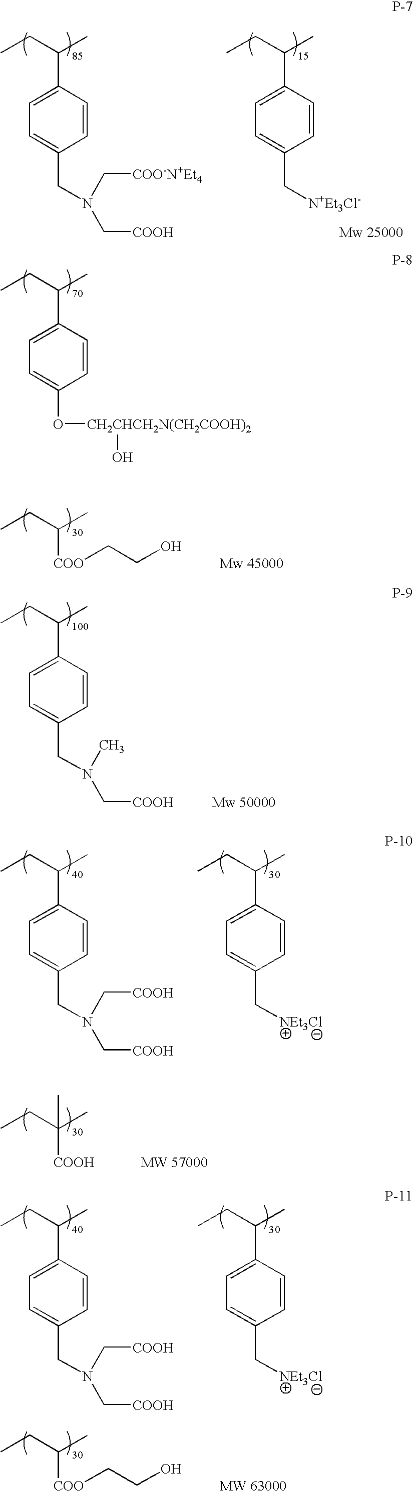

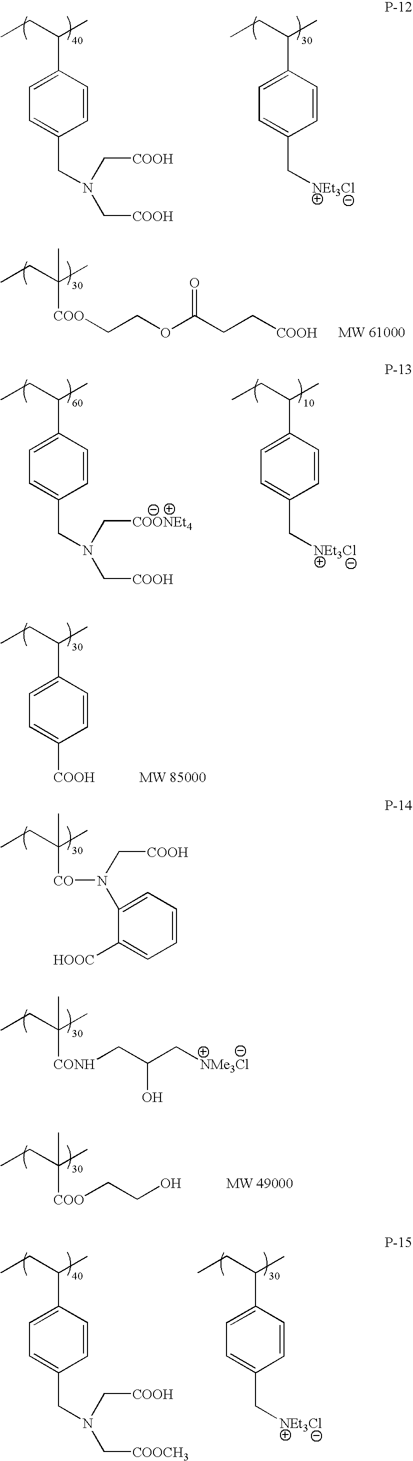

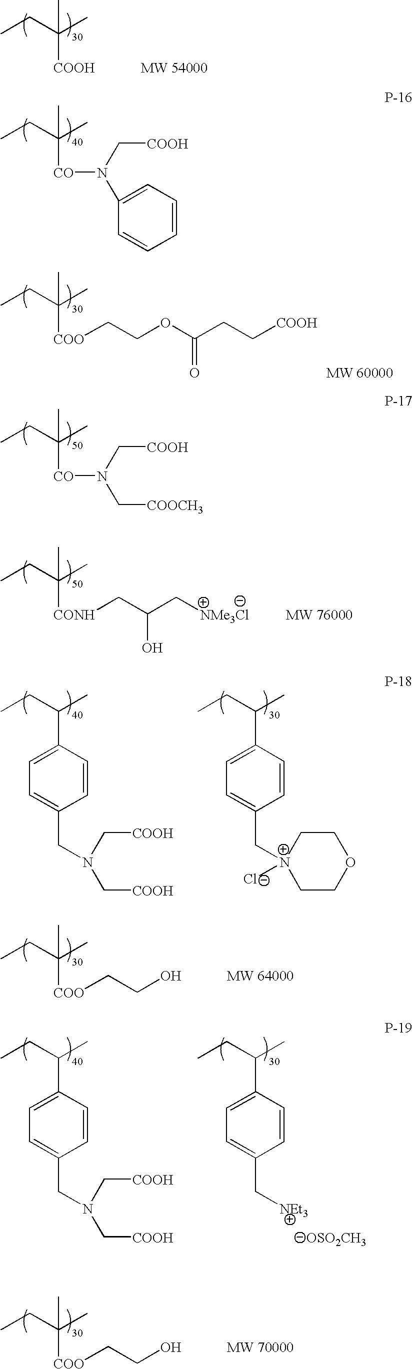

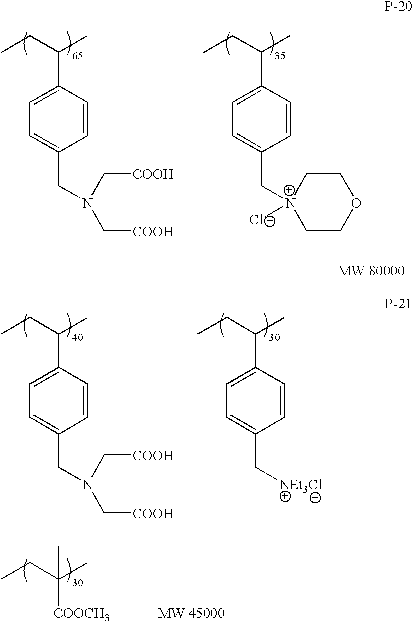

A content of a polymer (i) in an undercoating layer is preferably 50 to 100% by mass, more preferably 80 to 100% by mass relative to a total solid matter constituting an undercoating layer.

This undercoating layer (organic undercoating layer) can be provided by the following method. That is, there are a method of providing the layer by coating on an aluminum plate a solution in which the aforementioned organic compound is dissolved in water or an organic solvent such as methanol, ethanol and methyl ethyl ketone, or a mixed solvent of them, followed by drying, and a method of providing an organic undercoating layer by immersing an aluminum plate in a solution in which the aforementioned organic compound is dissolved in water or an organic solvent such as methanol, ethanol and methyl ethyl ketone, or a mixed solvent thereof, to adsorb the compound thereon and, thereafter, washing this with water, followed by drying. In the former method, a solution of the organic compound having a concentration of 0.005 to 10% by mass can be coated by various methods. In addition, in the latter method, a concentration of a solution is 0.01 to 20% by mass, preferably 0.05 to 5% by mass, an immersion temperature is 20 to 90° C., preferably 25 to 50° C., and an immersion time is 0.1 seconds to 20 minutes, preferably 2 seconds to 1 second. A solution used therefor may be adjusted into a range of pH 1 to 12 with a basic substance such as ammonia, triethylamine, and a basic substance such as potassium hydroxide, or an acid substance such as hydrochloric acid and phosphoric acid. In addition, for improving tone reproductivity of a heat-sensitive planographic printing plate, a yellow dye may be added.

A covering amount of an undercoating layer is suitably 2 to 200 mg/m², preferably 5 to 100 mg/m². In this range, better printing resistance is obtained.

<Plate-Making and Plating>

In the planographic printing plate of the invention, an image is formed by heat. Specifically, direct image-like recording with a thermal recording head, scanning light exposure with infrared-ray laser, high illuminance flash exposure such as xenon discharge lamp, and infrared-ray lamp exposure are used, and exposure with a solid high output infrared-ray laser such as a semiconductor laser and YAG laser which radiates infrared-ray having a wavelength of 700 to 1200 nm is suitable.

(Alkali Developer)

The exposed planographic printing plate precursor is developed with an alkali developer (hereinafter, simply also referred to as developer). It is essential that a developer used in plate-making of the planographic printing plate precursor of the invention contains at least one kind selected from an anionic surfactant and an amphoteric surfactant in an aqueous alkali solution.

The effect of a surfactant in the invention is that a highly clear image can be formed by improving dispersibility of a dissolved resin at an exposed part, and increasing solubility of an alkali-soluble resin remaining in a concave part of a support in alkali. In addition, there is also an effect that a dreg generated by insoluble components of a dissolved resin is dispersed.

Examples of an anionic surfactant include fatty acid salts, abietic acid salts, hydroxyalkanesulfonic acid salts, alkanesulfonic acid salts, dialkylsulfosuccinic acid ester salts, straight alkylbenzenesulfonic acid salts, branched alkylbenzenesulfonic acid salts, alkylnaphthalenesulfonic acid salts, alkylphenoxypolyoxyethylenepropylsulfonic acid salts, polyoxyethylene alkyl sulfophenyl ether salts, N-methyl-N-oleyltaurin sodium salt, N-alkylsulfosuccinic acid monoamide disodium salt, petroleum sulfonic acid salts, sulfated beef tallow oil, fatty acid alkyl ester sulfate ester salts, alkylphosphate ester salts, polyoxyethylene alkyl ether sulfate ester salts, aliphatic acid monoglyceride phosphate ester salts, polyoxyethylene alkyl phenyl ether sulfate ester salts, polyoxyethylene styryl phenyl ether sulfate ester salts, alkyl phosphate ester salts, polyoxyethylene alkyl ether phosphate ester salts, polyoxyethylene alkyl phenyl ether phosphate ester salts, styrene/maleic acid anhydride polymer partial saponified entities, olefin/maleic anhydride copolymer partial saponified entities, and naphthalenesulfonate salt formalin-fused entities. Inter alia, preferable examples include fatty acid salts classified into carboxylic acid type, abietic acid salts, hydroxyalkanesulfonic acid salts classified into a sulfonic acid type, alkanesulfonic acid salts, alkyl diphenyl ether sulfonic acid salts, diphenyl ether disulfonic acid salts, dialkylsulfosuccinic acid ester salts, olefinsulfonic acid salts, straight alkylbenzenesulfonic acid salts, branched alkylbenzenesulfonic acid salts, alkylnaphthalenesulfonic acid salts, alkylphenoxypolyoxyethylenepropylsulfonic acid salts, polyoxyethylenealkylsulfophenyl ether salts, N-alkylsulfosuccinic acid monoamide disodium salt, petroleum sulfonic acid salts, and naphthalenesulfonic acid salt formalin condensed entities.

Examples of an amphoteric surfactant include alkylaminocarboxylic acids such as alkylbetaine type, amidobetaine type, imidazolinium betaine type, alkylglycine type and alkylalanine type, and sulfobetaine type, and particularly preferable examples include alkylaminocarboxylic acids such as alkylglycine type, and alkylalanine type.

A developer used in the invention preferably contains any one kind or more of an anionic surfactant and an amphoteric surfactant, or may contain both of them.

A content of the surfactant in a developer is preferably 0.001 to 10% by mass, more preferably 0.005 to 1% by mass, most preferably 0.01 to 0.5% by mass.

When the content is less than 0.001% by mass, the effect of improving image forming property and of suppressing generation of insolubles is insufficient and, when a content exceeds 10% by mass, a developing force may be reduced in some cases.

An aqueous alkali solution used in a developer, which is applied to the invention, can be appropriately selected among the conventionally known aqueous alkali solutions. Among them, examples of a preferable aqueous alkali solution include a developer comprising alkali silicate or non-reducing sugar, and a base and, particularly, a developer having a pH of 12.5 to 14.0 is preferable. The alkali silicate exhibits alkaline property when dissolved in water, and examples include sodium silicate, potassium silicate, and lithium silicate, and ammonium silicate. Alkali silicates may be used alone, or by combining two or more kinds.

Developability of the aqueous alkali solution can be easily regulated by adjusting a mixing ratio of silicon oxide SiO₂, which is a component of a silicate salt and an alkali oxide M₂O (M represents an alkali metal or an ammonium group), and a concentration.

Among the aqueous alkali solutions, a solution in which a ratio of mixing the silicon oxide SiO₂ and alkali oxide M₂O (SiO₂/M₂O: mole ratio) is preferably 0.5 to 3.0, more preferably 1.0 to 2.0. When the SiO₂/M₂O is less than 0.5, since an alkali intensity is increased, a harmful influence that an aluminum plate of a support is etched is caused and, when the SiO₂/M₂O exceeds 3.0, developability is reduced in some cases.

In addition, a concentration of alkali silicate in a developer is preferably 1 to 10% by mass, more preferably 3 to 8% by mass, most preferably 4 to 7% by mass relative to a mass of an aqueous alkali solution. When this concentration is less than 1% by mass, processing ability is reduced in some cases and, when the concentration exceeds 10% by mass, precipitates or crystals are easily produced and, further, upon neutralization of a waste solution, gelling is easily caused, and waste solution treatment is adversely influenced.

In a developer comprising a non-reducing saccharide and a base, non-reducing saccharide means a saccharide which has no reducing property since an aldehyde group or a ketone group is not possessed, and such the saccharide is classified into trehalose-type oligosaccharides in which reducing groups are bound, glycoside in which a reducing group of saccharides and non-saccharides are bound, and sugar alcohol obtained by reduction by adding hydrogen to saccharides. In the invention, any of them can be suitably used.

Examples of trehalose-type oligosaccharide include saccharose and trehalose, and example of the glycoside include an alkyl glycoside, a phenol glycoside, and a mustard oil glycoside.

Examples of sugar alcohol include D,L-arabit, libit, xylit, D,L-sorbit, D,L-mannit, D,L-idit, D,L-darit, dulcit, and allodulcit. Further preferable examples include maltitol obtained by hydrogenating disaccharides, and reduced entity obtained by hydrogenating an oligosaccharide (reduced thick mold syrup).

Among them, as a non-reducing sugar, sugar alcohol and saccharose are preferable and, inter alia, particularly, D-sorbit, saccharose and reduced thick mold syrup are more preferable in that they have buffering activity in a suitable pH region.

These non-reducing sugars can be used alone, or by combining two or more kinds, and a ratio occupied in a developer is preferably 0.1 to 30% by mass, more preferably 1 to 20% by mass.

The alkali silicate or non-reducing sugar can be combined with an alkali agent as a base by appropriately selecting it among the conventionally known alkali agents.

Examples of the alkali agent include inorganic alkali agents such as sodium hydroxide, potassium hydroxide, lithium hydroxide, trisodium phosphate, tripotassium phosphate, triammonium phosphate, disodium phosphate, dipottasium phosphate, diammonium phosphate, sodium carbonate, potassium carbonate, ammonium carbonate, sodium hydrogen carbonate, potassium hydrogen carbonate, ammonium hydrogen carbonate, sodium borate, potassium borate, and ammonium borate, potassium citrate, tripotassium citrate, and sodium citrate.

Further, preferable examples include organic alkali agents such as monomethylamine, dimethylamine, trimethylamine, monoethylamine, diethylamine, triethylamine, monoisopropylamine, diisopropylamine, triisopropylamine, n-butylamine, monoethanolamine, diethanolamine, triethanolamine, monoisopropanolamine, diisopropanolamine, ethyleneimine, ethylenediamine, and pyridine.

These alkali agents may be used alone, or may be used by combining two or more kinds. Inter alia, sodium hydroxide, and potassium hydroxide are preferable. The reason is that it becomes possible to adjust a pH in a wide pH region by adjusting an amount to be added to a non-reducing sugar.

In addition, it is preferable that a developer, which is applied to the invention, contains a salt of an alkali metal or a quaternary ammonium cation in addition to the aforementioned aqueous alkali solution.

The effect of these salts is such that a highly clear image can be formed by improving permeation of an alkali into an exposed part, and increasing solubility of an alkali-soluble resin remaining in a concave part of a support in an alkali. As a result, an alkali intensity (pH) of a developer can be reduced, and scratch resistance of an image part can be greatly improved.

Examples of salts of an alkali metal or a quaternary ammonium cation to be contained in a developer include inorganic salts such as halide, sulfate, nitrate, phosphate, carbonate, and borate, and organic acid salts such as formate, acetate, propionate, maleate, lactate, levulinate, malonate, adipate, fumarate, citrate, malate. Particularly, a potassium salt, a sodium salt, and a lithium salt are preferable.

A developer, which is applied to the invention, may contain one kind of the aforementioned compound alone, or two or more kinds.

Since the effect of the aforementioned compound in a developer depends on molarity of an alkali metal or quaternary ammonium cation, a content of the compound in a developer is preferably 0.01 to 1 mole/liter, more preferably 0.05 to 0.5 mole/liter in terms of an alkali metal or quaternary ammonium cation.

When the content is less than 0.01 mole/liter, the effect of improving image forming property is insufficient and, when the content exceeds 1 mole/liter, not only the effect of improving image forming property remains unchanged, but also other component is made to be insoluble in some cases.

For the purpose of further enhancing developing performance, the following additive may be added to a developer.

Examples include a chelating agent such as EDTA and NTA described in JP-A No. 58-190952, a complex such as [Co(NH₃)₆]Cl₃ and CoCl₂.6H₂O described in JP-A No. 59-121336, a nonionic surfactant such as tetramethyldecynediol described in U.S. Pat. No. 4,374,920, a cationic polymer of p-dimethylaminomethylpolystyrene with methyl chloride quaternary compound described in JP-A No. 55-95946, an amphoteric polymer electrolyte such as a copolymer of vinylbenzyltrimethylammonium chloride and sodium acrylate described in JP-A No. 56-142528, a reducing inorganic salt such as sodium sulfite described in JP-A No. 57-192951, an organic metal surfactant containing organic Si or Ti described in JP-A No. 59-75255, an organic boron compound described in JP-A No. 59-84241, and a quaternary ammonium salt such as tetraallkylammonium oxide described in EP No. 101010.

A surface tension of a developer is preferably 65 dyne/cm or lower, particularly, more preferably 60 dyne/cm or lower. A surface tension of a developer can be measured, for example, by a vibration jet method and, as a measuring equipment, there is an automatic dynamic surface tension meter JET-type.

A use aspect of an alkali developer in the invention is not particularly limited.

In recent years, particularly, in plate-making•printing field, for rationalizing and standardizing plate-making work, an automatic developing machine for a printing plate material is widely used.

This automatic developing machine generally consists of a developing part and a post-treating part, consists of an apparatus for conveying a printing plate material, each treating solution tank and a spray apparatus, and is to perform developing treatment by blowing each treating solution drawn with a pump through a spraying nozzle while an already exposed printing plate is horizontally conveyed. In addition, in recent years, a method of treatment by immersing and conveying a printing plate material in a treating solution tank filled with a treating solution with an in liquid guide roll is also known. Upon immersion development, it is preferable to uniformly supply a developer to a plate surface, and a supply amount is desirably in a range of 0.5 to 10 ml/sec·cm². An amount of developer to be supplied to a plate surface can be defined by a conveying rate, and a supply amount by a means for supplying a developer, and examples of a means for supplying a developer include convection with a spraying apparatus or a circulating pomp. In such the automatic treatment, treatment can be performed while a replenisher is replenished to each treating solution, depending on a treating amount and a working time.

In this case, by adding an aqueous solution having higher alkali intensity than a developer as a development replenisher to a developer, many planographic printing plates can be treated without exchanging a developer in a development tank for a long time. Also, upon use of an alkali development treating solution of the invention, it is a preferable aspect that this replenishing format is adopted. As a development replenisher in that case, formation of the above-explained alkali developer can be used.

For the purpose of promoting or suppressing developability, dispersing a development dreg, and enhancing inkphilicity of a printing plate image part, if necessary, various surfactants and organic solvents other than those described above may be added to the developer and the development replenisher. As an organic solvent, benzyl alcohol is preferable. Alternatively, it is preferable to add polyethylene glycol or a derivative thereof, or polypropylene glycol or a derivative thereof.

Further, if necessary, an inorganic salt-based reducing agent such the hydroquinone, resorcin, and a sodium salt or a potassium salt of sulfurous acid or hydrogensulfurous acid, organic carboxylic acid, an anti-foam agent, and a hard water-softening agent may be added.

A plate-making method, which is applied to the invention, can be also applied to so-called disposable treating format development in which treatment is performed with a substantially unused developer, in addition to the aforementioned developing format development.

The planogaphic printing plate, which has been development-treated using the aforementioned alkali developer, is post-treated with a rinse solution containing washing water and a surfactant, or a desensitizing solution (gum solution) containing gum arabic and a starch derivative. This post-treatment can be performed by variously combining these known treating solutions.

### EXAMPLES

The present invention will be further specifically explained below by way of Examples, however, the scope of the invention is, of course, not limited thereto.

### Synthesis Example 1

### Synthesis of (a) Long Chain Alkyl Group-Containing Polymer A

59 g of 1-methoxy-2-propanol was placed into a 1000 ml three-neck flask equipped with a condenser and a stirrer, and this was heated to 80° C. Under a nitrogen stream, a solution containing 42.0 g of stearyl n-methacrylate, 16.0 g of methacrylic acid, 0.714 g of polymerization initiator V-601 (manufactured by Wako Pure Chemical Industries, Ltd.), and 59 g of 1-methoxy-2-propanol was added dropwise over two and a half hours. Further, the mixture was reacted at 80° C. for 2 hours. The reaction mixture was cooled to room temperature, and the reaction solution was poured into 1000 ml of water. After decantation, this was washed with methanol, and the resulting liquid product was dried under reduced pressure to obtain 73.5 g of the (a) long chain alkyl group-containing polymer A shown below. The mass average molecular weight was measured by a gel permeation chromatography method (GPC) using polystyrene as the standard substance and, as a result, it was 66,000.
Long Chain Alkyl Group-Containing Polymer A 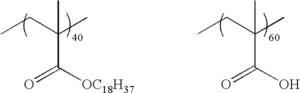
Weight average molecular weight

### Synthesis Example 2

### Synthesis of (a) Long Chain Alkyl Group-Containing Polymer B

56.0 g of 1-methoxy-2-propanol was placed into a 1000 ml three-neck flask equipped with a condenser and a stirrer, and this was heated to 80° C. Under a nitrogen stream, a solution containing 22.3 g of dodecyl n-methacrylate, 33.7 g of a monomer having the following structure, 0.504 g of polymerization initiator V-601 (manufactured by Wako Pure Chemical Industries, Ltd.) and 56.0 g of 1-methoxy-2-propanol was added dropwise over two and a half hours. Further, the mixture was reacted at 80° C. for 2 hours. The reaction mixture was cooled to room temperature, and the reaction solution was poured into 1000 ml of water. After decantation, this was washed with methanol, and the resulting liquid product was dried under reduced pressure to obtain 50.3 g of (a) long chain alkyl group-containing polymer B. The mass average molecular weight was measured by a gel permeation chromatography method (GPC) using polystyrene as the standard substance and, as a result, it was 62,000.

Monomer Used in Synthesis Example 2

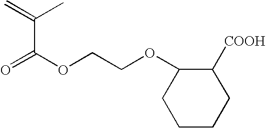

Long Chain Alkyl Group-Containing Polymer B

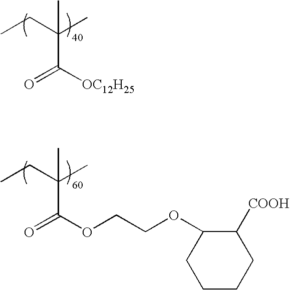

Weight Average Molecular Weight 62,000

### Synthesis Examples 3 to 9

### Synthesis of (a) Long Chain Alkyl Group-Containing Polymers C to I

In the same manner as that of Synthesis Example 1 or Synthesis Example 2, a long chain alkyl group-containing monomer, and a vinyl monomer having a carboxyl group shown in the following Table 1 were used to synthesize (a) long chain alkyl group-containing polymers C to I relating to the present invention. Further, the molecular weights were measured by GPC. Results of the measurements are shown in Table 1.

TABLE 1

| (a)Long chain | Long chain alkyl | | Weight |
|---|---|---|---|
| alkyl | group-containing | Vinyl monomer having | average |
| group-containing | monomer | a carboxyl group | molecular |
| polymer | (mol %) | (mol %) | weight |
| C | 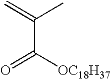 | 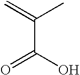 | 63,000 |
| | (55) | (45) | |
| D | 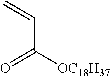 | 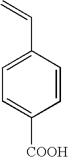 | 66,000 |
| | (40) | (60) | |
| E | 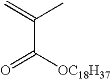 | 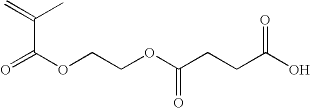 | 65,000 |
| | (55) | (45) | |
| F | 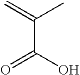 | 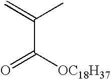 | 60,000 |
| | (20) | (80) | |
| G | 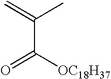 | 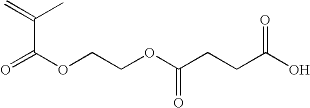 | 68,000 |
| | (40) | (60) | |
| H | 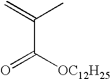 | 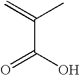 | 62,000 |
| | (55) | (45) | |
| I | 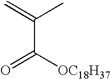 | 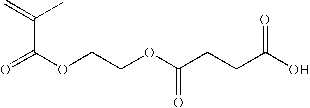 | 68,000 |
| | (20) | (80) | |

(Preparation of Support)
<Aluminum Plate>

Using an aluminum alloy containing Si: 0.06% by mass, Fe: 0.30% by mass, Cu: 0.005% by mass, Mn: 0.001% by mass, Mg: 0.001% by mass, Zn: 0.001% by mass, and Ti: 0.03% by mass, and the remainder Al and unavoidable impurities, a molten metal was prepared, molten metal treatment and filtration were performed, and an ingot having a thickness of 500 mm and a width of 1200 mm was prepared by a DC casting method. About 10 mm of the surface was cut off with a scalping machine, this was soaked at 550° C. for about 5 hours and then, when the temperature had fallen to 400° C., a rolled plate having a thickness of 2.7 mm was prepared using a hot rolling machine. Further, heat treatment was performed at 500° C. using a continuous annealing machine, and this was finished to a thickness of 0.24 mm by cold rolling to obtain an aluminum plate of JIS 1050 material. This aluminum plate was processed to a width of 1030 mm, and was subjected to the surface treatment shown below.

(a) Mechanical Surface-Roughening Treatment

Mechanical surface roughening treatment was carried out by a rotating roller type nylon brush by supplying a suspension of an abrasive agent (silica sand) having a specific gravity of 1.12 and water as an abrasive slurry solution to the surface of the aluminum plate. The average particle size of the abrasive agent was 8 μm and the maximum particle size was 50 μm. The material of the nylon brush was 6•10 nylon with a hair length of 50 mm and a hair diameter of 0.3 mm. The nylon brush was produced by implanting hairs densely in holes formed in a stainless cylinder having a diameter of 300 mm. Three rotary brushes were employed. The distance between two supporting rollers (diameter: 200 mm) under the brush was 300 mm. The brush roller was pressed to the aluminum plate until the load was increased to a load higher by 7 kW than that before it was pressed to the aluminum plate. The rotation direction of the brush was the same as the direction of the movement of the aluminum plate. The rotation speed of the brush was 200 rpm.

(b) Alkali Etching Treatment

The obtained aluminum plate was etched by spraying an aqueous NaOH solution (concentration: 26% by weight, aluminum ion concentration of 6.5% by weight) at 70° C. to etch 6 g/m² of the aluminum plate, followed by washing with water by spraying.

(c) Desmutting Treatment

Desmutting treatment was carried out by spraying an aqueous 1% by weight nitric acid solution (containing 0.5% by weight of aluminum ion) at 30° C., followed by washing with water by spraying. As the aqueous nitric acid solution, a waste solution obtained from the step of electrochemical surface roughening treatment by applying a.c. current in an aqueous nitric acid solution was used.

(d) Electrochemical Surface Roughening Treatment

Electrochemical surface roughening treatment was carried out continuously using an a.c. voltage of 60 Hz. The electrolytic solution was an aqueous solution containing 10.5 g/L of nitric acid (including 5 g/L of aluminum ions) at 50° C. The a.c. power source had the waveform in which the time TP required for current value to reach a peak from 0 was 0.8 msec and the duty ratio was 1:1, and trapezoidal rectangular wave a.c. current was used to carry out electrochemical surface roughening treatment using a carbon electrode as a counter electrode. Ferrite was used as an auxiliary anode. The electrolytic bath employed was a radial cell type.

The current density was 30 A/dm² as a peak current, and the quantity of electricity was 220 C/dm² as the total quantity of electricity when the aluminum plate was an anode. 5% of the current flowing from the power source was branched to the auxiliary electrode. Thereafter, the aluminum plate was washed with water by spraying.

(e) Alkali Etching Treatment

Etching treatment was carried out by spraying a solution containing 26% by weight of caustic soda and 6.5% by weight of aluminum ions to the aluminum plate at 32° C. to etch 0.20 g/cm² of the aluminum plate to remove the smut component primarily containing aluminum hydroxide generated when performing the foregoing electrochemical surface roughening treatment using a.c. current, and also to etch the edge part of the pits produced to thereby round the edge part. Thereafter, the aluminum plate was washed with water by spraying.

(f) Desmutting Treatment

Desmutting treatment was carried out by spraying an aqueous 15% by weight nitric acid solution (including 4.5% by weight of aluminum ions) at 30° C., followed by washing with water by spraying. As the aqueous nitric acid solution used in the desmutting treatment, a waste solution obtained in the step of electrochemical surface roughening treatment by applying a.c. current in an aqueous nitric acid solution was used.

(g) Electrochemical Surface Roughening Treatment

Electrochemical surface roughening treatment was continuously carried out by applying an a.c. voltage of 60 Hz. In this case, the electrolytic solution was an aqueous solution containing 7.5 g/L of hydrochloric acid (including 5 g/L of aluminum ions) at 35° C. The a.c. power source had a trapezoidal rectangular waveform and a carbon electrode was used as a counter electrode to carry out electrochemical surface roughening treatment. Ferrite was used as an auxiliary anode. The electrolytic bath employed was a radial cell type.

The current density was 25 A/dm² as a peak current and the quantity of electricity was 50 C/dm² as the total quantity of electricity when the aluminum plate was an anode.

Thereafter, the aluminum plate was washed with water by spraying.

(h) Alkali Etching Treatment

Etching treatment was carried out by spraying a solution containing 26% by weight of caustic soda and 6.5% by weight of aluminum ions to the aluminum plate at 32° C. to etch 0.10 g/cm² of the aluminum plate to remove the smut component primarily containing aluminum hydroxide generated when performing the foregoing electrochemical surface roughening treatment using a.c. current, and also to etch the edge part of the pits produced to thereby round the edge part. Thereafter, the aluminum plate was washed with water by spraying.

(i) Desmutting Treatment

Desmutting treatment was carried out by spraying an aqueous solution containing 25% by weight sulfuric acid solution (inluding 0.5% by weight of aluminum ions) at 60° C., followed by washing with water by spraying.

(j) Anodization Treatment

Sulfuric acid was used as the electrolytic solution. The electrolytic solution contained 170 g/L of sulfuric acid (including 0.5% by weight of aluminum ions) at 38° C. Thereafter, the aluminum plate was washed with water by spraying.

The current densities were respectively about 30 A/dm². The final anodized coating amount was 2.7 g/m².

(k) Alkali Metal Silicate Treatment

Alkali metal silicate treatment (silicate treatment) was carried out by immersing the above-mentioned aluminum support in an aqueous solution containing 1% by weight of No. 3 sodium silicate at 30° C. for 10 seconds, followed by washing with water by spraying. The amount of silicate adhering to the support was 3.5 mg/m².

<Support A>

Each of the aforementioned processes (a) to (k) were sequentially performed, and an etching amount in process (e) was adjusted to 3.4 g/m² to prepare a support A.

<Support B>

Each of the processes for manufacturing a support A were sequentially performed, except that processes (g), (h) and (i) were omitted, to prepare a support B.

<Support C>

Each of the processes for manufacturing a support A were sequentially performed, except that process (a) was omitted, to prepare a support C.

<Support D>

Each of the processes for manufacturing a support A were sequentially performed, except that processes (a), (g), (h) and (i) were omitted, to prepare a support D.

<Support E>

Each of the processes for manufacturing a support A were sequentially performed, except that processes (a), (d), (e) and (f) were omitted, and the sum of the quantity of electricity in process (g) was adjusted to 450 C/dm², to prepare a support E.

### Example 1

(Formation of Back Coating Layer)

The following <back coating layer 1> was provided on a surface-treated back surface of the above-obtained support C.

<Back Coating Layer 1>

The following sol-gel reaction solution (back coating solution 1) was coated with a back coater, and dried at 100° C. for 30 seconds to provide a back coating layer 1 having a coating amount of 120 mg/m² after drying.

-Sol-Gel Reaction Solution (Back Coating Solution 1)-

| | |
|---|---|
| Tetraethyl silicate | 50 g |
| Water | 90 g |
| Methanol | 10 g |
| Phosphoric acid | 0.1 g |

The above components were mixed and stirred, and heat was produced in about 30 minutes. The mixture was stirred for 60 minutes to allow reaction, and the following solution was added to prepare a back coating solution 1.

| | | |
|---|---|---|
| Pyrogallol formaldehyde polycondensed resin | 5 | g |
| (Mw2200 organic polymer compound) | | |
| Dibutyl maleate | 5 | g |
| Methanol silica sol | 50 | g |
| (Colloidal silica sol, manufactured by | | |
| Nissan Chemical Industries, Ltd., methanol 30%) | | |
| Megaface F780 (Fluorine-based surfactant, | 0.5 | g |
| manufactured by Dainippon Ink and Chemicals, Incorporated, | | |
| with 30% methyl ethyl ketone) | | |
| Methanol | 800 | g |
| 1-Methoxy-2-propanol | 270 | g |

(Formation of Organic Undercoating Layer)

The following organic undercoating solution was applied with a bar coater onto a surface-treated surface of a support on which a back coating had been provided as described above, and this was dried at 80° C. for 15 seconds to provide an organic undercoating layer of a covering amount of 18 mg/m² after drying.

<Organic Undercoating Layer Coating Solution>

| | |
|---|---|
| Following polymer compound | 0.3 g |
| Methanol | 100 g |

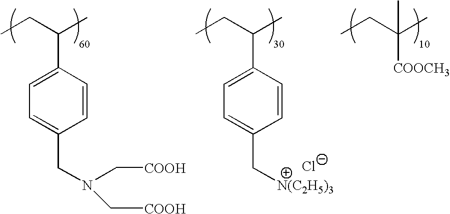

(Formation of Recording Layer)

The following recording layer forming coating solution 1 was applied with a bar coater onto a surface of the above-provided organic undercoating layer, and this was dried at 130° C. for 30 seconds in a PERFECT OVEN PH200 manufactured by TABAI (currently named ESPEC Corp.), to provide a recording layer at a coating amount of 1.3 g/m² after drying. Thereafter, the following recording layer-forming coating solution 2 was applied with a bar coater, this was dried at 130° C. for 60 seconds in a PERFECT OVEN PH200 manufactured by TABAI (currently named ESPEC Corp.), and a recording layer having a coating amount after drying of 0.26 g/m² was provided to obtain the infrared-ray photosensitive planographic printing plate precursor of Example 1.

(Recording Layer Forming Coating Solution 1)

| | |
|---|---|
| N-(4-aminosulfonylphenyl)methacrylamide/ | 1.9 g |
| acrylonitrile/methyl methacrylate | |
| copolymer (36/34/30% by mass: | |
| weight average molecular weight 50000, | |
| acid value 2.65) | |
| m/p cresol novolak | 0.3 g |
| (m/p = 6/4, weight average | |
| molecular weight 4500, containing | |
| 0.8% by mass of unreacted cresol) | |
| Cyanine dye B (following structure) | 0.13 g |
| 4,4′-Bishydroxyphenylsulfone | 0.13 g |
| Tetrahydrophthalic acid anhydride | 0.19 g |
| p-toluenesulfonic acid | 0.008 g |
| 3-Methoxy-4-diazodiphenylamine | 0.032 g |
| hexafluorophosphate | |
| Ethyl Violet in which a counter | 0.078 g |
| ion was changed to a 6-hydro-2- | |
| naphthalenesulfonic acid ion | |
| Megaface F780 | 0.2 g |
| (fluorine-based surfactant, | |
| manufactured by Dainippon Ink and | |
| Chemicals, | |
| Incorporated, with 30% methyl ethyl ketone) | |
| Methyl ethyl ketone | 16.0 g |
| 1-Methoxy-2-propanol | 8.0 g |
| γ-butyrolactone | 8.0 g |

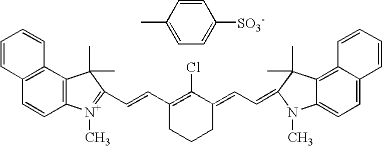

Cyanine dye B

(Recording Layer Forming Coating Solution 2)

| | |
|---|---|
| Phenol/m/p cresol novolak | 0.27 g |
| (phenol/m/p = 5/3/2, mass average molecular weight 5000, | |
| containing 0.8% by mass of unreacted cresol) | |
| Acryl-based resin C (following structure) | 0.042 g |
| Cyanine dye B (above structure) | 0.019 g |
| Long chain alkyl group-containing polymer A | 0.042 g |
| Sulfonium salt compound D (following structure) | 0.065 g |
| Ammonium compound used in Example 2 | 0.004 g |
| in JP-A No. 2001-398047, the disclosure of which is | |
| incorporated by reference herein | |
| Megaface F780 | 0.02 g |
| (fluorine-based surfactant, manufactured by | |
| Dainippon Ink and Chemicals, Incorporated, | |
| with 30% methyl ethyl ketone) | |
| Fluorine-based surfactant E (methyl ethyl ketone 60%) | 0.032 g |
| Methyl ethyl ketone | 13.0 g |
| 1-Methoxy-2-propanol | 7.0 g |

Acryl resin C

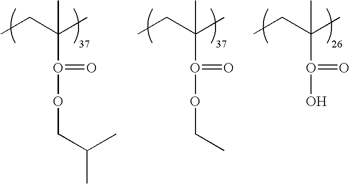

Sulfonium salt compound D

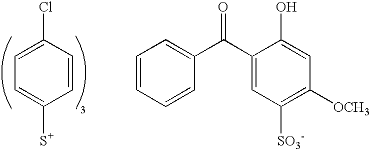

Fluorine-based surfactant E

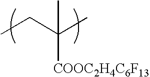

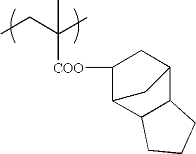

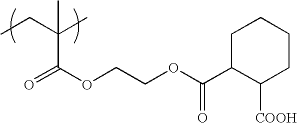

### Example 2

An infrared-ray photosensitive planographic printing plate precursor of Example 2 was obtained in the same manner as that of Example 1 except that the <back coating layer 1> formed in Example 1 was changed to the following <back coating layer 2>.

<Back Coating Layer 2>

The following back coating solution 2 was coated with a bar coater, this was dried at 100° C. for 60 seconds, and a back coating layer 2 having a coating amount after drying of 200 mg/m² was provided.

-Back Coating Solution 2

| | | |
|---|---|---|
| Saturated copolymerized polyester resin | 3 | g |
| (tradename: Kemit K-1294; manufactured by Toray Industries, | | |
| Inc.) | | |
| Megaface F780 | 0.2 | g |
| (Fluorine-based surfactant, manufactured by | | |
| Dainippon Ink and Chemicals, Incorporated, | | |
| with 30% methyl ethyl ketone) | | |
| Methyl ethyl ketone | 100 | g |

### Example 3

An infrared-ray photosensitive planographic printing plate precursor of Example 3 was obtained in the same manner as that of Example 1 except that the <back coating layer 1> formed in Example 1 was changed to the following <back coating layer 3>.

<Back Coating Layer 3>

The following back coating solution 3 was applied with a bar coater, this was dried at 100° C. for 60 seconds, and a back coating layer 3 having a coating amount after drying of 200 mg/m² was provided.

-Back Coating Solution 3-

| | | |
|---|---|---|
| Phenoxy resin (tradename: Pheno Tohto YP-50; | 3 | g |
| manufactured by Tohto Kasei Kogyo Co., Ltd.) | | |
| Megaface F780 | 0.2 | g |
| (Fluorine-based surfactant, manufactured by | | |
| Dainippon Ink and Chemicals, Incorporated, | | |
| with 30% methyl ethyl ketone) | | |
| Methyl ethyl ketone | 100 | g |

### Example 4

An infrared-ray photosensitive planographic printing plate precursor of Example 4 was obtained in the same manner as that of Example 1 except that the <back coating layer 1> formed in Example 1 was changed to the following <back coating layer 4>.

<Back Coating Layer 4>

The following back coating solution 4 was applied with a bar coater, this was dried at 100° C. for 60 seconds, and a back coating layer 4 having a coating amount after drying of 200 mg/m² was provided.

-Back Coating Solution 4-

| | | |
|---|---|---|
| Polyvinyl butyral resin | 3 | g |
| (tradename: Denka Butyral 3000-K; manufactured by | | |
| Denki Kagaku Kogyo Kabushiki Kaisha) | | |
| Megaface F780 | 0.2 | g |
| (fluorine-based surfactant, manufactured by | | |
| Dainippon Ink and Chemicals, Incorporated, | | |
| with 30% methyl ethyl ketone) | | |
| Methyl ethyl ketone | 70 | g |
| 1-Methoxy-2-propanol | 30 | g |

### Example 5

An infrared-ray photosensitive planographic printing plate precursor of Example 5 was obtained in the same manner as that of Example 1 except that the <back coating layer 1> formed in Example 1 was changed to the following <back coating layer 5>.

<Back Coating Layer 5>

The following back coating solution was applied with a bar coater, this was dried at 100° C. for 60 seconds, and a back coating layer 5 having a coating amount after drying of 200 mg/m² was obtained.

-Back Coating Solution 5-

| | | |
|---|---|---|
| Vinylidene chloride copolymer resin | 3 | g |
| (tradename: Saran resin; manufactured by Asahi Kasei | | |
| Corporation) | | |
| Megaface F780 | 0.2 | g |
| (fluorine-based surfactant, manufactured by | | |
| Dainippon Ink and Chemicals, Incorporated, | | |
| with 30% methyl ethyl ketone) | | |
| Methyl ethyl ketone | 70 | g |
| 1-Methoxy-2-propanol | 30 | g |

### Comparative Example 1

An infrared-ray photosensitive planographic printing plate precursor of Comparative Example 1 was obtained in the same manner as that of Example 1 except that the <back coating layer 1> formed in Example 1 was not provided.

### Examples 6 to 9

A back coating layer, an organic undercoating layer, a recording layer 1 and a recording layer 2 were provided to obtain the infrared-ray photosensitive planographic printing plate precursors of Examples 6 to 9 in the same manner as that of Example 1 except that a support A, a support B, a support D and a support E were each used, respectively, in place of the support C used in Example 1.

### Examples 10-17

The infrared-ray photosensitive planographic printing plate precursors of Examples 10 to 17 were obtained in the same manner as that of Example 1 except that the long chain alkyl group-containing polymer A used in recording layer 2 of Example 1 was changed, respectively, with each of the long chain alkyl group-containing polymers B to I shown in the above Synthesis Examples.

### Example 18

An infrared-ray photosensitive planographic printing plate precursor was obtained in the same manner as that of Example 1 except that a wet coating amount of a bar coater was adjusted so that a coating amount of a recording layer 1 of Example 1 became 0.85 g/m².

### Comparative Example 2

An infrared-ray photosensitive planographic printing plate precursor of Comparative example 2 was obtained in the same manner as that of Example 1 except that a long chaing alkyl group-containing polymer A was removed in a recording layer 2 of Example 1.

[Scratch Resistance Assessment: Transportation Test in Interleaving Paperless Packaging Aspect]

Each of the infrared-ray photosensitive planographic printing plate precursors obtained as described above was cut to 1030 mm×800 mm, and 30 sheets of each precursor were prepared. These 30 sheets were stacked without interleaving papers, one each of a board paper having a thickness of 0.5 mm was placed above and below the stack, the four corners were secured with tape, and wrapped with an aluminum kraft paper. This was further externally wrapped with corrugated cardboard and secured with tape to make an interleaving paperless packaging aspect. This was placed on a palette, transported 2000 km by a truck, and opened. After opening, the infrared-ray photosensitive planographic printing plate precursor were developed by placing a developer DT-2 manufactured by Fuji Photo Film Co., Ltd. at 1:8 in an automatic developing machine LP-940HII manufactured by Fuji Photo Film Co., Ltd. Regarding the planographic printing plates after development, the presence or the absence of drop-out in an image portion generated due to transportation was observed visually, and this was used as an assessment of scratch resistance. The results are shown in Table 2.

TABLE 2

| | | | | | Image part |
|---|---|---|---|---|---|
| | | | Long | | drop-out due |
| | | | chain | Recording | to trans- |
| | | | alkyl | layer | portation in |
| | | Back | group- | coating | interleaving |
| | Sup- | coating | containing | amount | paperless |
| | port | layer | polymer | (g/m2) | packaging |
| Example 1 | C | Sol-gel | A | 1.56 | Absent |
| Example 2 | C | Saturated | A | 1.56 | Absent |
| | | polymerized | | | |
| | | polyester | | | |
| | | resin | | | |
| Example 3 | C | Phenoxy | A | 1.56 | Absent |
| | | resin | | | |
| Example 4 | C | Polyvinyl | A | 1.56 | Absent |
| | | butyral resin | | | |
| Example 5 | C | Vinylidene | A | 1.56 | Absent |
| | | chloride | | | |
| | | copolymer | | | |
| | | resin | | | |
| Example 6 | A | Sol-gel | A | 1.56 | Absent |
| Example 7 | B | Sol-gel | A | 1.56 | Absent |
| Example 8 | D | Sol-gel | A | 1.56 | Absent |
| Example 9 | E | Sol-gel | A | 1.56 | Absent |
| Example 10 | C | Sol-gel | B | 1.56 | Absent |
| Example 11 | C | Sol-gel | C | 1.56 | Absent |
| Example 12 | C | Sol-gel | D | 1.56 | Absent |
| Example 13 | C | Sol-gel | E | 1.56 | Absent |
| Example 14 | C | Sol-gel | F | 1.56 | Absent |
| Example 15 | C | Sol-gel | G | 1.56 | Absent |
| Example 16 | C | Sol-gel | H | 1.56 | Absent |
| Example 17 | C | Sol-gel | I | 1.56 | Absent |
| Example 18 | C | Sol-gel | A | 1.11 | Absent |
| Comparative | C | None | A | 1.56 | Present |
| Example 1 | | | | | |
| Comparative | C | Sol-gel | None | 1.56 | Present |
| Example 2 | | | | | |

As shown in Table 2, in the planographic printing plate precursors of Examples 1 to 18, even after they are stacked and packaged without interleaving papers, and transported a long distance, drop-out in an image portion is not generated, and it was found that they are excellent in scratch resistance.

What is clamed is:

1. An infrared-ray photosensitive planographic printing plate precursor, comprising:
a support,
a recording layer provided on one side of the support, and
a back coating layer provided on a side opposite to a side having the recording layer of the support,
wherein the recording layer contains (a) a long chain alkyl group-containing polymer constituted from a vinyl monomer having a carboxyl group at a composition ratio within a range from 20 to 99 mol %, and (b) an infrared absorbing agent, and can form an image by infrared-ray irradiation.

2. The infrared-ray photosensitive planographic printing plate precursor of claim 1, wherein the back coating layer is a back coating layer (A) containing at least one kind of resin selected from the group consisting of a polymerized saturated polyester resin, a phenoxy resin, a polyvinyl acetal resin, and a vinylidene chloride copolymer resin, or a back coating layer (B) containing the following (i) to (iii):
(i) a metal oxide obtained by hydrolyzing and polycondensing an organic metal compound or an inorganic metal compound,
(ii) a colloidal silica sol, and
(iii) an organic polymer compound.

3. The infrared-ray photosensitive planographic printing plate precursor of claim 1, wherein (a) the long chain alkyl group-containing polymer is a copolymer represented by the following formula (I). 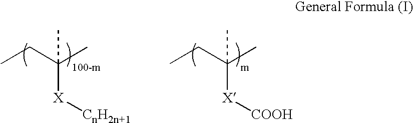
In the formula (I), X and X′ each represents, independently, a single bond or a bivalent connecting group, m represents an integer of 20<m<99, n represents an integer of 6 to 40, and a bond indicated by a dotted line means that there is a methyl group or hydrogen atom at its terminal.

4. The infrared-ray photosensitive planographic printing plate precursor of claim 3, wherein in the formula (I), 30<m<90, and 12<n<30.

5. The infrared-ray photosensitive planographic printing plate precursor of claim 4, wherein in the formula (I), 45<m<80, and 14<n<20.

6. The infrared-ray photosensitive planographic printing plate precursor of claim 1, wherein (a) the long chain alkyl group-containing polymer is an acryl-based copolymer represented by the following formula (II): 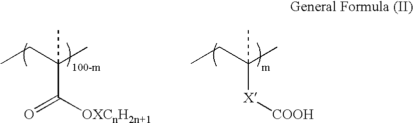
In the formula (II), X and X′ each represents, independently, a single bond or a bivalent connecting group, m represents an integer of 20<m<99, n represents an integer of 6 to 40, and a bond indicated by a dotted line means that there is a methyl group or hydrogen atom at its terminal.

7. The infrared-ray photosensitive planographic printing plate precursor of claim 6, wherein in the formula (II), 30<m<90, and 12<n<30.

8. The infrared-ray photosensitive planographic printing plate precursor of claim 7, wherein in the formula (II), 45<m<80, and 14<n<20.

9. The infrared-ray photosensitive planographic printing plate precursor of claim 1, wherein (a) the long chain alkyl group-containing polymer is an acryl-based copolymer represented by the following formula (III): 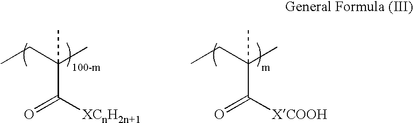
In the formula (III), X and X′ each represents, independently, a single bond or a bivalent connecting group, m represents an integer of 20<m<99, n represents an integer of 6 to 40, and a bond indicated by a dotted line means that there is a methyl group or hydrogen atom at its terminal.

10. The infrared-ray photosensitive planographic printing plate precursor of claim 9, wherein in the formula (III), 30<m<90, and 12<n<30.

11. The infrared-ray photosensitive planographic printing plate precursor of claim 10, wherein in the formula (III), 45<m<80, and 14<n<20.

12. The infrared-ray photosensitive planographic printing plate precursor of claim 1, wherein (a) the long chain alkyl group-containing polymer is an acryl-based polymer represented by the following formula (IV) or the formula (V): 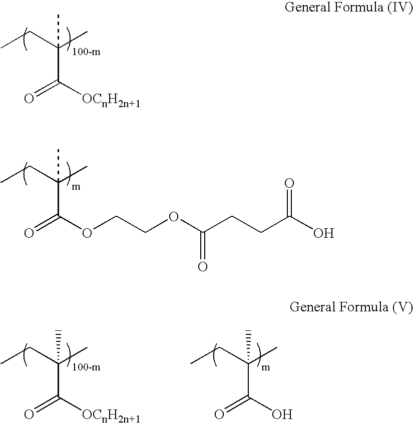
In the formula (IV) and the formula (V), X and X′ each represents, independently, a single bond or a bivalent connecting group, m represents an integer of 20<m<99, n represents an integer of 6 to 40, and a bond indicated by a dotted line means that there is a methyl group or hydrogen atom at its terminal.

13. The infrared-ray photosensitive plangraphic printing plate precursor of claim 12, wherein in the formula (IV) and the formula (V), 30<m<90, and 12<n<30.

14. The infrared-ray photosensitive plangraphic printing plate precursor of claim 13, wherein in the formula (IV) and the formula (V), 45<m<80, and 14<n<20.

15. The infrared-ray photosensitive plangraphic printing plate precursor of claim 1, wherein surface roughness (Ra) of the back coating layer is 0.25 or lower.

16. The infrared-ray photosensitive planographic printing plate precursor of claim 2, wherein a glass transition temperature of the resin used in the back coating layer (A) is 60° C. or higher.

17. An infrared-ray photosensitive planographic printing plate precursor, comprising:
a support,
a recording layer provided on one side of the support, and
a back coating layer provided on a side opposite to a side having the recording layer of the support,
wherein, the recording layer contains (a) a long chain alkyl group-containing polymer containing a vinyl monomer having a carboxyl group at a composition ratio within a range from 20 to 99 mol %, and (b) an infrared absorbing agent, and can form an image by infrared-ray irradiation, and
the back coating layer is a back coating layer (A) containing at least one kind of resin selected from the group consisting of a saturated polymerized polyester resin, a phenoxy resin, a polyvinyl acetal resin, and a vinylidene chloride copolymer resin.

18. The infrared-ray photosensitive planographic printing plate precursor of claim 17, wherein a glass transition temperature of the resin used in the back coating layer (A) is 60° C. or higher.

19. An infrared-ray photosensitive planographic printing plate precursor, comprising:
a support,
a recording layer provided on one side of the support, and
a back coating layer provided on a side opposite to a side having the recording layer of the support,
wherein the recording layer contains (a) a long chain alkyl group-containing polymer containing a vinyl monomer having a carboxyl group at a composition ratio within a range from 20 to 99 mol %, and (b) an infrared absorbing agent, and can form an image by infrared-ray irradiation, and
the back coating layer is a back coating layer (B) containing the following (i) to (iii):
(i) a metal oxide obtained by hydrolyzing and polycondensing an organic metal compound or an inorganic metal compound,
(ii) a colloidal silica sol, and
(iii) an organic polymer compound.
